(19) United States
(12) Patent Application Publication
(10) Pub. No.: US 2025/0034445 A1
(43) Pub. Date: Jan. 30, 2025

(54) REFRIGERANTS HAVING LOW GWP, AND SYSTEMS FOR AND METHODS OF PROVIDING REFRIGERATION

(71) Applicant: HONEYWELL INTERNATIONAL INC., Charlotte, NC (US)

(72) Inventors: Ankit Sethi, Charlotte, NC (US); Kaimi Gao, Charlotte, NC (US); Henna Tangri, Charlotte, NC (US); Elizabet Vera Becerra, Charlotte, NC (US); Ryan Hulse, Charlotte, NC (US); Bruno Yuji Kimura de Carvalho, Charlotte, NC (US)

(73) Assignee: HONEYWELL INTERNATIONAL INC., Charlotte, NC (US)

(21) Appl. No.: 18/779,307

(22) Filed: Jul. 22, 2024

Related U.S. Application Data
(60) Provisional application No. 63/528,728, filed on Jul. 25, 2023.

(51) Int. Cl. C09K 5/04

(52) U.S. Cl. CPC C09K 5/045; C09K 2205/122; C09K 2205/126; C09K 2205/22

(57) ABSTRACT

Low-flammability and low-GWP refrigerants based on mixtures of R-32, R-1132(E), and R-1234yf and uses thereof in air conditioning systems and methods in general and reversible heat pump systems and methods.

### CROSS REFERENCE TO RELATED APPLICATIONS

The present application claims the priority benefit of U.S. Provisional application 63/528,728, filed Jul. 25, 2023, which is incorporated herein by reference in its entirety.

### FIELD OF THE DISCLOSURE

The present disclosure relates to low-global warming potential (“low GWP”) refrigerant and heat transfer compositions, heat transfer methods, and heat transfer systems, with particular benefit in heat pump systems and air conditioning systems.

### BACKGROUND

Certain single-component fluorocarbons, including chlorofluorocarbons (“CFCs”), hydrochlorofluorocarbons (“HCFCs”), and hydrofluorolefins (“HFOs”), have been used in many heat transfer applications. One advantage that single component fluids have as refrigerants is that for a given pressure, the boiling point is constant. This is highly desirable because it permits the refrigeration system or method to be designed with a refrigerant temperature along the evaporator that has an acceptably small change during the evaporation processes, assuming little or no pressure drop as the refrigerant flows through the evaporator.

Prior to the present disclosure, those skilled in the art have utilized mainly single component refrigerants, such as HFC-134a, in many refrigeration applications and have avoided refrigerant blends because blends generally undergo a significant change in boiling point temperature upon evaporation, which has heretofore been perceived as a major obstacle to the ability to identify blends having the correct balance of properties to be useful in such systems. This change in boiling point temperature is generally reflected in the property of the blend known as the “glide” of the blend. In general, the larger the glide the greater the difference in boiling temperature which occurs in various pieces of refrigeration equipment. For many important applications, this parameter is considered critical for the success of the refrigerant and/or the refrigeration system in which it is used, with a relatively low glide potentially providing significant advantage in many important applications. However, in some applications the “glide” can be used to improve the efficiency of the heat transfer process by matching the refrigerant temperature change with the secondary fluid temperature lift. This effect allows the reduction of the temperature difference profile between refrigerant and secondary fluid (air, water, glycol, etc.) and can reduce the refrigerant condensation temperature or increase the refrigerant evaporation temperature. This improvement is generally observed with high specific heat secondary fluids, for example, water, brine or a glycol solution, such as ethylene glycol or propylene glycol.

Another refrigerant characteristic which has become increasingly important in recent years, to the point of now being critical for many applications, is the environmental friendliness of the refrigerant. This environmental friendliness can be measured, at least in part, by the projected impact that release of the refrigerant into the atmosphere would have on global warming. This projected impact is frequently measured as the global warming potential (GWP) of the refrigerant, with refrigerants having a GWP below a certain value, such as 150, being highly preferred and/or legally required for use in many applications. As used herein, the GWP values are determined in accordance with AR4.

Flammability is another important consideration for refrigerants used in applications. Currently, it is most preferred for a refrigerant to a non-flammable substance as classified by ASHRAE as Class 1. A second preferred class of non-flammability is the classification by ASHRAE of Class 2L. Applicants and others in the field have come to recognize that it is very difficult to develop new refrigerants that are at the same time environmentally friendly, preferably with a GWP of less than 150, have low glide, preferably less than 6° C., and are nonflammable, preferably having a classification of 2L or 1. Applicants have come to particularly appreciate that it is extremely difficult in many applications to identify a single-component fluid, much less a refrigerant that is a blend of components, that possesses the full set of properties that make it of particular advantage in applications of the type discussed herein. For example, in many important applications, it is necessary to identify a refrigerant that simultaneously: (1) has workable glide; (2) has low global warming potential (GWP) (i.e., less than about 150); (3) is non-flammable (i.e., is Class 1 or Class 2L according to ASHRAE); (4) has low or no substantial toxicity; and (5) has heat transfer and other properties (such as chemical stability) that match the needs of the particular applications, especially in medium temperature heat transfer systems. While the use of single component refrigerants has been able in many cases to satisfy one or two of these items, those skilled in the art have found it difficult (if not impossible) to heretofore find a refrigerant (whether single component or otherwise) that can satisfy all five items, that is, each of items (1)-(5) is achieved. Here a low toxicity substance is classified as class “A” by ASHRAE Standard 34-2019. A substance which is non-flammable and low-toxicity would be classified as “A1” or A2L by ASHRAE Standard 34-2019.

It is also highly desirable to provide refrigerants and heat transfer compositions that can be used in a variety of cooling applications. Applicants have come to appreciate that in order to satisfy this need, as well as the many other important needs describe above, the refrigerant and the heat transfer compositions must be able to operate within industry and/or government requirements in the most restrictive applications. A refrigerant which has heretofore been used to meet these strict requirements is R448A. However, R448A suffers from the serious deficiency of having a GWP of greater than 150.

Thus, the effort to find a low GWP replacement refrigerant represents a significant and difficult to solve technical challenge. Applicants have come to appreciate that the mosaic of difficult-to-achieve properties could unexpectedly be satisfied by use of refrigerants of the present disclosure, as explained in detail hereinafter.

### SUMMARY

Applicants have unexpectedly and advantageously found, as described in detail hereinafter, that certain refrigerants based on mixtures of R-32, R-1132(E), and R-1234yf, preferably and especially within specific concentration ranges of these components as described herein, have unexpected advantage in several aspects, including but not limited to: heat transfer performance (including preferably high capacity, high COP and low evaporator glide (preferably less than 5° C.) in air conditioning systems and methods in general and reversible heat pump systems and methods in particular; low GWP (preferably below 150); and low toxicity and low flammability (preferably class A1 or A2L).

The present invention includes heat transfer systems for heating and/or cooling air and/or water in an indoor space comprising:
a. a refrigerant comprising at least 97% by weight of the following three components, wherein the following percentages are based on the total of components (i) through (iii): (i) from about 19.5 wt. % to about 30 wt % of R-32; (ii) from about 15 wt. % to about 45 wt. % R-1132(E); and from about 35 wt. % to about 65 wt. % R-1234yf;
b. a compressor for the refrigerant, said compressor being located outdoors;
c. a first heat exchanger for exchanging heat, directly or indirectly, between said refrigerant and an outdoor heat sink, said first heat exchanger being located outdoors;
d. a second heat exchanger for exchanging heat, directly or indirectly, between said refrigerant and air and/or water in said indoor space;
e. optionally a reversing valve located between said compressor and said first heat exchanger and between said compressor and said second heat exchanger; and
f. at least one expansion device for said refrigerant located between said first heat exchanger and said second heat exchanger.
   The systems as defined in this paragraph are referred to herein for convenience as Heat Transfer System 1A.

The present invention includes heat transfer systems for heating and/or cooling air and/or water in an indoor space comprising:
a. a refrigerant comprising at least 97% by weight of the following three components, wherein the following percentages are based on the total of components (i) through (iii): (i) from about 19.5 wt. % to about 30 wt % of R-32; (ii) from about 25 wt. % to about 45 wt. % R-1132(E); and from about 35 wt. % to about 55 wt. % R-1234yf;
b. a compressor for the refrigerant, said compressor being located outdoors;
c. a first heat exchanger for exchanging heat, directly or indirectly, between said refrigerant and an outdoor heat sink, said first heat exchanger being located outdoors;
d. a second heat exchanger for exchanging heat, directly or indirectly, between said refrigerant and air and/or water in said indoor space;
e. optionally a reversing valve located between said compressor and said first heat exchanger and between said compressor and said second heat exchanger; and
f. at least one expansion device for said refrigerant located between said first heat exchanger and said second heat exchanger.
   The systems as defined in this paragraph are referred to herein for convenience as Heat Transfer System 1B.

The present invention includes heat pump and air conditioning systems for heating and/or cooling air and/or water in an indoor living space comprising:
a. a refrigerant comprising at least 97% by weight of the following three components, wherein the following percentages are based on the total of components (i) through (iii): (i) from about 19.5 wt. % to about 30 wt % of R-32; (ii) from about 15 wt. % to about 45 wt. % R-1132(E); and from about 35 wt. % to about 65 wt. % R-1234yf;
b. a compressor for the refrigerant, said compressor being located outdoors;
c. a first heat exchanger for exchanging heat, directly or indirectly, between said refrigerant and an outdoor heat sink, said first heat exchanger being located outdoors;
d. a second heat exchanger for exchanging heat, directly or indirectly, between said refrigerant and air and/or water in said indoor living space;
e. optionally a reversing valve located between said compressor and said first heat exchanger and between said compressor and said second heat exchanger; and
f. at least one expansion device for said refrigerant located between said first heat exchanger and said second heat exchanger.
   The systems as defined in this paragraph are referred to herein for convenience as Heat Transfer System 2A.

The present invention includes heat pump and air conditioning systems for heating and/or cooling air and/or water in an indoor living space comprising:
a. a refrigerant comprising at least 97% by weight of the following three components, wherein the following percentages are based on the total of components (i) through (iii): (i) from about 19.5 wt. % to about 30 wt % of R-32; (ii) from about 25 wt. % to about 45 wt. % R-1132(E); and from about 35 wt. % to about 55 wt. % R-1234yf;
b. a compressor for the refrigerant, said compressor being located outdoors;
c. a first heat exchanger for exchanging heat, directly or indirectly, between said refrigerant and an outdoor heat sink, said first heat exchanger being located outdoors;
d. a second heat exchanger for exchanging heat, directly or indirectly, between said refrigerant and air and/or water in said indoor living space;
e. optionally a reversing valve located between said compressor and said first heat exchanger and between said compressor and said second heat exchanger; and
f. at least one expansion device for said refrigerant located between said first heat exchanger and said second heat exchanger.
   The systems as defined in this paragraph are referred to herein for convenience as Heat Transfer System 2B.

A heat pump or air conditioning system for heating and/or cooling air and/or water in an occupied indoor space comprising:
a. a refrigerant comprising at least 99% by weight of the following three components, wherein the following percentages are based on the total of components (i) through (iii): (i) 21.5 wt. %+/−0.5 wt %; (ii) from 25 wt. % to 42.5 wt. % R-1132(E); and from 36 wt. % to 52 wt. % R-1234yf;
b. a compressor for the refrigerant, said compressor being located outdoors;
c. a first heat exchanger for exchanging heat, directly or indirectly, between said refrigerant and an outdoor heat sink, said first heat exchanger being located outdoors;
d. a second heat exchanger for exchanging heat, directly or indirectly, between said refrigerant and air and/or water in said occupied indoor space;
e. optionally a reversing valve located between said compressor and said first heat exchanger and between said compressor and said second heat exchanger; and
f. at least one expansion device for said refrigerant located between said first heat exchanger and said second heat exchanger.
   The systems as defined in this paragraph are referred to herein for convenience as Heat Transfer System 2C.

The present invention also includes methods of heating and/or cooling air and/or water in an indoor space comprising:
a. providing a heat transfer system comprising: (1) a refrigerant comprising at least 97% by weight of the following three components, wherein the following percentages are based on the total of components (i) through (iii): (i) about 19.5 wt. % to about 30 wt % of R-32; (ii) from about 15 wt. % to about 45 wt. % R-1132(E); and from about 35 wt. % to about 65 wt. % R-1234yf; (2) a compressor for said refrigerant located outdoors; (3) a first heat exchanger for exchanging heat, directly or indirectly, between said refrigerant and an outdoor heat sink and being located outdoors; (4) a second heat exchanger for exchanging heat, directly or indirectly, between said refrigerant and air and/or water in said occupied indoor space; (5) optionally a reversing valve located between said compressor and said first heat exchanger and between said compressor and said second heat exchanger; and (6) at least one expansion device for said refrigerant located between said first heat exchanger and said second heat exchanger; and
b. transferring heat between air or water located in said indoor space and said outdoor heat sink using said heat transfer system.
   The methods as defined in this paragraph are referred to herein for convenience as Heat Transfer Method 1A.

The present invention also includes methods of heating and/or cooling air and/or water in an indoor space comprising:
a. providing a heat transfer system comprising: (1) a refrigerant comprising at least 97% by weight of the following three components, wherein the following percentages are based on the total of components (i) through (iii): (i) about 19.5 wt. % to about 30 wt % of R-32; (ii) from about 25 wt. % to about 45 wt. % R-1132(E); and from about 35 wt. % to about 55 wt. % R-1234yf; (2) a compressor for said refrigerant located outdoors; (3) a first heat exchanger for exchanging heat, directly or indirectly, between said refrigerant and an outdoor heat sink and being located outdoors; (4) a second heat exchanger for exchanging heat, directly or indirectly, between said refrigerant and air and/or water in said occupied indoor space; (5) optionally a reversing valve located between said compressor and said first heat exchanger and between said compressor and said second heat exchanger; and (6) at least one expansion device for said refrigerant located between said first heat exchanger and said second heat exchanger; and
b. transferring heat between air or water located in said indoor space and said outdoor heat sink using said heat transfer system.
   The methods as defined in this paragraph are referred to herein for convenience as Heat Transfer Method 1B.

The present invention also includes methods of heating and/or cooling air and/or water in an indoor living space comprising:
a. providing a heat transfer system comprising: (1) a refrigerant comprising at least 97% by weight of the following three components, wherein the following percentages are based on the total of components (i) through (iii): (i) 21.5 wt. %+/−0.5 wt %; (ii) from 15 wt. % to 42.5 wt. % R-1132(E); and from 36 wt. % to 62 wt. % R-1234yf; (2) a compressor for said refrigerant located outdoors; (3) a first heat exchanger for exchanging heat, directly or indirectly, between said refrigerant and an outdoor heat sink and being located outdoors; (4) a second heat exchanger for exchanging heat, directly or indirectly, between said refrigerant and air and/or water in said indoor living space; (5) optionally a reversing valve located between said compressor and said first heat exchanger and between said compressor and said second heat exchanger; and (6) at least one expansion device for said refrigerant located between said first heat exchanger and said second heat exchanger; and
b. transferring heat between air or water located in said indoor living space and said outdoor heat sink using said heat transfer system.
   The methods as defined in this paragraph are referred to herein for convenience as Heat Transfer Method 2A.

The present invention also includes methods of heating and/or cooling air and/or water in an indoor living space comprising:
a. providing a heat transfer system comprising: (1) a refrigerant comprising at least 97% by weight of the following three components, wherein the following percentages are based on the total of components (i) through (iii): (i) 21.5 wt. %+/−0.5 wt %; (ii) from 25 wt. % to 42.5 wt. % R-1132(E); and from 36 wt. % to 52 wt. % R-1234yf; (2) a compressor for said refrigerant located outdoors; (3) a first heat exchanger for exchanging heat, directly or indirectly, between said refrigerant and an outdoor heat sink and being located outdoors; (4) a second heat exchanger for exchanging heat, directly or indirectly, between said refrigerant and air and/or water in said indoor living space; (5) optionally a reversing valve located between said compressor and said first heat exchanger and between said compressor and said second heat exchanger; and (6) at least one expansion device for said refrigerant located between said first heat exchanger and said second heat exchanger; and
b. transferring heat between air or water located in said indoor living space and said outdoor heat sink using said heat transfer system.
   The methods as defined in this paragraph are referred to herein for convenience as Heat Transfer Method 2B.

The present invention also includes refrigerants comprising at least 97% by weight of the following three components, wherein the following percentages are based on the total of components (i) through (iii): (i) from about 19.5 wt. % to about 30 wt % of R-32; (ii) from about 15 wt. % to about 45 wt. % R-1132(E); and from about 35 wt. % to about 65 wt. % R-1234yf. The refrigerants as defined in this paragraph are referred to herein for convenience as Refrigerant 1A.

The present invention also includes refrigerants comprising at least 97% by weight of the following three components, wherein the following percentages are based on the total of components (i) through (iii): (i) from about 19.5 wt. % to about 30 wt % of R-32; (ii) from about 25 wt. % to about 45 wt. % R-1132(E); and from about 35 wt. % to about 55 wt. % R-1234yf. The refrigerants as defined in this paragraph are referred to herein for convenience as Refrigerant 1B.

The present invention also includes refrigerants comprising at least 97% by weight of the following three components, wherein the following percentages are based on the total of components (i) through (iii): (i) 21.5 wt. %+/−0.5 wt % R-32; (ii) from 16 wt. % to 38 wt. % R-1132(E); and from 40.5 wt. % to 61.7 wt. % R-1234yf. The refrigerants as defined in this paragraph are referred to herein for convenience as Refrigerant 2A.

The present invention also includes refrigerants comprising at least 97% by weight of the following three components, wherein the following percentages are based on the total of components (i) through (iii): (i) 21.5 wt. %+/−0.5 wt % R-32; (ii) from 26 wt. % to 38 wt. % R-1132(E); and from 40.5 wt. % to 51.7 wt. % R-1234yf. The refrigerants as defined in this paragraph are referred to herein for convenience as Refrigerant 2A.

The present invention also includes refrigerants comprising at least 97% by weight of the following three components, wherein the following percentages are based on the total of components (i) through (iii): (i) 21.5 wt. %+/−0.5 wt % R-32; (ii) 38 wt. %+/−0.5 wt % R-1132(E); and 40.5 wt. %+/−0.5 wt % R-1234yf. The refrigerants as defined in this paragraph are referred to herein for convenience as Refrigerant 3.

### BRIEF DESCRIPTION OF THE DRAWINGS

FIG. 1 is a schematic process flow diagram representing an exemplary (monoblock) air-to-water heat pump system illustrating operation in a heating mode.

FIG. 2 is a schematic process flow diagram representing an exemplary (monoblock) air-to-water heat pump system illustrating operation in a cooling mode showing optional water flow reversal to improve evaporator heat transfer.

FIG. 3 is a schematic process flow diagram representing an exemplary split air-to-water heat pump system illustrating operation in a heating mode, with the refrigerant-water heat exchanger is located indoors (with buffer, DHW tanks, etc not being shown for convenience of illustration), for any heating method, including underfloor, radiators, DHW, etc.

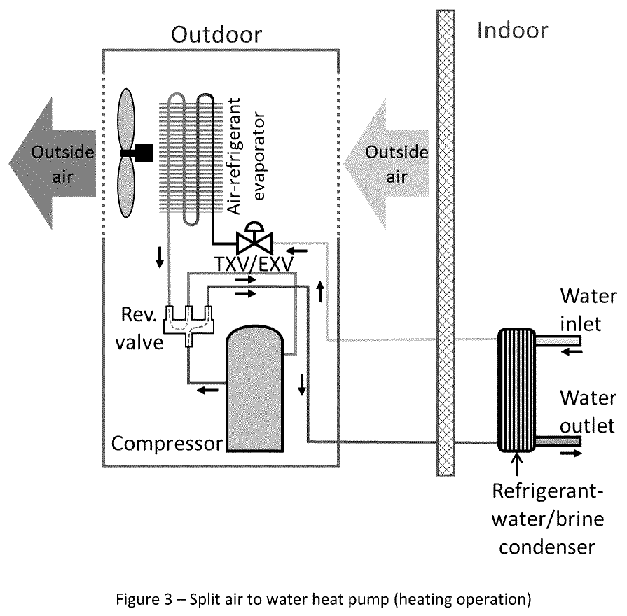

FIG. 4 is a schematic process flow diagram representing an exemplary split air-to-water heat pump system illustrating operation in a cooling mode.

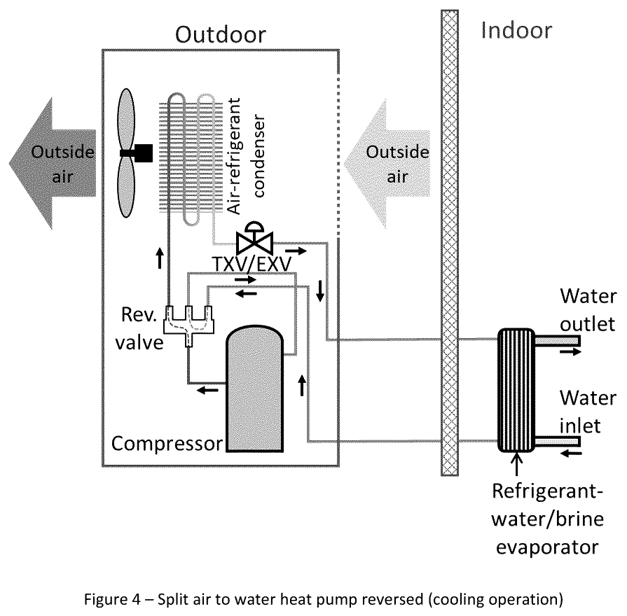

FIG. 5 is a schematic process flow diagram representing an exemplary split air-to-air heat pump system illustrating operation in a heating mode showing optional water flow reversal to improve evaporator heat transfer.

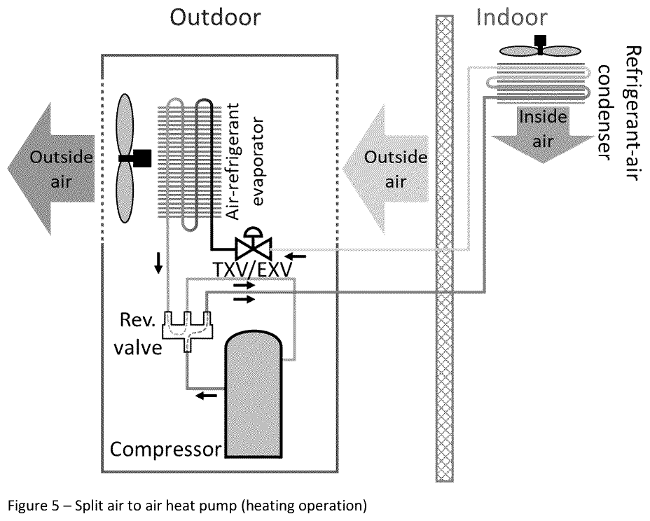

FIG. 6 is a schematic process flow diagram representing an exemplary split air-to-air heat pump system illustrating operation in a cooling mode.

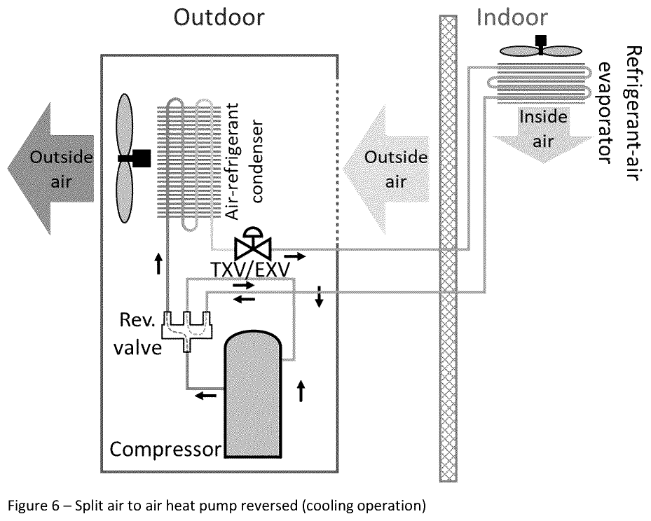

FIG. 7 is a schematic process flow diagram representing an exemplary split air-to-air heat pump system with two expansion devices (one for heating (located in the outdoor unit) and one for cooling (located in the indoor unit)) illustrating operation in a heating mode.

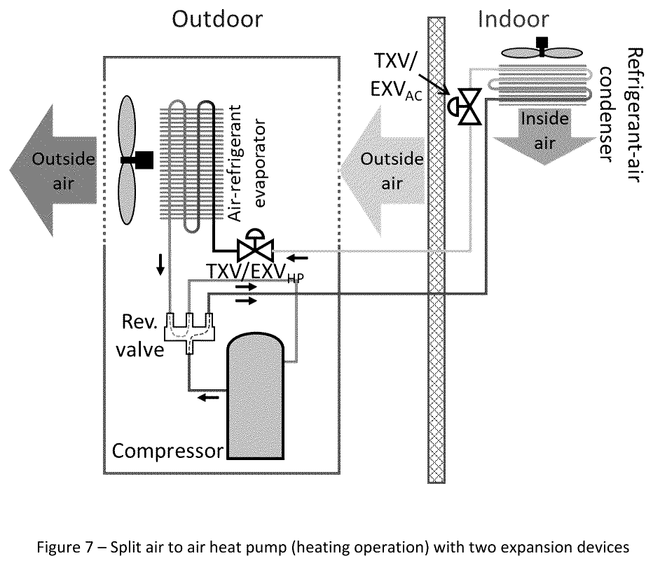

FIG. 8 is a schematic process flow diagram representing an exemplary split air-to-air heat pump system with two expansion devices (one for heating (located in the outdoor unit) and one for cooling (located in the indoor unit)) illustrating operation in a cooling mode.

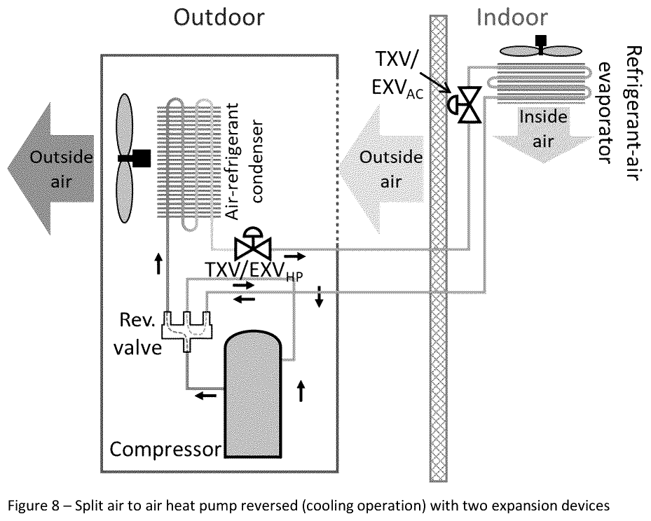

FIG. 9 is a schematic process flow diagram representing an exemplary ground/water/brine-to-water heat pump system, which can be all contained inside or outside, illustrating operation in a heating mode (with the outdoor water/brine extracting/rejecting heat to the ground or another water body).

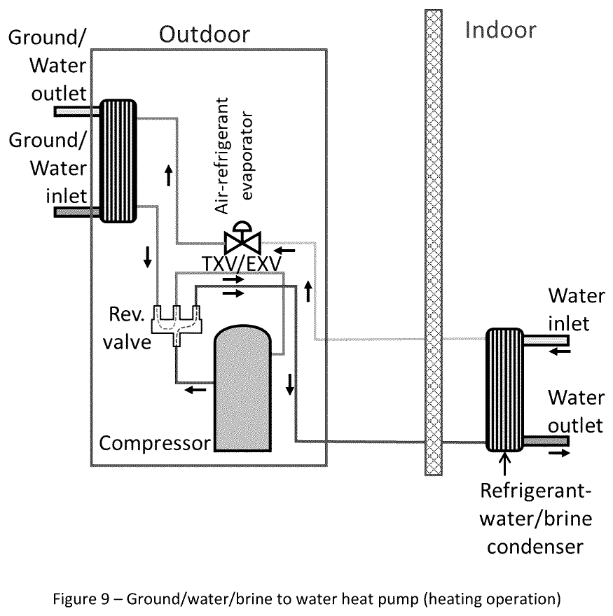

FIG. 10 is a schematic process flow diagram representing an exemplary split ground/water/brine-to-water heat pump system (showing optional water flows being reversed to allow for counterflow configuration which leads to improved performance) and illustrating operation in a cooling mode.

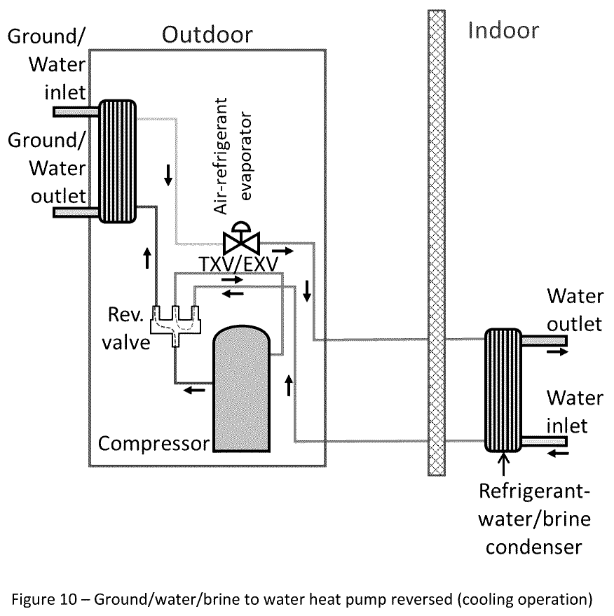

FIG. 11 is a schematic representation of an exemplary heat transfer system useful in refrigeration, air conditioning and heat pump.

FIG. 12 is a schematic representation of an exemplary heat transfer system useful in refrigeration, air conditioning and heat pump and which includes an optional vapor injector with economizer.

FIG. 13 is a schematic representation of a vapor compressions heat transfer cycle having a liquid line/suction line heat exchanger.

### DETAILED DESCRIPTION

### I. Definitions

The term “about” in relation to the amounts expressed in weight percent means that the amount of the component can vary by an amount of +/−2% by weight.

The term “about” in relation to temperatures in degrees centigrade (° C.) means that the stated temperature can vary by an amount of +/−5° C.

The term “capacity” is the amount of cooling provided, in BTUs/hr., by the refrigerant in the refrigeration system. This is experimentally determined by multiplying the change in enthalpy in BTU/lb., of the refrigerant as it passes through the evaporator by the mass flow rate of the refrigerant. The enthalpy can be determined from the measurement of the pressure and temperature of the refrigerant. The capacity of the refrigeration system relates to the ability to maintain an area to be cooled at a specific temperature. The capacity of a refrigerant represents the amount of cooling or heating that it provides and provides some measure of the capability of a compressor to pump quantities of heat for a given volumetric flow rate of refrigerant. In other words, given a specific compressor, a refrigerant with a higher capacity will deliver more cooling or heating power.

The phrase “coefficient of performance” (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R.C. Downing, FLUOROCARBON REFRIGERANTS HANDBOOK, Chapter 3, Prentice-Hall, 1988 which is incorporated herein by reference in its entirety).

The phrase “discharge temperature” refers to the temperature of the refrigerant at the outlet of the compressor. The advantage of a low discharge temperature is that it permits the use of existing equipment without activation of the thermal protection aspects of the system which are preferably designed to protect compressor components and avoids the use of costly controls such as liquid injection to reduce discharge temperature.

The phrase “Global Warming Potential” (hereinafter “GWP”) was developed to allow comparisons of the global warming impact of different gases. It compares the amount of heat trapped by a certain mass of a gas to the amount of heat trapped by a similar mass of carbon dioxide over a specific time period of time. Carbon dioxide was chosen by the Intergovernmental Panel on Climate Change (IPCC) as the reference gas and its GWP is taken as 1. The larger GWP, the more that a given gas warms the Earth compared to CO2 over that time period. The time period usually used for GWP is 100 years. GWP provides a common measure, which allows analysts to add up emission estimates of different gases. The parameter values used in this document are based on the fourth assessment report of IPCC (AR4).

The term “Occupational Exposure Limit (OEL)” is determined in accordance with ASHRAE Standard 34-2019 Designation and Safety Classification of Refrigerants.

The phrase “acceptable toxicity” as used herein means the composition is classified as class “A” by ASHRAE Standard 34-2019 Designation and Safety Classification of Refrigerants and described in Appendix B1 to ASHRAE Standard 34-2019 (as each standard exists as of the filing date of this application).

The term “A1” means a substance which is non-flammable and low toxicity and is classified as “A1” by ASHRAE Standard 34-2019 Designation and Safety Classification of Refrigerants and described in Appendix B1 to ASHRAE Standard 34-2019 (as each standard exists as of the filing date of this application).

The term “A2L” means a substance which is mildly flammable and low-toxicity and is classified as “A2L” by ASHRAE Standard 34-2019 Designation and Safety Classification of Refrigerants and described in Appendix B1 to ASHRAE Standard 34-2019 (as each standard exists as of the filing date of this application).

The term “mass flow rate” is the mass of refrigerant passing through a conduit per unit of time.

The term “non-flammable” refers to compounds or compositions which are either A1 or A2L as defined herein.

As used herein, the term “evaporator glide” means the difference between the saturation temperature of the refrigerant at the entrance to the evaporator and the dew point of the refrigerant at the exit of the evaporator, assuming the pressure at the evaporator exit is the same as the pressure at the inlet. As used herein, the phrase “saturation temperature” means the temperature at which the liquid refrigerant boils into vapor at a given pressure.

The phrase “acceptable toxicity” as used herein means the composition is classified as class “A” by ASHRAE Standard 34-2019 Designation and Safety Classification of Refrigerants and described in Appendix B1 to ASHRAE Standard 34-2019 (as each standard exists as of the filing date of this application). A substance which is non-flammable and low-toxicity would be classified as “A1” by ASHRAE Standard 34-2019 Designation and Safety Classification of Refrigerants and described in Appendix B1 to ASHRAE Standard 34-2019 (as each standard exists as of the filing date of this application).

As used herein, the term “indoor living space” means an indoor space which is or is intended to be occupied by humans for extended periods of time, and is intended to include homes and other indoor residential spaces, and to include office buildings and other indoor work spaces.

As used herein, the term “replacement” means the use of a composition of the present disclosure in a heat transfer system that had been designed for use with or is suitable for use with another refrigerant. By way of example, when a refrigerant or heat transfer composition of the present disclosure is used in a heat transfer system that was designed for use with R-22, then the refrigerant or heat transfer composition of the present disclosure is a replacement for R-22 in said system. It will thus be understood that the term “replacement” includes the use of the refrigerants and heat transfer compositions of the present disclosure in both new and existing systems that had been designed for use with, or are suitable for use with, a designated refrigerant, such as R-22. Further for example, the term “R-22 system” means a heat transfer system that had been designed for use with, is suitable for use with or was used with R-22.

The term “degree of superheat” or simply “superheat” means the temperature rise of the refrigerant at the exit of the evaporator above the saturated vapor temperature (or dew temperature) of the refrigerant.

The terms “R-1132(E)”, “HFO-1132(E)” and “transHFO-1132(E)” each means the trans isomer of 1,2-difluorethylene.

The terms “R-1132a” and “HFO-1132a” each means 1,1-difluoroethylene.

The terms “R-1123” and “HFO-1122” each means trifluoroethylene.

The terms “R-1234yf” and “HFO-1234yf” mean 2,3,3,3-tetrafluoropropene.

The terms “R-1234ze(E)” and “HFO-1234ze(E)” means the trans isomer of 1,3,3,3-tetrafluoropropene.

The terms “HFC-32” and “R-32” each mean difluoromethane.

The term “R-22” means chlorodifluoromethane.

The term “R-290” means propane.

The term “R407C” means a blend of refrigerants consisting of 23 wt. %+/−2 wt. % of R-32, 25 wt. %+/−2 wt. % of R-125, and 52 wt. %+/−2 wt. % of R134a).

The term “R-290” means propane.

The term “R-410A” means a blend of refrigerants consisting of 50 wt. %+0.5/−1 wt. % of R-32 and 50 wt. %+1.5/−0.5 wt. % of R125.

The term “R-454B” means a blend of refrigerants consisting of 68.9 wt. %+1/−1 wt. % of R-32 and 31.1 wt. %+1/−1 wt. % of R-1234yf.

The term “R-454C” means a blend of refrigerants consisting of 21.5 wt. %+2/−2 wt. % of R-32 and 78.5 wt. %+2/−2 wt. % of R-1234yf.

The term “R-455A” means a blend of refrigerants consisting of 3.0 wt. %+2.0 wt. % of R-744, 21.5 wt. %+1/−1 wt. % of R-32 and 75.5 wt. %+2/−2 wt. % of R-1234yf.

The term “R-744” means carbon dioxide.

As used herein, reference to a defined group, such as “Heat Transfer Systems 1-2,” refers to each composition within that group, including wherein a definition number includes a suffix. Thus, reference to Heat Transfer Systems 1-2 includes reference to each of Heat Transfer System 1, Heat Transfer System 2A and Heat Transfer System 2B.

### II. Refrigerants and Heat Transfer Compositions

The present disclosure encompasses refrigerants and heat transfer compositions which comprise, consist essentially of, or consist of blends of one or more of R-32, R-1132(E), and R-1234yf. Generally, the heat transfer compositions will also comprise a lubricant.

### A. Refrigerant Compositions

The preferred refrigerant compositions of the present invention, including each of Refrigerants 1-3, are especially useful in connection generally with the heat transfer methods and heat transfer systems.

Preferred refrigerants according to the present invention are identified and defined in the following Refrigerant Table (Table 1).

TABLE 1

| | | | | Amount of | | | |
|---|---|---|---|---|---|---|---|
| | | | | three components | | | |
| | Wt % (based on the listed | | | together based on | Refrigerant | | |
| Refrigerant | three components) | | | all refrigerants, | Properties** | | Excluded |
| No. | R-32 | R-1132(E) | R-1234yf | wt %* | GWP | Flam | components*** |
| Refrigerant | 21.5 | 26.8 | 51.7 | =>99.5% | NR | NR | NA |
| 4A1 | | | | | | | |
| Refrigerant | 21.5 | 30.0 | 48.5 | =>99.5% | NR | NR | NA |
| 4A2 | | | | | | | |
| Refrigerant | 21.5 | 35.0 | 43.5 | =>99.5% | NR | NR | NA |
| 4A3 | | | | | | | |
| Refrigerant | 21.5 | 38.0 | 40.5 | =>99.5% | NR | NR | NA |
| 4A4 | | | | | | | |
| Refrigerant | 20-25 | 15-45 | 35-65 | =>97 | NR | NR | NA |
| 5A1 | | | | | | | |
| Refrigerant | 20-25 | 15-45 | 35-65 | =>99 | NR | NR | NA |
| 5B1 | | | | | | | |
| Refrigerant | 20-25 | 15-45 | 35-65 | CEO | NR | NR | NA |
| 5C1 | | | | | | | |
| Refrigerant | 20-25 | 15-45 | 35-65 | CO | NR | NR | NA |
| 5D1 | | | | | | | |
| Refrigerant | 20-25 | 25-45 | 35-55 | =>97 | NR | NR | NA |
| 5A21 | | | | | | | |
| Refrigerant | 20-25 | 25-45 | 35-55 | =>99 | NR | NR | NA |
| 5B2 | | | | | | | |
| Refrigerant | 20-25 | 25-45 | 35-55 | CEO | NR | NR | NA |
| 5C2 | | | | | | | |
| Refrigerant | 20-25 | 25-45 | 35-55 | CO | NR | NR | NA |
| 5D2 | | | | | | | |
| Refrigerant | 20-25 | 15-45 | 35-65 | =>97 | =<150 | 2L | NA |
| 5E1 | | | | | | | |
| Refrigerant | 20-25 | 25-45 | 35-55 | =>97 | =<150 | 2L | NA |
| 5E2 | | | | | | | |
| Refrigerant | 20-25 | 15-45 | 35-65 | =>97 | =<150 | 1A | NA |
| 5F1 | | | | | | | |
| Refrigerant | 20-25 | 25-45 | 35-55 | =>97 | =<150 | 1A | NA |
| 5F2 | | | | | | | |
| Refrigerant | 20-25 | 15-45 | 35-65 | =>97 | =<150 | 2L | R-1132a |
| 5G2 | | | | | | | |
| Refrigerant | 20-25 | 25-45 | 35-55 | =>97 | =<150 | 2L | R-1132a |
| 5G2 | | | | | | | |
| Refrigerant | 20-25 | 15-45 | 35-65 | =>97 | =<150 | 2L | R-1234ze |
| 5H1 | | | | | | | |
| Refrigerant | 20-25 | 25-45 | 35-55 | =>97 | =<150 | 2L | R-1234ze |
| 5H2 | | | | | | | |
| Refrigerant | 20-25 | 15-45 | 35-65 | =>97 | =<150 | 2L | R-1132a and |
| 5I1 | | | | | | | R-1234ze |
| Refrigerant | 20-25 | 25-45 | 35-55 | =>97 | =<150 | 2L | R-1132a and |
| 5I2 | | | | | | | R-1234ze |
| Refrigerant | 20-22 | 25-45 | 40-52 | =>97 | NR | 2L | NA |
| 6A | | | | | | | |
| Refrigerant | 20-22 | 25-45 | 40-52 | =>99 | NR | 2L | NA |
| 6B | | | | | | | |
| Refrigerant | 21-22 | 25-40 | 40-52 | CEO | NR | 2L | NA |
| 6C | | | | | | | |
| Refrigerant | 21-22 | 25-40 | 40-52 | CO | NR | 2L | NA |
| 6D | | | | | | | |
| Refrigerant | 21-22 | 25-40 | 40-52 | =>97 | =<150 | 2L | NA |
| 6E | | | | | | | |
| Refrigerant | 21-22 | 25-40 | 40-52 | =>97 | =<150 | 2L | NA |
| 6F | | | | | | | |
| Refrigerant | 21-22 | 25-40 | 40-52 | =>97 | =<150 | 2L | R-1132a |
| 6G | | | | | | | |
| Refrigerant | 21-22 | 25-40 | 40-52 | =>97 | =<150 | 2L | R-1234ze |
| 6H | | | | | | | |
| Refrigerant | 21-22 | 25-40 | 40-52 | =>97 | =<150 | 2L | R-1132a and |
| 6I | | | | | | | R-1234ze |
| Refrigerant | 21.5 + 2/−2 | 38.0 + 2/−2 | 40.5 + 2/−2 | =>97 | NR | 2L | NA |
| 7A | | | | | | | |
| Refrigerant | 21.5 + 2/−2 | 38.0 + 2/−2 | 40.5 + 2/−2 | =>99 | NR | 2L | NA |
| 7B | | | | | | | |
| Refrigerant | 21.5 + 2/−2 | 38.0 + 2/−2 | 40.5 + 2/−2 | CEO | NR | 2L | NA |
| 7C | | | | | | | |
| Refrigerant | 21.5 + 2/−2 | 38.0 + 2/−2 | 40.5 + 2/−2 | CO | NR | 2L | NA |
| 7D | | | | | | | |
| Refrigerant | 21.5 + 2/−2 | 38.0 + 2/−2 | 40.5 + 2/−2 | =>97 | =<150 | 2L | NA |
| 7E | | | | | | | |
| Refrigerant | 21.5 + 2/−2 | 38.0 + 2/−2 | 40.5 + 2/−2 | =>97 | =<150 | 2L | NA |
| 7F | | | | | | | |
| Refrigerant | 21.5 + 2/−2 | 38.0 + 2/−2 | 40.5 + 2/−2 | =>97 | =<150 | 2L | R-1132a |
| 7G | | | | | | | |
| Refrigerant | 21.5 + 2/−2 | 38.0 + 2/−2 | 40.5 + 2/−2 | =>97 | =<150 | 2L | R-1234ze |
| 7H | | | | | | | |
| Refrigerant | 21.5 + 2/−2 | 38.0 + 2/−2 | 40.5 + 2/−2 | =>97 | =<150 | 2L | R-1132a and |
| 7I | | | | | | | R-1234ze |

*The following designations have the following meanings in the table: CEO means that the refrigerant consists essentially of the three components; CO means that the refrigerant consists of the three components.
**The designation “NR” means not required according to the definition for that Refrigerant. The column heading “Flam” means flammability by class designation.
***Components when identified in the column means that the refrigerant does not include an amount of the indicated component above contamination levels, with the designation NA meaning that no components are excluded by the definition for that Refrigerant.

For the purposes of definition of terms used herein, it is to be noted that reference will be made at various locations herein to the Refrigerant as identified in the first column in each of the rows in the Refrigerant table above, and reference to each of these numbers is a reference to a refrigerant as defined in the corresponding columns of that row. Reference to a group of Refrigerants that have been defined in the table above by reference to a Refrigerant number means separately and individually each such numbered Refrigerant, including each Refrigerant having the indicated number, including any such number that has a suffix. So for example, reference to Refrigerant 4 is a separate and independent reference to Refrigerant 4A1, Refrigerant 4A2, Refrigerant 4A3, Refrigerant 4A4. This use convention is used for all definition tables in the present disclosure.

In preferred embodiments, refrigerant compositions of the present invention, including each of Refrigerants 1-7 have a GWP below 150 and provide the required efficiency and capacity thresholds for preferred embodiments, including heat pump systems and air conditioning systems.

### B. Heat Transfer Compositions

The present disclosure also provides heat transfer compositions which comprise the refrigerant compositions described in Section A above.

The heat transfer compositions generally comprise a refrigerant according to the present disclosure, including each of Refrigerants 1-7, and a lubricant. For the purpose of convenience, a heat transfer composition according to the present invention is referred to for convenience as Heat Transfer Composition 1.

Applicants have found that the heat transfer compositions of the present invention, including heat transfer compositions that include a lubricant, and particularly a polyol ester (POE) lubricant and/or polyvinyl ether (PVE) lubricant and each of Refrigerants 1-7 as described herein, is capable of providing exceptionally advantageous properties including, in addition to the advantageous properties identified herein with respect to the refrigerant, excellent refrigerant/lubricant compatibility, including acceptable miscibility with POE and/or PVE lubricants over the operating temperature and concentration ranges for the intended use, including particularly for residential air conditioning and residential heat pumps.

Other commonly used refrigerant lubricants such as polyalkylene glycols (PAGs), PAG oils, silicone oils, mineral oil, alkylbenzenes (ABs), polyethers (PEs) and poly(alpha-olefin) (PAO) that are used in refrigeration machinery may be also used with the refrigerant compositions of the present invention, including each of Refrigerants 1-7.

In preferred embodiments, the heat transfer composition comprises a lubricant in an amount as low as 0.1 wt. %, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, or within any range encompassed by any two of the foregoing values as endpoints, based on the total weight of the heat transfer composition.

A lubricant consisting essentially of a POE having a viscosity at 40° C. measured in accordance with ASTM D445 of from about 30 to about 70 is preferred for use.

Commercially available POEs that are preferred for use in the present heat transfer compositions include neopentyl glycol dipelargonate which is available as Emery 2917 (registered trademark) and Hatcol 2370 (registered trademark) and pentaerythritol derivatives including those sold under the trade designations Emkarate RL32-3MAF and Emkarate RL68H by CPI Fluid Engineering. Emkarate RL32-3MAF and Emkarate RL68H are preferred POE lubricants having the properties identified below:

| Property | RL32-3MAF | RL68H |
|---|---|---|
| Viscosity | about 31 | about 67 |
| @ 40° C. (ASTM D445), cSt | | |
| Viscosity | about 5.6 | about 9.4 |
| @ 100° C. (ASTM D445), cSt | | |
| Pour Point (ASTM D97), ° C. | about −40 | about −40 |

The lubricant of the present invention can include PVE lubricants generally. In preferred embodiments the PVE lubricant is as PVE according to Formula II below:

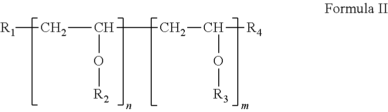

where R2 and R3 are each independently C1-C10 hydrocarbons, preferably C2-C8 hydrocarbons, and R1 and R4 are each independently alkyl, alkylene glycol, or polyoxyalkylene glycol units and n and m are selected preferably according to the needs of those skilled in the art to obtain a lubricant with the desired properties, and preferable n and m are selected to obtain a lubricant with a viscosity at 40° C. measured in accordance with ASTM D467 of from about 30 to about 70 cSt. Commercially available polyvinyl ethers include those lubricants sold under the trade designations FVC32D and FVC68D, from Idemitsu.

Other additives not mentioned herein can also be included by those skilled in the art in view of the teaching contained herein without departing from the novel and basic features of the present disclosure.

Combinations of surfactants and solubilizing agents may also be added to the present compositions to aid oil solubility as disclosed in U.S. Pat. No. 6,516,837, the disclosure of which is incorporated by reference in its entirety.

Other optional components that may be included in the heat transfer composition include a compatibilizer, such as propane, for the purpose of aiding compatibility and/or solubility of the lubricant. When present, such compatibilizers, including propane, butanes and pentanes, are preferably present in amounts of from about 0.5 to about 5 percent by weight of the composition. Combinations of surfactants and solubilizing agents may also be added to the present compositions to aid oil solubility, as disclosed by U.S. Pat. No. 6,516,837, the disclosure of which is incorporated by reference.

The heat transfer compositions (HTCs) according to the present invention comprise a refrigerant of the present invention (identified by Refrigerant Number) and lubricant as identified and defined in the following Heat Transfer Composition Table (Table 2).

TABLE 2

| | | Refrigerant | | Lubricant |
|---|---|---|---|---|
| | Refrigerant | amount, | Lubricant | Amount. |
| HTC No. | No. | wt % | Type* | Wt % |
| HTC1A | 1 | 90-99.9 | NR | NR |
| HTC1B | 1 | 90-99.9 | NR | 0.1-10 |
| HTC1C | 1 | 90-99.9 | POE | NR |
| HTC1D | 1 | 90-99.9 | POE | 0.1-10 |
| HTC1E | 1 | 90-99.9 | PVE | NR |
| HTC1F | 1 | 90-99.9 | PVE | 0.1-10 |
| HTC2A | 2 | 90-99.9 | NR | NR |
| HTC2B | 2 | 90-99.9 | NR | 0.1-10 |
| HTC2C | 2 | 90-99.9 | POE | NR |
| HTC2D | 2 | 90-99.9 | POE | 0.1-10 |
| HTC2E | 2 | 90-99.9 | PVE | NR |
| HTC2F | 2 | 90-99.9 | PVE | 0.1-10 |
| HTC3A | 3 | 90-99.9 | NR | NR |
| HTC3B | 3 | 90-99.9 | NR | 0.1-10 |
| HTC3C | 3 | 90-99.9 | POE | NR |
| HTC3D | 3 | 90-99.9 | POE | 0.1-10 |
| HTC3E | 3 | 90-99.9 | PVE | NR |
| HTC3F | 3 | 90-99.9 | PVE | 0.1-10 |
| HTC4A1A | 4A1 | 90-99.9 | NR | NR |
| HTC4A1B | 4A1 | 90-99.9 | NR | 0.1-10 |
| HTC4A1C | 4A1 | 90-99.9 | POE | NR |
| HTC4A1D | 4A1 | 90-99.9 | POE | 0.1-10 |
| HTC4A1E | 4A1 | 90-99.9 | PVE | NR |
| HTC4A1F | 4A1 | 90-99.9 | PVE | 0.1-10 |
| HTC4A2A | 4A2 | 90-99.9 | NR | NR |
| HTC4A2B | 4A2 | 90-99.9 | NR | 0.1-10 |
| HTC4A2C | 4A2 | 90-99.9 | POE | NR |
| HTC4A2D | 4A2 | 90-99.9 | POE | 0.1-10 |
| HTC4A2E | 4A2 | 90-99.9 | PVE | NR |
| HTC4A2F | 4A2 | 90-99.9 | PVE | 0.1-10 |
| HTC4A3A | 4A3 | 90-99.9 | NR | NR |
| HTC4A3B | 4A3 | 90-99.9 | NR | 0.1-10 |
| HTC4A3C | 4A3 | 90-99.9 | POE | NR |
| HTC4A3D | 4A3 | 90-99.9 | POE | 0.1-10 |
| HTC4A3E | 4A3 | 90-99.9 | PVE | NR |
| HTC4A3F | 4A3 | 90-99.9 | PVE | 0.1-10 |
| HTC4A4A | 4A4 | 90-99.9 | NR | NR |
| HTC4A4B | 4A4 | 90-99.9 | NR | 0.1-10 |
| HTC4A4C | 4A4 | 90-99.9 | POE | NR |
| HTC4A4D | 4A4 | 90-99.9 | POE | 0.1-10 |
| HTC4A4E | 4A4 | 90-99.9 | PVE | NR |
| HTC4A4F | 4A4 | 90-99.9 | PVE | 0.1-10 |
| HTC5A1 | 5A | 90-99.9 | NR | NR |
| HTC5A2 | 5A | 90-99.9 | NR | 0.1-10 |
| HTC5A3 | 5A | 90-99.9 | POE | NR |
| HTC5A4 | 5A | 90-99.9 | POE | 0.1-10 |
| HTC5A5 | 5A | 90-99.9 | PVE | NR |
| HTC5A6 | 5A | 90-99.9 | PVE | 0.1-10 |
| HTC5B1 | 5B | 90-99.9 | NR | NR |
| HTC5B2 | 5B | 90-99.9 | NR | 0.1-10 |
| HTC5B3 | 5B | 90-99.9 | POE | NR |
| HTC5B4 | 5B | 90-99.9 | POE | 0.1-10 |
| HTC5B5 | 5B | 90-99.9 | PVE | NR |
| HTC5B6 | 5B | 90-99.9 | PVE | 0.1-10 |
| HTC5C1 | 5C | 90-99.9 | NR | NR |
| HTC5C2 | 5C | 90-99.9 | NR | 0.1-10 |
| HTC5C3 | 5C | 90-99.9 | POE | NR |
| HTC5C4 | 5C | 90-99.9 | POE | 0.1-10 |
| HTC5C5 | 5C | 90-99.9 | PVE | NR |
| HTC5C6 | 5C | 90-99.9 | PVE | 0.1-10 |
| HTC5D1 | 5D | 90-99.9 | NR | NR |
| HTC5D2 | 5D | 90-99.9 | NR | 0.1-10 |
| HTC5D3 | 5D | 90-99.9 | POE | NR |
| HTC5D4 | 5D | 90-99.9 | POE | 0.1-10 |
| HTC5D5 | 5D | 90-99.9 | PVE | NR |
| HTC5D6 | 5D | 90-99.9 | PVE | 0.1-10 |
| HTC5E1 | 5E | 90-99.9 | NR | NR |
| HTC5E2 | 5E | 90-99.9 | NR | 0.1-10 |
| HTC5E3 | 5E | 90-99.9 | POE | NR |
| HTC5E4 | 5E | 90-99.9 | POE | 0.1-10 |
| HTC5E5 | 5E | 90-99.9 | PVE | NR |
| HTC5E6 | 5E | 90-99.9 | PVE | 0.1-10 |
| HTC5F1 | 5F | 90-99.9 | NR | NR |
| HTC5F2 | 5F | 90-99.9 | NR | 0.1-10 |
| HTC5F3 | 5F | 90-99.9 | POE | NR |
| HTC5F4 | 5F | 90-99.9 | POE | 0.1-10 |
| HTC5F5 | 5F | 90-99.9 | PVE | NR |
| HTC5F6 | 5F | 90-99.9 | PVE | 0.1-10 |
| HTC5G1 | 5G | 90-99.9 | NR | NR |
| HTC5G2 | 5G | 90-99.9 | NR | 0.1-10 |
| HTC5G3 | 5G | 90-99.9 | POE | NR |
| HTC5G4 | 5G | 90-99.9 | POE | 0.1-10 |
| HTC5G5 | 5G | 90-99.9 | PVE | NR |
| HTC5G6 | 5G | 90-99.9 | PVE | 0.1-10 |
| HTC5H1 | 5H | 90-99.9 | NR | NR |
| HTC5H2 | 5H | 90-99.9 | NR | 0.1-10 |
| HTC5H3 | 5H | 90-99.9 | POE | NR |
| HTC5H4 | 5H | 90-99.9 | POE | 0.1-10 |
| HTC5H5 | 5H | 90-99.9 | PVE | NR |
| HTC5H6 | 5H | 90-99.9 | PVE | 0.1-10 |
| HTC5I1 | 5I | 90-99.9 | NR | NR |
| HTC5I2 | 5I | 90-99.9 | NR | 0.1-10 |
| HTC5I3 | 5I | 90-99.9 | POE | NR |
| HTC5I4 | 5I | 90-99.9 | POE | 0.1-10 |
| HTC5I5 | 5I | 90-99.9 | PVE | NR |
| HTC5I6 | 5I | 90-99.9 | PVE | 0.1-10 |
| HTC6A1 | 6A | 90-99.9 | NR | NR |
| HTC6A2 | 6A | 90-99.9 | NR | 0.1-10 |
| HTC6A3 | 6A | 90-99.9 | POE | NR |
| HTC6A4 | 6A | 90-99.9 | POE | 0.1-10 |
| HTC6A5 | 6A | 90-99.9 | PVE | NR |
| HTC6A6 | 6A | 90-99.9 | PVE | 0.1-10 |
| HTC6B1 | 6B | 90-99.9 | NR | NR |
| HTC6B2 | 6B | 90-99.9 | NR | 0.1-10 |
| HTC6B3 | 6B | 90-99.9 | POE | NR |
| HTC6B4 | 6B | 90-99.9 | POE | 0.1-10 |
| HTC6B5 | 6B | 90-99.9 | PVE | NR |
| HTC6B6 | 6B | 90-99.9 | PVE | 0.1-10 |
| HTC6C1 | 6C | 90-99.9 | NR | NR |
| HTC6C2 | 6C | 90-99.9 | NR | 0.1-10 |
| HTC6C3 | 6C | 90-99.9 | POE | NR |
| HTC6C4 | 6C | 90-99.9 | POE | 0.1-10 |
| HTC6C5 | 6C | 90-99.9 | PVE | NR |
| HTC6C6 | 6C | 90-99.9 | PVE | 0.1-10 |
| HTC6D1 | 6D | 90-99.9 | NR | NR |
| HTC6D2 | 6D | 90-99.9 | NR | 0.1-10 |
| HTC6D3 | 6D | 90-99.9 | POE | NR |
| HTC6D4 | 6D | 90-99.9 | POE | 0.1-10 |
| HTC6D5 | 6D | 90-99.9 | PVE | NR |
| HTC6D6 | 6D | 90-99.9 | PVE | 0.1-10 |
| HTC6E1 | 6E | 90-99.9 | NR | NR |
| HTC6E2 | 6E | 90-99.9 | NR | 0.1-10 |
| HTC6E3 | 6E | 90-99.9 | POE | NR |
| HTC6E4 | 6E | 90-99.9 | POE | 0.1-10 |
| HTC6E5 | 6E | 90-99.9 | PVE | NR |
| HTC6E6 | 6E | 90-99.9 | PVE | 0.1-10 |
| HTC6F1 | 6F | 90-99.9 | NR | NR |
| HTC6F2 | 6F | 90-99.9 | NR | 0.1-10 |
| HTC6F3 | 6F | 90-99.9 | POE | NR |
| HTC6F4 | 6F | 90-99.9 | POE | 0.1-10 |
| HTC6F5 | 6F | 90-99.9 | PVE | NR |
| HTC6F6 | 6F | 90-99.9 | PVE | 0.1-10 |
| HTC6G1 | 6G | 90-99.9 | NR | NR |
| HTC6G2 | 6G | 90-99.9 | NR | 0.1-10 |
| HTC6G3 | 6G | 90-99.9 | POE | NR |
| HTC6G4 | 6G | 90-99.9 | POE | 0.1-10 |
| HTC6G5 | 6G | 90-99.9 | PVE | NR |
| HTC6G6 | 6G | 90-99.9 | PVE | 0.1-10 |
| HTC6H1 | 6H | 90-99.9 | NR | NR |
| HTC6H2 | 6H | 90-99.9 | NR | 0.1-10 |
| HTC6H3 | 6H | 90-99.9 | POE | NR |
| HTC6H4 | 6H | 90-99.9 | POE | 0.1-10 |
| HTC6H5 | 6H | 90-99.9 | PVE | NR |
| HTC6H6 | 6H | 90-99.9 | PVE | 0.1-10 |
| HTC6I1 | 6I | 90-99.9 | NR | NR |
| HTC6I2 | 6I | 90-99.9 | NR | 0.1-10 |
| HTC6I3 | 6I | 90-99.9 | POE | NR |
| HTC6I4 | 6I | 90-99.9 | POE | 0.1-10 |
| HTC6I5 | 6I | 90-99.9 | PVE | NR |
| HTC6I6 | 6I | 90-99.9 | PVE | 0.1-10 |
| HTC7A1 | 7A | 90-99.9 | NR | NR |
| HTC7A2 | 7A | 90-99.9 | NR | 0.1-10 |
| HTC7A3 | 7A | 90-99.9 | POE | NR |
| HTC7A4 | 7A | 90-99.9 | POE | 0.1-10 |
| HTC7A5 | 7A | 90-99.9 | PVE | NR |
| HTC7A6 | 7A | 90-99.9 | PVE | 0.1-10 |
| HTC7B1 | 7B | 90-99.9 | NR | NR |
| HTC7B2 | 7B | 90-99.9 | NR | 0.1-10 |
| HTC7B3 | 7B | 90-99.9 | POE | NR |
| HTC7B4 | 7B | 90-99.9 | POE | 0.1-10 |
| HTC7B5 | 7B | 90-99.9 | PVE | NR |
| HTC7B6 | 7B | 90-99.9 | PVE | 0.1-10 |
| HTC7C1 | 7C | 90-99.9 | NR | NR |
| HTC7C2 | 7C | 90-99.9 | NR | 0.1-10 |
| HTC7C3 | 7C | 90-99.9 | POE | NR |
| HTC7C4 | 7C | 90-99.9 | POE | 0.1-10 |
| HTC7C5 | 7C | 90-99.9 | PVE | NR |
| HTC7C6 | 7C | 90-99.9 | PVE | 0.1-10 |
| HTC7D1 | 7D | 90-99.9 | NR | NR |
| HTC7D2 | 7D | 90-99.9 | NR | 0.1-10 |
| HTC7D3 | 7D | 90-99.9 | POE | NR |
| HTC7D4 | 7D | 90-99.9 | POE | 0.1-10 |
| HTC7D5 | 7D | 90-99.9 | PVE | NR |
| HTC7D6 | 7D | 90-99.9 | PVE | 0.1-10 |
| HTC7E1 | 7E | 90-99.9 | NR | NR |
| HTC7E2 | 7E | 90-99.9 | NR | 0.1-10 |
| HTC7E3 | 7E | 90-99.9 | POE | NR |
| HTC7E4 | 7E | 90-99.9 | POE | 0.1-10 |
| HTC7E5 | 7E | 90-99.9 | PVE | NR |
| HTC7E6 | 7E | 90-99.9 | PVE | 0.1-10 |
| HTC7F1 | 7F | 90-99.9 | NR | NR |
| HTC7F2 | 7F | 90-99.9 | NR | 0.1-10 |
| HTC7F3 | 7F | 90-99.9 | POE | NR |
| HTC7F4 | 7F | 90-99.9 | POE | 0.1-10 |
| HTC7F5 | 7F | 90-99.9 | PVE | NR |
| HTC7F6 | 7F | 90-99.9 | PVE | 0.1-10 |
| HTC7G1 | 7G | 90-99.9 | NR | NR |
| HTC7G2 | 7G | 90-99.9 | NR | 0.1-10 |
| HTC7G3 | 7G | 90-99.9 | POE | NR |
| HTC7G4 | 7G | 90-99.9 | POE | 0.1-10 |
| HTC7G5 | 7G | 90-99.9 | PVE | NR |
| HTC7G6 | 7G | 90-99.9 | PVE | 0.1-10 |
| HTC7H1 | 7H | 90-99.9 | NR | NR |
| HTC7H2 | 7H | 90-99.9 | NR | 0.1-10 |
| HTC7H3 | 7H | 90-99.9 | POE | NR |
| HTC7H4 | 7H | 90-99.9 | POE | 0.1-10 |
| HTC7H5 | 7H | 90-99.9 | PVE | NR |
| HTC7H6 | 7H | 90-99.9 | PVE | 0.1-10 |
| HTC7I1 | 7I | 90-99.9 | NR | NR |
| HTC7I2 | 7I | 90-99.9 | NR | 0.1-10 |
| HTC7I3 | 7I | 90-99.9 | POE | NR |
| HTC7I4 | 7I | 90-99.9 | POE | 0.1-10 |
| HTC7I5 | 7I | 90-99.9 | PVE | NR |
| HTC7I6 | 7I | 90-99.9 | PVE | 0.1-10 |

*The following designations have the following meanings in the table: NR means that the type or amount is not required, i.e, that all types and amounts are within the definition.

### III. Systems

The present disclosure includes heat transfer systems of all types that include refrigerants of the present disclosure and/or that include heat transfer compositions of the disclosure.

The present disclosure also includes, and provides a particular advantage in connection with, systems that include the refrigerants or heat transfer compositions of the present disclosure such as heat pump systems (especially in air-to-water system) and air conditioning systems.

For heat transfer systems of the present disclosure that include a compressor and lubricant for the compressor in the system, the system can comprises a loading of refrigerant of the present disclosure, including each of Refrigerants 1-7, and lubricant, including POE and PVE lubricant, such that the lubricant loading in the system is from about 5% to 60% by weight, or from about 10% to about 60% by weight, or from about 20% to about 50% by weight, or from about 20% to about 40% by weight, or from about 20% to about 30% by weight, or from about 30% to about 50% by weight, or from about 30% to about 40% by weight. As used herein, the term “lubricant loading” refers to the total weight of lubricant contained in the system as a percentage of total of lubricant and refrigerant contained in the system. Such systems may also include a lubricant loading of from about 5% to about 10% by weight, or about 8% by weight of the heat transfer composition.

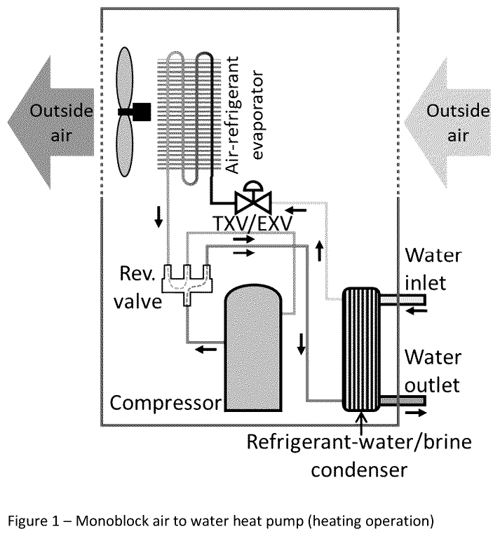

As described in detail below, the reference system of the present disclosure comprises a compressor, a condenser, an expansion device, and an evaporator, all connected in fluid communication using piping, valving, and control systems such that the refrigerant and associate components of the refrigerant, including each of Refrigerants 1-7 or heat transfer compositions, including each of HTC1-7, can flow through the system in known fashion to complete the vapor compression cycle. An exemplary schematic of such a basic system is illustrated in FIG. 1. In particular, the system schematically illustrated in FIG. 1 shows a compressor 10, which provides compressed refrigerant vapor to condenser 20. The compressed refrigerant vapor is condensed to produce a liquid refrigerant which is then directed to an expansion device 40 that produces refrigerant at reduced temperature and pressure, which in turn is then provided to an evaporator 50. In the evaporator 50 the liquid refrigerant absorbs heat from the body of fluid being cooled, thus producing refrigerant vapor which is then provided to the suction line of the compressor.

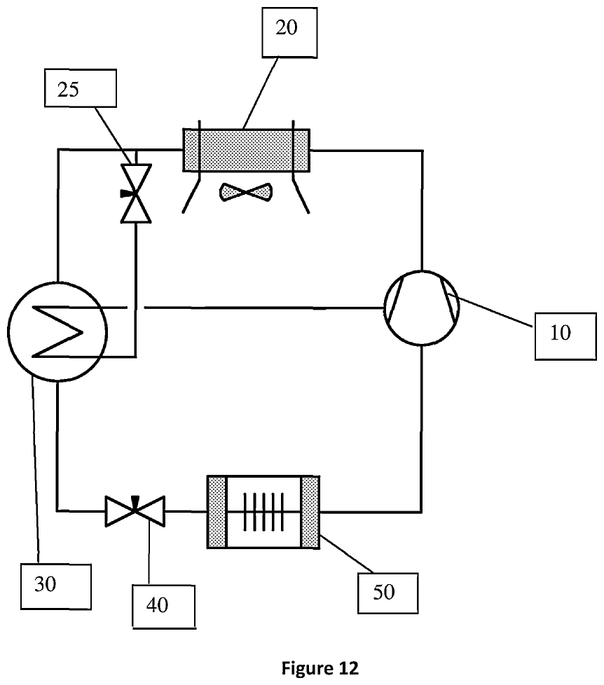

As described in detail below and in connection with FIG. 12, the preferred systems of the present disclosure, including each of Heat Transfer System 1A and Heat Transfer System 1B, can comprise a compressor with a vapor injection port, a condenser, a secondary expansion device 25, a refrigerant-refrigerant heat exchanger 30 (the secondary expansion device and the heat exchanger together sometimes referred to herein as an “economizer”), a primary expansion device 40 and an evaporator. An exemplary schematic of such system is illustrated in FIG. 12. In particular, the system schematically illustrated in FIG. 12 shows a compressor 10, which provides compressed refrigerant vapor to condenser 20. The compressed refrigerant vapor is condensed to produce a liquid refrigerant which is then split to a secondary expansion device 25 that diverts a portion of the refrigerant flow and produces refrigerant at reduced temperature medium-pressure, which in turn is then provided to a refrigerant-refrigerant heat exchanger 30. The medium-pressure liquid refrigerant in the refrigerant-refrigerant heat exchanger absorbs heat from the high-pressure liquid refrigerant, thus producing refrigerant vapor which is then provided to the vapor injection port on the compressor 10. The high-pressure liquid refrigerant is cooled in the refrigerant-refrigerant heat exchanger providing subcooled liquid to the primary expansion device 40. The expansion device 40 produces liquid refrigerant at a low-pressure and relatively low temperature which enter the evaporator 50 where the liquid refrigerant absorbs heat from the body or fluid being cooled, thus producing a refrigerant vapor which is then provided to the suction line of the compressor.

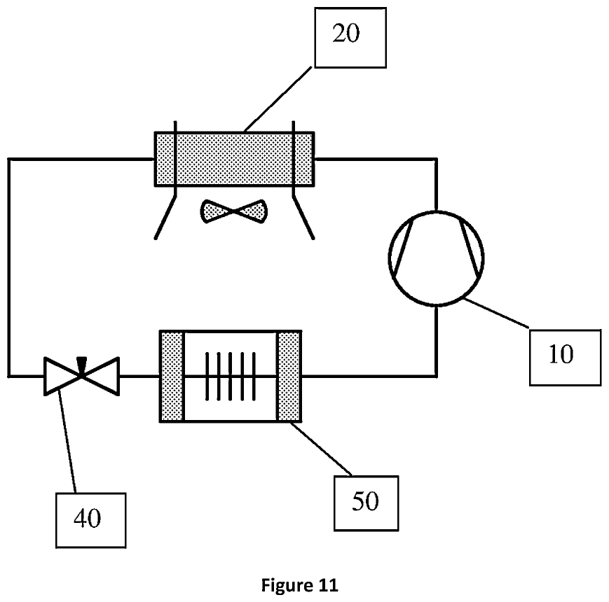

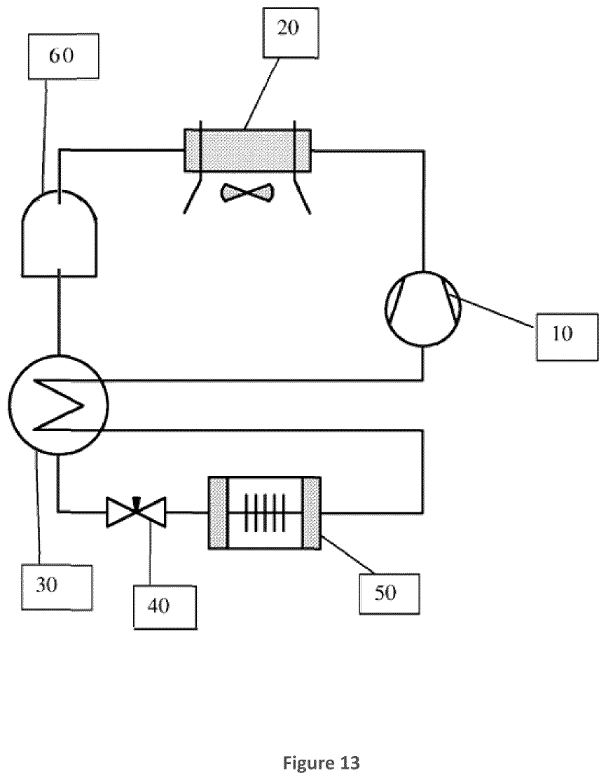

The refrigeration system illustrated in FIG. 13 is the same as described above in connection with FIG. 11 except that it includes a liquid line/suction line heat exchanger. At least a portion of the refrigerant leaving the condenser (or all of the refrigerant as shown in FIG. 13) is diverted to the liquid line/suction line heat exchanger, where heat is transferred from the high-pressure liquid refrigerant to the low-pressure refrigerant leaving the evaporator.

It will be appreciated by those skilled in the art that the different equipment/configuration options shown separately in each of FIGS. 11-13 can be combined and used together as deemed advantageous for any application, including each of Heat Transfer Systems 1-2.

### IV. Uses

The methods and systems of the present disclosure may comprise any heat transfer system and/or any heat transfer method which utilize a refrigerant or heat transfer composition as described herein.

The present disclosure also includes and provides particular advantage in connection with use of the refrigerants of the present disclosure in heat pumps systems (particularly air-to-water heat pump systems) and air conditioning systems.

The present disclosure also includes and provides a particular advantage in connection with use of the refrigerants of the present disclosure as a replacement for R-22, R-407, R-410A, R-32, R-290, R-454Ba, R-454 and R-455A.

The present disclosure also includes and provides a particular advantage in connection with replacement of any of R-22, R-407, R-410A, R-32, R-290, R-454B, R-454, R-455A in any of the following systems: Residential and commercial air-to-water heat pumps, air-to-water air conditioning systems and air-to-air heat pumps, air conditioning systems, and ground-source or water-source heat pumps and air conditioning systems.

The following Table 3 provides particularly preferred combinations of the present refrigerants as replacements for prior refrigerants in particular heat pump systems.

TABLE 3

| | Re- | | | |
|---|---|---|---|---|
| | frigerant | | | |
| | Being | | Outdoor | Indoor |
| | Re- | | Heat | Indirect |
| Refrigerant No. | placed | System Type | Sink | Fluid |
| Refrigerant 1 | R22 | Residential Heat Pump | Air | NR |
| Refrigerant 2 | R22 | Residential Heat Pump | Air | NR |
| Refrigerant 3 | R22 | Residential Heat Pump | Air | NR |
| Refrigerant 4A1 | R22 | Residential Heat Pump | Air | NR |
| Refrigerant 4A2 | R22 | Residential Heat Pump | Air | NR |
| Refrigerant 4A3 | R22 | Residential Heat Pump | Air | NR |
| Refrigerant 4A4 | R22 | Residential Heat Pump | Air | NR |
| Refrigerant 5A | R22 | Residential Heat Pump | Air | NR |
| Refrigerant 5B | R22 | Residential Heat Pump | Air | NR |
| Refrigerant 5C | R22 | Residential Heat Pump | Air | NR |
| Refrigerant 5D | R22 | Residential Heat Pump | Air | NR |
| Refrigerant 5E | R22 | Residential Heat Pump | Air | NR |
| Refrigerant 5F | R22 | Residential Heat Pump | Air | NR |
| Refrigerant 5G | R22 | Residential Heat Pump | Air | NR |
| Refrigerant 5H | R22 | Residential Heat Pump | Air | NR |
| Refrigerant 5I | R22 | Residential Heat Pump | Air | NR |
| Refrigerant 6A | R22 | Residential Heat Pump | Air | NR |
| Refrigerant 6B | R22 | Residential Heat Pump | Air | NR |
| Refrigerant 6C | R22 | Residential Heat Pump | Air | NR |
| Refrigerant 6D | R22 | Residential Heat Pump | Air | NR |
| Refrigerant 6E | R22 | Residential Heat Pump | Air | NR |
| Refrigerant 6F | R22 | Residential Heat Pump | Air | NR |
| Refrigerant 6G | R22 | Residential Heat Pump | Air | NR |
| Refrigerant 6H | R22 | Residential Heat Pump | Air | NR |
| Refrigerant 6I | R22 | Residential Heat Pump | Air | NR |
| Refrigerant 7A | R22 | Residential Heat Pump | Air | NR |
| Refrigerant 7B | R22 | Residential Heat Pump | Air | NR |
| Refrigerant 7C | R22 | Residential Heat Pump | Air | NR |
| Refrigerant 7D | R22 | Residential Heat Pump | Air | NR |
| Refrigerant 7E | R22 | Residential Heat Pump | Air | NR |
| Refrigerant 7F | R22 | Residential Heat Pump | Air | NR |
| Refrigerant 7G | R22 | Residential Heat Pump | Air | NR |
| Refrigerant 7H | R22 | Residential Heat Pump | Air | NR |
| Refrigerant 7I | R22 | Residential Heat Pump | Air | NR |
| Refrigerant 1 | R290 | Residential Heat Pump | Air | NR |
| Refrigerant 2 | R290 | Residential Heat Pump | Air | NR |
| Refrigerant 3 | R290 | Residential Heat Pump | Air | NR |
| Refrigerant 4A1 | R290 | Residential Heat Pump | Air | NR |
| Refrigerant 4A2 | R290 | Residential Heat Pump | Air | NR |
| Refrigerant 4A3 | R290 | Residential Heat Pump | Air | NR |
| Refrigerant 4A4 | R290 | Residential Heat Pump | Air | NR |
| Refrigerant 5A | R290 | Residential Heat Pump | Air | NR |
| Refrigerant 5B | R290 | Residential Heat Pump | Air | NR |
| Refrigerant 5C | R290 | Residential Heat Pump | Air | NR |
| Refrigerant 5D | R290 | Residential Heat Pump | Air | NR |
| Refrigerant 5E | R290 | Residential Heat Pump | Air | NR |
| Refrigerant 5F | R290 | Residential Heat Pump | Air | NR |
| Refrigerant 5G | R290 | Residential Heat Pump | Air | NR |
| Refrigerant 5H | R290 | Residential Heat Pump | Air | NR |
| Refrigerant 5I | R290 | Residential Heat Pump | Air | NR |
| Refrigerant 6A | R290 | Residential Heat Pump | Air | NR |
| Refrigerant 6B | R290 | Residential Heat Pump | Air | NR |
| Refrigerant 6C | R290 | Residential Heat Pump | Air | NR |
| Refrigerant 6D | R290 | Residential Heat Pump | Air | NR |
| Refrigerant 6E | R290 | Residential Heat Pump | Air | NR |
| Refrigerant 6F | R290 | Residential Heat Pump | Air | NR |
| Refrigerant 6G | R290 | Residential Heat Pump | Air | NR |
| Refrigerant 6H | R290 | Residential Heat Pump | Air | NR |
| Refrigerant 6I | R290 | Residential Heat Pump | Air | NR |
| Refrigerant 7A | R290 | Residential Heat Pump | Air | NR |
| Refrigerant 7B | R290 | Residential Heat Pump | Air | NR |
| Refrigerant 7C | R290 | Residential Heat Pump | Air | NR |
| Refrigerant 7D | R290 | Residential Heat Pump | Air | NR |
| Refrigerant 7E | R290 | Residential Heat Pump | Air | NR |
| Refrigerant 7F | R290 | Residential Heat Pump | Air | NR |
| Refrigerant 7G | R290 | Residential Heat Pump | Air | NR |
| Refrigerant 7H | R290 | Residential Heat Pump | Air | NR |
| Refrigerant 7I | R290 | Residential Heat Pump | Air | NR |
| Refrigerant 1 | R407C | Residential Heat Pump | Air | NR |
| Refrigerant 2 | R407C | Residential Heat Pump | Air | NR |
| Refrigerant 3 | R407C | Residential Heat Pump | Air | NR |
| Refrigerant 4A1 | R407C | Residential Heat Pump | Air | NR |
| Refrigerant 4A2 | R407C | Residential Heat Pump | Air | NR |
| Refrigerant 4A3 | R407C | Residential Heat Pump | Air | NR |
| Refrigerant 4A4 | R407C | Residential Heat Pump | Air | NR |
| Refrigerant 5A | R407C | Residential Heat Pump | Air | NR |
| Refrigerant 5B | R407C | Residential Heat Pump | Air | NR |
| Refrigerant 5C | R407C | Residential Heat Pump | Air | NR |
| Refrigerant 5D | R407C | Residential Heat Pump | Air | NR |
| Refrigerant 5E | R407C | Residential Heat Pump | Air | NR |
| Refrigerant 5F | R407C | Residential Heat Pump | Air | NR |
| Refrigerant 5G | R407C | Residential Heat Pump | Air | NR |
| Refrigerant 5H | R407C | Residential Heat Pump | Air | NR |
| Refrigerant 5I | R407C | Residential Heat Pump | Air | NR |
| Refrigerant 6A | R407C | Residential Heat Pump | Air | NR |
| Refrigerant 6B | R407C | Residential Heat Pump | Air | NR |
| Refrigerant 6C | R407C | Residential Heat Pump | Air | NR |
| Refrigerant 6D | R407C | Residential Heat Pump | Air | NR |
| Refrigerant 6E | R407C | Residential Heat Pump | Air | NR |
| Refrigerant 6F | R407C | Residential Heat Pump | Air | NR |
| Refrigerant 6G | R407C | Residential Heat Pump | Air | NR |
| Refrigerant 6H | R407C | Residential Heat Pump | Air | NR |
| Refrigerant 6I | R407C | Residential Heat Pump | Air | NR |
| Refrigerant 7A | R407C | Residential Heat Pump | Air | NR |
| Refrigerant 7B | R407C | Residential Heat Pump | Air | NR |
| Refrigerant 7C | R407C | Residential Heat Pump | Air | NR |
| Refrigerant 7D | R407C | Residential Heat Pump | Air | NR |
| Refrigerant 7E | R407C | Residential Heat Pump | Air | NR |
| Refrigerant 7F | R407C | Residential Heat Pump | Air | NR |
| Refrigerant 7G | R407C | Residential Heat Pump | Air | NR |
| Refrigerant 7H | R407C | Residential Heat Pump | Air | NR |
| Refrigerant 7I | R407C | Residential Heat Pump | Air | NR |
| Refrigerant 1 | R410A | Residential Heat Pump | Air | NR |
| Refrigerant 2 | R410A | Residential Heat Pump | Air | NR |
| Refrigerant 3 | R410A | Residential Heat Pump | Air | NR |
| Refrigerant 4A1 | R410A | Residential Heat Pump | Air | NR |
| Refrigerant 4A2 | R410A | Residential Heat Pump | Air | NR |
| Refrigerant 4A3 | R410A | Residential Heat Pump | Air | NR |
| Refrigerant 4A4 | R410A | Residential Heat Pump | Air | NR |
| Refrigerant 5A | R410A | Residential Heat Pump | Air | NR |
| Refrigerant 5B | R410A | Residential Heat Pump | Air | NR |
| Refrigerant 5C | R410A | Residential Heat Pump | Air | NR |
| Refrigerant 5D | R410A | Residential Heat Pump | Air | NR |
| Refrigerant 5E | R410A | Residential Heat Pump | Air | NR |
| Refrigerant 5F | R410A | Residential Heat Pump | Air | NR |
| Refrigerant 5G | R410A | Residential Heat Pump | Air | NR |
| Refrigerant 5H | R410A | Residential Heat Pump | Air | NR |
| Refrigerant 5I | R410A | Residential Heat Pump | Air | NR |
| Refrigerant 6A | R410A | Residential Heat Pump | Air | NR |
| Refrigerant 6B | R410A | Residential Heat Pump | Air | NR |
| Refrigerant 6C | R410A | Residential Heat Pump | Air | NR |
| Refrigerant 6D | R410A | Residential Heat Pump | Air | NR |
| Refrigerant 6E | R410A | Residential Heat Pump | Air | NR |
| Refrigerant 6F | R410A | Residential Heat Pump | Air | NR |
| Refrigerant 6G | R410A | Residential Heat Pump | Air | NR |
| Refrigerant 6H | R410A | Residential Heat Pump | Air | NR |
| Refrigerant 6I | R410A | Residential Heat Pump | Air | NR |
| Refrigerant 7A | R410A | Residential Heat Pump | Air | NR |
| Refrigerant 7B | R410A | Residential Heat Pump | Air | NR |
| Refrigerant 7C | R410A | Residential Heat Pump | Air | NR |
| Refrigerant 7D | R410A | Residential Heat Pump | Air | NR |
| Refrigerant 7E | R410A | Residential Heat Pump | Air | NR |
| Refrigerant 7F | R410A | Residential Heat Pump | Air | NR |
| Refrigerant 7G | R410A | Residential Heat Pump | Air | NR |
| Refrigerant 7H | R410A | Residential Heat Pump | Air | NR |
| Refrigerant 7I | R410A | Residential Heat Pump | Air | NR |
| Refrigerant 1 | R454B | Residential Heat Pump | Air | NR |
| Refrigerant 2 | R454B | Residential Heat Pump | Air | NR |
| Refrigerant 3 | R454B | Residential Heat Pump | Air | NR |
| Refrigerant 4A1 | R454B | Residential Heat Pump | Air | NR |
| Refrigerant 4A2 | R454B | Residential Heat Pump | Air | NR |
| Refrigerant 4A3 | R454B | Residential Heat Pump | Air | NR |
| Refrigerant 4A4 | R454B | Residential Heat Pump | Air | NR |
| Refrigerant 5A | R454B | Residential Heat Pump | Air | NR |
| Refrigerant 5B | R454B | Residential Heat Pump | Air | NR |
| Refrigerant 5C | R454B | Residential Heat Pump | Air | NR |
| Refrigerant 5D | R454B | Residential Heat Pump | Air | NR |
| Refrigerant 5E | R454B | Residential Heat Pump | Air | NR |
| Refrigerant 5F | R454B | Residential Heat Pump | Air | NR |
| Refrigerant 5G | R454B | Residential Heat Pump | Air | NR |
| Refrigerant 5H | R454B | Residential Heat Pump | Air | NR |
| Refrigerant 5I | R454B | Residential Heat Pump | Air | NR |
| Refrigerant 6A | R454B | Residential Heat Pump | Air | NR |
| Refrigerant 6B | R454B | Residential Heat Pump | Air | NR |
| Refrigerant 6C | R454B | Residential Heat Pump | Air | NR |
| Refrigerant 6D | R454B | Residential Heat Pump | Air | NR |
| Refrigerant 6E | R454B | Residential Heat Pump | Air | NR |
| Refrigerant 6F | R454B | Residential Heat Pump | Air | NR |
| Refrigerant 6G | R454B | Residential Heat Pump | Air | NR |
| Refrigerant 6H | R454B | Residential Heat Pump | Air | NR |
| Refrigerant 6I | R454B | Residential Heat Pump | Air | NR |
| Refrigerant 7A | R454B | Residential Heat Pump | Air | NR |
| Refrigerant 7B | R454B | Residential Heat Pump | Air | NR |
| Refrigerant 7C | R454B | Residential Heat Pump | Air | NR |
| Refrigerant 7D | R454B | Residential Heat Pump | Air | NR |
| Refrigerant 7E | R454B | Residential Heat Pump | Air | NR |
| Refrigerant 7F | R454B | Residential Heat Pump | Air | NR |
| Refrigerant 7G | R454B | Residential Heat Pump | Air | NR |
| Refrigerant 7H | R454B | Residential Heat Pump | Air | NR |
| Refrigerant 7I | R454B | Residential Heat Pump | Air | NR |
| Refrigerant 1 | R454C | Residential Heat Pump | Air | NR |
| Refrigerant 2 | R454C | Residential Heat Pump | Air | NR |
| Refrigerant 3 | R454C | Residential Heat Pump | Air | NR |
| Refrigerant 4A1 | R454C | Residential Heat Pump | Air | NR |
| Refrigerant 4A2 | R454C | Residential Heat Pump | Air | NR |
| Refrigerant 4A3 | R454C | Residential Heat Pump | Air | NR |
| Refrigerant 4A4 | R454C | Residential Heat Pump | Air | NR |
| Refrigerant 5A | R454C | Residential Heat Pump | Air | NR |
| Refrigerant 5B | R454C | Residential Heat Pump | Air | NR |
| Refrigerant 5C | R454C | Residential Heat Pump | Air | NR |
| Refrigerant 5D | R454C | Residential Heat Pump | Air | NR |
| Refrigerant 5E | R454C | Residential Heat Pump | Air | NR |
| Refrigerant 5F | R454C | Residential Heat Pump | Air | NR |
| Refrigerant 5G | R454C | Residential Heat Pump | Air | NR |
| Refrigerant 5H | R454C | Residential Heat Pump | Air | NR |
| Refrigerant 5I | R454C | Residential Heat Pump | Air | NR |
| Refrigerant 6A | R454C | Residential Heat Pump | Air | NR |
| Refrigerant 6B | R454C | Residential Heat Pump | Air | NR |
| Refrigerant 6C | R454C | Residential Heat Pump | Air | NR |
| Refrigerant 6D | R454C | Residential Heat Pump | Air | NR |
| Refrigerant 6E | R454C | Residential Heat Pump | Air | NR |
| Refrigerant 6F | R454C | Residential Heat Pump | Air | NR |
| Refrigerant 6G | R454C | Residential Heat Pump | Air | NR |
| Refrigerant 6H | R454C | Residential Heat Pump | Air | NR |
| Refrigerant 6I | R454C | Residential Heat Pump | Air | NR |
| Refrigerant 7A | R454C | Residential Heat Pump | Air | NR |
| Refrigerant 7B | R454C | Residential Heat Pump | Air | NR |
| Refrigerant 7C | R454C | Residential Heat Pump | Air | NR |
| Refrigerant 7D | R454C | Residential Heat Pump | Air | NR |
| Refrigerant 7E | R454C | Residential Heat Pump | Air | NR |
| Refrigerant 7F | R454C | Residential Heat Pump | Air | NR |
| Refrigerant 7G | R454C | Residential Heat Pump | Air | NR |
| Refrigerant 7H | R454C | Residential Heat Pump | Air | NR |
| Refrigerant 7I | R454C | Residential Heat Pump | Air | NR |
| Refrigerant 1 | R455A | Residential Heat Pump | Air | NR |
| Refrigerant 2 | R455A | Residential Heat Pump | Air | NR |
| Refrigerant 3 | R455A | Residential Heat Pump | Air | NR |
| Refrigerant 4A1 | R455A | Residential Heat Pump | Air | NR |
| Refrigerant 4A2 | R455A | Residential Heat Pump | Air | NR |
| Refrigerant 4A3 | R455A | Residential Heat Pump | Air | NR |
| Refrigerant 4A4 | R455A | Residential Heat Pump | Air | NR |
| Refrigerant 5A | R455A | Residential Heat Pump | Air | NR |
| Refrigerant 5B | R455A | Residential Heat Pump | Air | NR |
| Refrigerant 5C | R455A | Residential Heat Pump | Air | NR |
| Refrigerant 5D | R455A | Residential Heat Pump | Air | NR |
| Refrigerant 5E | R455A | Residential Heat Pump | Air | NR |
| Refrigerant 5F | R455A | Residential Heat Pump | Air | NR |
| Refrigerant 5G | R455A | Residential Heat Pump | Air | NR |
| Refrigerant 5H | R455A | Residential Heat Pump | Air | NR |
| Refrigerant 5I | R455A | Residential Heat Pump | Air | NR |
| Refrigerant 6A | R455A | Residential Heat Pump | Air | NR |
| Refrigerant 6B | R455A | Residential Heat Pump | Air | NR |
| Refrigerant 6C | R455A | Residential Heat Pump | Air | NR |
| Refrigerant 6D | R455A | Residential Heat Pump | Air | NR |
| Refrigerant 6E | R455A | Residential Heat Pump | Air | NR |
| Refrigerant 6F | R455A | Residential Heat Pump | Air | NR |
| Refrigerant 6G | R455A | Residential Heat Pump | Air | NR |
| Refrigerant 6H | R455A | Residential Heat Pump | Air | NR |
| Refrigerant 6I | R455A | Residential Heat Pump | Air | NR |
| Refrigerant 7A | R455A | Residential Heat Pump | Air | NR |
| Refrigerant 7B | R455A | Residential Heat Pump | Air | NR |
| Refrigerant 7C | R455A | Residential Heat Pump | Air | NR |
| Refrigerant 7D | R455A | Residential Heat Pump | Air | NR |
| Refrigerant 7E | R455A | Residential Heat Pump | Air | NR |
| Refrigerant 7F | R455A | Residential Heat Pump | Air | NR |
| Refrigerant 7G | R455A | Residential Heat Pump | Air | NR |
| Refrigerant 7H | R455A | Residential Heat Pump | Air | NR |
| Refrigerant 7I | R455A | Residential Heat Pump | Air | NR |
| Refrigerant 1 | R32 | Residential Heat Pump | Air | NR |
| Refrigerant 2 | R32 | Residential Heat Pump | Air | NR |
| Refrigerant 3 | R32 | Residential Heat Pump | Air | NR |
| Refrigerant 4A1 | R32 | Residential Heat Pump | Air | NR |
| Refrigerant 4A2 | R32 | Residential Heat Pump | Air | NR |
| Refrigerant 4A3 | R32 | Residential Heat Pump | Air | NR |
| Refrigerant 4A4 | R32 | Residential Heat Pump | Air | NR |
| Refrigerant 5A | R32 | Residential Heat Pump | Air | NR |
| Refrigerant 5B | R32 | Residential Heat Pump | Air | NR |
| Refrigerant 5C | R32 | Residential Heat Pump | Air | NR |
| Refrigerant 5D | R32 | Residential Heat Pump | Air | NR |
| Refrigerant 5E | R32 | Residential Heat Pump | Air | NR |
| Refrigerant 5F | R32 | Residential Heat Pump | Air | NR |
| Refrigerant 5G | R32 | Residential Heat Pump | Air | NR |
| Refrigerant 5H | R32 | Residential Heat Pump | Air | NR |
| Refrigerant 5I | R32 | Residential Heat Pump | Air | NR |
| Refrigerant 6A | R32 | Residential Heat Pump | Air | NR |
| Refrigerant 6B | R32 | Residential Heat Pump | Air | NR |
| Refrigerant 6C | R32 | Residential Heat Pump | Air | NR |
| Refrigerant 6D | R32 | Residential Heat Pump | Air | NR |
| Refrigerant 6E | R32 | Residential Heat Pump | Air | NR |
| Refrigerant 6F | R32 | Residential Heat Pump | Air | NR |
| Refrigerant 6G | R32 | Residential Heat Pump | Air | NR |
| Refrigerant 6H | R32 | Residential Heat Pump | Air | NR |
| Refrigerant 6I | R32 | Residential Heat Pump | Air | NR |
| Refrigerant 7A | R32 | Residential Heat Pump | Air | NR |
| Refrigerant 7B | R32 | Residential Heat Pump | Air | NR |
| Refrigerant 7C | R32 | Residential Heat Pump | Air | NR |
| Refrigerant 7D | R32 | Residential Heat Pump | Air | NR |
| Refrigerant 7E | R32 | Residential Heat Pump | Air | NR |
| Refrigerant 7F | R32 | Residential Heat Pump | Air | NR |
| Refrigerant 7G | R32 | Residential Heat Pump | Air | NR |
| Refrigerant 7H | R32 | Residential Heat Pump | Air | NR |
| Refrigerant 7I | R32 | Residential Heat Pump | Air | NR |
| Refrigerant 1 | NR | Residential Heat Pump | Air | NR |
| Refrigerant 2 | NR | Residential Heat Pump | Air | NR |
| Refrigerant 3 | NR | Residential Heat Pump | Air | NR |
| Refrigerant 4A1 | NR | Residential Heat Pump | Air | NR |
| Refrigerant 4A2 | NR | Residential Heat Pump | Air | NR |
| Refrigerant 4A3 | NR | Residential Heat Pump | Air | NR |
| Refrigerant 4A4 | NR | Residential Heat Pump | Air | NR |
| Refrigerant 5A | NR | Residential Heat Pump | Air | NR |
| Refrigerant 5B | NR | Residential Heat Pump | Air | NR |
| Refrigerant 5C | NR | Residential Heat Pump | Air | NR |
| Refrigerant 5D | NR | Residential Heat Pump | Air | NR |
| Refrigerant 5E | NR | Residential Heat Pump | Air | NR |
| Refrigerant 5F | NR | Residential Heat Pump | Air | NR |
| Refrigerant 5G | NR | Residential Heat Pump | Air | NR |
| Refrigerant 5H | NR | Residential Heat Pump | Air | NR |
| Refrigerant 5I | NR | Residential Heat Pump | Air | NR |
| Refrigerant 6A | NR | Residential Heat Pump | Air | NR |
| Refrigerant 6B | NR | Residential Heat Pump | Air | NR |
| Refrigerant 6C | NR | Residential Heat Pump | Air | NR |
| Refrigerant 6D | NR | Residential Heat Pump | Air | NR |
| Refrigerant 6E | NR | Residential Heat Pump | Air | NR |
| Refrigerant 6F | NR | Residential Heat Pump | Air | NR |
| Refrigerant 6G | NR | Residential Heat Pump | Air | NR |
| Refrigerant 6H | NR | Residential Heat Pump | Air | NR |
| Refrigerant 6I | NR | Residential Heat Pump | Air | NR |
| Refrigerant 7A | NR | Residential Heat Pump | Air | NR |
| Refrigerant 7B | NR | Residential Heat Pump | Air | NR |
| Refrigerant 7C | NR | Residential Heat Pump | Air | NR |
| Refrigerant 7D | NR | Residential Heat Pump | Air | NR |
| Refrigerant 7E | NR | Residential Heat Pump | Air | NR |
| Refrigerant 7F | NR | Residential Heat Pump | Air | NR |
| Refrigerant 7G | NR | Residential Heat Pump | Air | NR |
| Refrigerant 7H | NR | Residential Heat Pump | Air | NR |
| Refrigerant 7I | NR | Residential Heat Pump | Air | NF |
| Refrigerant 1 | R22 | Residential Heat Pump | Ground | NR |
| Refrigerant 2 | R22 | Residential Heat Pump | Ground | NR |
| Refrigerant 3 | R22 | Residential Heat Pump | Ground | NR |
| Refrigerant 4A1 | R22 | Residential Heat Pump | Ground | NR |
| Refrigerant 4A2 | R22 | Residential Heat Pump | Ground | NR |
| Refrigerant 4A3 | R22 | Residential Heat Pump | Ground | NR |
| Refrigerant 4A4 | R22 | Residential Heat Pump | Ground | NR |
| Refrigerant 5A | R22 | Residential Heat Pump | Ground | NR |
| Refrigerant 5B | R22 | Residential Heat Pump | Ground | NR |
| Refrigerant 5C | R22 | Residential Heat Pump | Ground | NR |
| Refrigerant 5D | R22 | Residential Heat Pump | Ground | NR |
| Refrigerant 5E | R22 | Residential Heat Pump | Ground | NR |
| Refrigerant 5F | R22 | Residential Heat Pump | Ground | NR |
| Refrigerant 5G | R22 | Residential Heat Pump | Ground | NR |
| Refrigerant 5H | R22 | Residential Heat Pump | Ground | NR |
| Refrigerant 5I | R22 | Residential Heat Pump | Ground | NR |
| Refrigerant 6A | R22 | Residential Heat Pump | Ground | NR |
| Refrigerant 6B | R22 | Residential Heat Pump | Ground | NR |
| Refrigerant 6C | R22 | Residential Heat Pump | Ground | NR |
| Refrigerant 6D | R22 | Residential Heat Pump | Ground | NR |
| Refrigerant 6E | R22 | Residential Heat Pump | Ground | NR |
| Refrigerant 6F | R22 | Residential Heat Pump | Ground | NR |
| Refrigerant 6G | R22 | Residential Heat Pump | Ground | NR |
| Refrigerant 6H | R22 | Residential Heat Pump | Ground | NR |
| Refrigerant 6I | R22 | Residential Heat Pump | Ground | NR |
| Refrigerant 7A | R22 | Residential Heat Pump | Ground | NR |
| Refrigerant 7B | R22 | Residential Heat Pump | Ground | NR |
| Refrigerant 7C | R22 | Residential Heat Pump | Ground | NR |
| Refrigerant 7D | R22 | Residential Heat Pump | Ground | NR |
| Refrigerant 7E | R22 | Residential Heat Pump | Ground | NR |
| Refrigerant 7F | R22 | Residential Heat Pump | Ground | NR |
| Refrigerant 7G | R22 | Residential Heat Pump | Ground | NR |
| Refrigerant 7H | R22 | Residential Heat Pump | Ground | NR |
| Refrigerant 7I | R22 | Residential Heat Pump | Ground | NR |
| Refrigerant 1 | R290 | Residential Heat Pump | Ground | NR |
| Refrigerant 2 | R290 | Residential Heat Pump | Ground | NR |
| Refrigerant 3 | R290 | Residential Heat Pump | Ground | NR |
| Refrigerant 4A1 | R290 | Residential Heat Pump | Ground | NR |
| Refrigerant 4A2 | R290 | Residential Heat Pump | Ground | NR |
| Refrigerant 4A3 | R290 | Residential Heat Pump | Ground | NR |
| Refrigerant 4A4 | R290 | Residential Heat Pump | Ground | NR |
| Refrigerant 5A | R290 | Residential Heat Pump | Ground | NR |
| Refrigerant 5B | R290 | Residential Heat Pump | Ground | NR |
| Refrigerant 5C | R290 | Residential Heat Pump | Ground | NR |
| Refrigerant 5D | R290 | Residential Heat Pump | Ground | NR |
| Refrigerant 5E | R290 | Residential Heat Pump | Ground | NR |
| Refrigerant 5F | R290 | Residential Heat Pump | Ground | NR |
| Refrigerant 5G | R290 | Residential Heat Pump | Ground | NR |
| Refrigerant 5H | R290 | Residential Heat Pump | Ground | NR |
| Refrigerant 5I | R290 | Residential Heat Pump | Ground | NR |
| Refrigerant 6A | R290 | Residential Heat Pump | Ground | NR |
| Refrigerant 6B | R290 | Residential Heat Pump | Ground | NR |
| Refrigerant 6C | R290 | Residential Heat Pump | Ground | NR |
| Refrigerant 6D | R290 | Residential Heat Pump | Ground | NR |
| Refrigerant 6E | R290 | Residential Heat Pump | Ground | NR |
| Refrigerant 6F | R290 | Residential Heat Pump | Ground | NR |
| Refrigerant 6G | R290 | Residential Heat Pump | Ground | NR |
| Refrigerant 6H | R290 | Residential Heat Pump | Ground | NR |
| Refrigerant 6I | R290 | Residential Heat Pump | Ground | NR |
| Refrigerant 7A | R290 | Residential Heat Pump | Ground | NR |
| Refrigerant 7B | R290 | Residential Heat Pump | Ground | NR |
| Refrigerant 7C | R290 | Residential Heat Pump | Ground | NR |
| Refrigerant 7D | R290 | Residential Heat Pump | Ground | NR |
| Refrigerant 7E | R290 | Residential Heat Pump | Ground | NR |
| Refrigerant 7F | R290 | Residential Heat Pump | Ground | NR |
| Refrigerant 7G | R290 | Residential Heat Pump | Ground | NR |
| Refrigerant 7H | R290 | Residential Heat Pump | Ground | NR |
| Refrigerant 7I | R290 | Residential Heat Pump | Ground | NR |
| Refrigerant 1 | R407C | Residential Heat Pump | Ground | NR |
| Refrigerant 2 | R407C | Residential Heat Pump | Ground | NR |
| Refrigerant 3 | R407C | Residential Heat Pump | Ground | NR |
| Refrigerant 4A1 | R407C | Residential Heat Pump | Ground | NR |
| Refrigerant 4A2 | R407C | Residential Heat Pump | Ground | NR |
| Refrigerant 4A3 | R407C | Residential Heat Pump | Ground | NR |
| Refrigerant 4A4 | R407C | Residential Heat Pump | Ground | NR |
| Refrigerant 5A | R407C | Residential Heat Pump | Ground | NR |
| Refrigerant 5B | R407C | Residential Heat Pump | Ground | NR |
| Refrigerant 5C | R407C | Residential Heat Pump | Ground | NR |
| Refrigerant 5D | R407C | Residential Heat Pump | Ground | NR |
| Refrigerant 5E | R407C | Residential Heat Pump | Ground | NR |
| Refrigerant 5F | R407C | Residential Heat Pump | Ground | NR |
| Refrigerant 5G | R407C | Residential Heat Pump | Ground | NR |
| Refrigerant 5H | R407C | Residential Heat Pump | Ground | NR |
| Refrigerant 5I | R407C | Residential Heat Pump | Ground | NR |
| Refrigerant 6A | R407C | Residential Heat Pump | Ground | NR |
| Refrigerant 6B | R407C | Residential Heat Pump | Ground | NR |
| Refrigerant 6C | R407C | Residential Heat Pump | Ground | NR |
| Refrigerant 6D | R407C | Residential Heat Pump | Ground | NR |
| Refrigerant 6E | R407C | Residential Heat Pump | Ground | NR |
| Refrigerant 6F | R407C | Residential Heat Pump | Ground | NR |
| Refrigerant 6G | R407C | Residential Heat Pump | Ground | NR |
| Refrigerant 6H | R407C | Residential Heat Pump | Ground | NR |
| Refrigerant 6I | R407C | Residential Heat Pump | Ground | NR |
| Refrigerant 7A | R407C | Residential Heat Pump | Ground | NR |
| Refrigerant 7B | R407C | Residential Heat Pump | Ground | NR |
| Refrigerant 7C | R407C | Residential Heat Pump | Ground | NR |
| Refrigerant 7D | R407C | Residential Heat Pump | Ground | NR |
| Refrigerant 7E | R407C | Residential Heat Pump | Ground | NR |
| Refrigerant 7F | R407C | Residential Heat Pump | Ground | NR |
| Refrigerant 7G | R407C | Residential Heat Pump | Ground | NR |
| Refrigerant 7H | R407C | Residential Heat Pump | Ground | NR |
| Refrigerant 7I | R407C | Residential Heat Pump | Ground | NR |
| Refrigerant 1 | R410A | Residential Heat Pump | Ground | NR |
| Refrigerant 2 | R410A | Residential Heat Pump | Ground | NR |
| Refrigerant 3 | R410A | Residential Heat Pump | Ground | NR |
| Refrigerant 4A1 | R410A | Residential Heat Pump | Ground | NR |
| Refrigerant 4A2 | R410A | Residential Heat Pump | Ground | NR |
| Refrigerant 4A3 | R410A | Residential Heat Pump | Ground | NR |
| Refrigerant 4A4 | R410A | Residential Heat Pump | Ground | NR |
| Refrigerant 5A | R410A | Residential Heat Pump | Ground | NR |
| Refrigerant 5B | R410A | Residential Heat Pump | Ground | NR |
| Refrigerant 5C | R410A | Residential Heat Pump | Ground | NR |
| Refrigerant 5D | R410A | Residential Heat Pump | Ground | NR |
| Refrigerant 5E | R410A | Residential Heat Pump | Ground | NR |
| Refrigerant 5F | R410A | Residential Heat Pump | Ground | NR |
| Refrigerant 5G | R410A | Residential Heat Pump | Ground | NR |
| Refrigerant 5H | R410A | Residential Heat Pump | Ground | NR |
| Refrigerant 5I | R410A | Residential Heat Pump | Ground | NR |
| Refrigerant 6A | R410A | Residential Heat Pump | Ground | NR |
| Refrigerant 6B | R410A | Residential Heat Pump | Ground | NR |
| Refrigerant 6C | R410A | Residential Heat Pump | Ground | NR |
| Refrigerant 6D | R410A | Residential Heat Pump | Ground | NR |
| Refrigerant 6E | R410A | Residential Heat Pump | Ground | NR |
| Refrigerant 6F | R410A | Residential Heat Pump | Ground | NR |
| Refrigerant 6G | R410A | Residential Heat Pump | Ground | NR |
| Refrigerant 6H | R410A | Residential Heat Pump | Ground | NR |
| Refrigerant 6I | R410A | Residential Heat Pump | Ground | NR |
| Refrigerant 7A | R410A | Residential Heat Pump | Ground | NR |
| Refrigerant 7B | R410A | Residential Heat Pump | Ground | NR |
| Refrigerant 7C | R410A | Residential Heat Pump | Ground | NR |
| Refrigerant 7D | R410A | Residential Heat Pump | Ground | NR |
| Refrigerant 7E | R410A | Residential Heat Pump | Ground | NR |
| Refrigerant 7F | R410A | Residential Heat Pump | Ground | NR |
| Refrigerant 7G | R410A | Residential Heat Pump | Ground | NR |
| Refrigerant 7H | R410A | Residential Heat Pump | Ground | NR |
| Refrigerant 7I | R410A | Residential Heat Pump | Ground | NR |
| Refrigerant 1 | R454B | Residential Heat Pump | Ground | NR |
| Refrigerant 2 | R454B | Residential Heat Pump | Ground | NR |
| Refrigerant 3 | R454B | Residential Heat Pump | Ground | NR |
| Refrigerant 4A1 | R454B | Residential Heat Pump | Ground | NR |
| Refrigerant 4A2 | R454B | Residential Heat Pump | Ground | NR |
| Refrigerant 4A3 | R454B | Residential Heat Pump | Ground | NR |
| Refrigerant 4A4 | R454B | Residential Heat Pump | Ground | NR |
| Refrigerant 5A | R454B | Residential Heat Pump | Ground | NR |
| Refrigerant 5B | R454B | Residential Heat Pump | Ground | NR |
| Refrigerant 5C | R454B | Residential Heat Pump | Ground | NR |
| Refrigerant 5D | R454B | Residential Heat Pump | Ground | NR |
| Refrigerant 5E | R454B | Residential Heat Pump | Ground | NR |
| Refrigerant 5F | R454B | Residential Heat Pump | Ground | NR |
| Refrigerant 5G | R454B | Residential Heat Pump | Ground | NR |
| Refrigerant 5H | R454B | Residential Heat Pump | Ground | NR |
| Refrigerant 5I | R454B | Residential Heat Pump | Ground | NR |
| Refrigerant 6A | R454B | Residential Heat Pump | Ground | NR |
| Refrigerant 6B | R454B | Residential Heat Pump | Ground | NR |
| Refrigerant 6C | R454B | Residential Heat Pump | Ground | NR |
| Refrigerant 6D | R454B | Residential Heat Pump | Ground | NR |
| Refrigerant 6E | R454B | Residential Heat Pump | Ground | NR |
| Refrigerant 6F | R454B | Residential Heat Pump | Ground | NR |
| Refrigerant 6G | R454B | Residential Heat Pump | Ground | NR |
| Refrigerant 6H | R454B | Residential Heat Pump | Ground | NR |
| Refrigerant 6I | R454B | Residential Heat Pump | Ground | NR |
| Refrigerant 7A | R454B | Residential Heat Pump | Ground | NR |
| Refrigerant 7B | R454B | Residential Heat Pump | Ground | NR |
| Refrigerant 7C | R454B | Residential Heat Pump | Ground | NR |
| Refrigerant 7D | R454B | Residential Heat Pump | Ground | NR |
| Refrigerant 7E | R454B | Residential Heat Pump | Ground | NR |
| Refrigerant 7F | R454B | Residential Heat Pump | Ground | NR |
| Refrigerant 7G | R454B | Residential Heat Pump | Ground | NR |
| Refrigerant 7H | R454B | Residential Heat Pump | Ground | NR |
| Refrigerant 7I | R454B | Residential Heat Pump | Ground | NR |
| Refrigerant 1 | R454C | Residential Heat Pump | Ground | NR |
| Refrigerant 2 | R454C | Residential Heat Pump | Ground | NR |
| Refrigerant 3 | R454C | Residential Heat Pump | Ground | NR |
| Refrigerant 4A1 | R454C | Residential Heat Pump | Ground | NR |
| Refrigerant 4A2 | R454C | Residential Heat Pump | Ground | NR |
| Refrigerant 4A3 | R454C | Residential Heat Pump | Ground | NR |
| Refrigerant 4A4 | R454C | Residential Heat Pump | Ground | NR |
| Refrigerant 5A | R454C | Residential Heat Pump | Ground | NR |
| Refrigerant 5B | R454C | Residential Heat Pump | Ground | NR |
| Refrigerant 5C | R454C | Residential Heat Pump | Ground | NR |
| Refrigerant 5D | R454C | Residential Heat Pump | Ground | NR |
| Refrigerant 5E | R454C | Residential Heat Pump | Ground | NR |
| Refrigerant 5F | R454C | Residential Heat Pump | Ground | NR |
| Refrigerant 5G | R454C | Residential Heat Pump | Ground | NR |
| Refrigerant 5H | R454C | Residential Heat Pump | Ground | NR |
| Refrigerant 5I | R454C | Residential Heat Pump | Ground | NR |
| Refrigerant 6A | R454C | Residential Heat Pump | Ground | NR |
| Refrigerant 6B | R454C | Residential Heat Pump | Ground | NR |
| Refrigerant 6C | R454C | Residential Heat Pump | Ground | NR |
| Refrigerant 6D | R454C | Residential Heat Pump | Ground | NR |
| Refrigerant 6E | R454C | Residential Heat Pump | Ground | NR |
| Refrigerant 6F | R454C | Residential Heat Pump | Ground | NR |
| Refrigerant 6G | R454C | Residential Heat Pump | Ground | NR |
| Refrigerant 6H | R454C | Residential Heat Pump | Ground | NR |
| Refrigerant 6I | R454C | Residential Heat Pump | Ground | NR |
| Refrigerant 7A | R454C | Residential Heat Pump | Ground | NR |
| Refrigerant 7B | R454C | Residential Heat Pump | Ground | NR |
| Refrigerant 7C | R454C | Residential Heat Pump | Ground | NR |
| Refrigerant 7D | R454C | Residential Heat Pump | Ground | NR |
| Refrigerant 7E | R454C | Residential Heat Pump | Ground | NR |
| Refrigerant 7F | R454C | Residential Heat Pump | Ground | NR |
| Refrigerant 7G | R454C | Residential Heat Pump | Ground | NR |
| Refrigerant 7H | R454C | Residential Heat Pump | Ground | NR |
| Refrigerant 7I | R454C | Residential Heat Pump | Ground | NR |
| Refrigerant 1 | R455A | Residential Heat Pump | Ground | NR |
| Refrigerant 2 | R455A | Residential Heat Pump | Ground | NR |
| Refrigerant 3 | R455A | Residential Heat Pump | Ground | NR |
| Refrigerant 4A1 | R455A | Residential Heat Pump | Ground | NR |
| Refrigerant 4A2 | R455A | Residential Heat Pump | Ground | NR |
| Refrigerant 4A3 | R455A | Residential Heat Pump | Ground | NR |
| Refrigerant 4A4 | R455A | Residential Heat Pump | Ground | NR |
| Refrigerant 5A | R455A | Residential Heat Pump | Ground | NR |
| Refrigerant 5B | R455A | Residential Heat Pump | Ground | NR |
| Refrigerant 5C | R455A | Residential Heat Pump | Ground | NR |
| Refrigerant 5D | R455A | Residential Heat Pump | Ground | NR |
| Refrigerant 5E | R455A | Residential Heat Pump | Ground | NR |
| Refrigerant 5F | R455A | Residential Heat Pump | Ground | NR |
| Refrigerant 5G | R455A | Residential Heat Pump | Ground | NR |
| Refrigerant 5H | R455A | Residential Heat Pump | Ground | NR |
| Refrigerant 5I | R455A | Residential Heat Pump | Ground | NR |
| Refrigerant 6A | R455A | Residential Heat Pump | Ground | NR |
| Refrigerant 6B | R455A | Residential Heat Pump | Ground | NR |
| Refrigerant 6C | R455A | Residential Heat Pump | Ground | NR |
| Refrigerant 6D | R455A | Residential Heat Pump | Ground | NR |
| Refrigerant 6E | R455A | Residential Heat Pump | Ground | NR |
| Refrigerant 6F | R455A | Residential Heat Pump | Ground | NR |
| Refrigerant 6G | R455A | Residential Heat Pump | Ground | NR |
| Refrigerant 6H | R455A | Residential Heat Pump | Ground | NR |
| Refrigerant 6I | R455A | Residential Heat Pump | Ground | NR |
| Refrigerant 7A | R455A | Residential Heat Pump | Ground | NR |
| Refrigerant 7B | R455A | Residential Heat Pump | Ground | NR |
| Refrigerant 7C | R455A | Residential Heat Pump | Ground | NR |
| Refrigerant 7D | R455A | Residential Heat Pump | Ground | NR |
| Refrigerant 7E | R455A | Residential Heat Pump | Ground | NR |
| Refrigerant 7F | R455A | Residential Heat Pump | Ground | NR |
| Refrigerant 7G | R455A | Residential Heat Pump | Ground | NR |
| Refrigerant 7H | R455A | Residential Heat Pump | Ground | NR |
| Refrigerant 7I | R455A | Residential Heat Pump | Ground | NR |
| Refrigerant 1 | R32 | Residential Heat Pump | Ground | NR |
| Refrigerant 2 | R32 | Residential Heat Pump | Ground | NR |
| Refrigerant 3 | R32 | Residential Heat Pump | Ground | NR |
| Refrigerant 4A1 | R32 | Residential Heat Pump | Ground | NR |
| Refrigerant 4A2 | R32 | Residential Heat Pump | Ground | NR |
| Refrigerant 4A3 | R32 | Residential Heat Pump | Ground | NR |
| Refrigerant 4A4 | R32 | Residential Heat Pump | Ground | NR |
| Refrigerant 5A | R32 | Residential Heat Pump | Ground | NR |
| Refrigerant 5B | R32 | Residential Heat Pump | Ground | NR |
| Refrigerant 5C | R32 | Residential Heat Pump | Ground | NR |
| Refrigerant 5D | R32 | Residential Heat Pump | Ground | NR |
| Refrigerant 5E | R32 | Residential Heat Pump | Ground | NR |
| Refrigerant 5F | R32 | Residential Heat Pump | Ground | NR |
| Refrigerant 5G | R32 | Residential Heat Pump | Ground | NR |
| Refrigerant 5H | R32 | Residential Heat Pump | Ground | NR |
| Refrigerant 5I | R32 | Residential Heat Pump | Ground | NR |
| Refrigerant 6A | R32 | Residential Heat Pump | Ground | NR |
| Refrigerant 6B | R32 | Residential Heat Pump | Ground | NR |
| Refrigerant 6C | R32 | Residential Heat Pump | Ground | NR |
| Refrigerant 6D | R32 | Residential Heat Pump | Ground | NR |
| Refrigerant 6E | R32 | Residential Heat Pump | Ground | NR |
| Refrigerant 6F | R32 | Residential Heat Pump | Ground | NR |
| Refrigerant 6G | R32 | Residential Heat Pump | Ground | NR |
| Refrigerant 6H | R32 | Residential Heat Pump | Ground | NR |
| Refrigerant 6I | R32 | Residential Heat Pump | Ground | NR |
| Refrigerant 7A | R32 | Residential Heat Pump | Ground | NR |
| Refrigerant 7B | R32 | Residential Heat Pump | Ground | NR |
| Refrigerant 7C | R32 | Residential Heat Pump | Ground | NR |
| Refrigerant 7D | R32 | Residential Heat Pump | Ground | NR |
| Refrigerant 7E | R32 | Residential Heat Pump | Ground | NR |
| Refrigerant 7F | R32 | Residential Heat Pump | Ground | NR |
| Refrigerant 7G | R32 | Residential Heat Pump | Ground | NR |
| Refrigerant 7H | R32 | Residential Heat Pump | Ground | NR |
| Refrigerant 7I | R32 | Residential Heat Pump | Ground | NR |
| Refrigerant 1 | NR | Residential Heat Pump | Ground | NR |
| Refrigerant 2 | NR | Residential Heat Pump | Ground | NR |
| Refrigerant 3 | NR | Residential Heat Pump | Ground | NR |
| Refrigerant 4A1 | NR | Residential Heat Pump | Ground | NR |
| Refrigerant 4A2 | NR | Residential Heat Pump | Ground | NR |
| Refrigerant 4A3 | NR | Residential Heat Pump | Ground | NR |
| Refrigerant 4A4 | NR | Residential Heat Pump | Ground | NR |
| Refrigerant 5A | NR | Residential Heat Pump | Ground | NR |
| Refrigerant 5B | NR | Residential Heat Pump | Ground | NR |
| Refrigerant 5C | NR | Residential Heat Pump | Ground | NR |
| Refrigerant 5D | NR | Residential Heat Pump | Ground | NR |
| Refrigerant 5E | NR | Residential Heat Pump | Ground | NR |
| Refrigerant 5F | NR | Residential Heat Pump | Ground | NR |
| Refrigerant 5G | NR | Residential Heat Pump | Ground | NR |
| Refrigerant 5H | NR | Residential Heat Pump | Ground | NR |
| Refrigerant 5I | NR | Residential Heat Pump | Ground | NR |
| Refrigerant 6A | NR | Residential Heat Pump | Ground | NR |
| Refrigerant 6B | NR | Residential Heat Pump | Ground | NR |
| Refrigerant 6C | NR | Residential Heat Pump | Ground | NR |
| Refrigerant 6D | NR | Residential Heat Pump | Ground | NR |
| Refrigerant 6E | NR | Residential Heat Pump | Ground | NR |
| Refrigerant 6F | NR | Residential Heat Pump | Ground | NR |
| Refrigerant 6G | NR | Residential Heat Pump | Ground | NR |
| Refrigerant 6H | NR | Residential Heat Pump | Ground | NR |
| Refrigerant 6I | NR | Residential Heat Pump | Ground | NR |
| Refrigerant 7A | NR | Residential Heat Pump | Ground | NR |
| Refrigerant 7B | NR | Residential Heat Pump | Ground | NR |
| Refrigerant 7C | NR | Residential Heat Pump | Ground | NR |
| Refrigerant 7D | NR | Residential Heat Pump | Ground | NR |
| Refrigerant 7E | NR | Residential Heat Pump | Ground | NR |
| Refrigerant 7F | NR | Residential Heat Pump | Ground | NR |
| Refrigerant 7G | NR | Residential Heat Pump | Ground | NR |
| Refrigerant 7H | NR | Residential Heat Pump | Ground | NR |
| Refrigerant 7I | NR | Residential Heat Pump | Ground | NR |
| Refrigerant 1 | R22 | Residential Heat Pump | Ground | water or brine |
| Refrigerant 2 | R22 | Residential Heat Pump | Ground | water or brine |
| Refrigerant 3 | R22 | Residential Heat Pump | Ground | water or brine |
| Refrigerant 4A1 | R22 | Residential Heat Pump | Ground | water or brine |
| Refrigerant 4A2 | R22 | Residential Heat Pump | Ground | water or brine |
| Refrigerant 4A3 | R22 | Residential Heat Pump | Ground | water or brine |
| Refrigerant 4A4 | R22 | Residential Heat Pump | Ground | water or brine |
| Refrigerant 5A | R22 | Residential Heat Pump | Ground | water or brine |
| Refrigerant 5B | R22 | Residential Heat Pump | Ground | water or brine |
| Refrigerant 5C | R22 | Residential Heat Pump | Ground | water or brine |
| Refrigerant 5D | R22 | Residential Heat Pump | Ground | water or brine |
| Refrigerant 5E | R22 | Residential Heat Pump | Ground | water or brine |
| Refrigerant 5F | R22 | Residential Heat Pump | Ground | water or brine |
| Refrigerant 5G | R22 | Residential Heat Pump | Ground | water or brine |
| Refrigerant 5H | R22 | Residential Heat Pump | Ground | water or brine |
| Refrigerant 5I | R22 | Residential Heat Pump | Ground | water or brine |
| Refrigerant 6A | R22 | Residential Heat Pump | Ground | water or brine |
| Refrigerant 6B | R22 | Residential Heat Pump | Ground | water or brine |
| Refrigerant 6C | R22 | Residential Heat Pump | Ground | water or brine |
| Refrigerant 6D | R22 | Residential Heat Pump | Ground | water or brine |
| Refrigerant 6E | R22 | Residential Heat Pump | Ground | water or brine |
| Refrigerant 6F | R22 | Residential Heat Pump | Ground | water or brine |
| Refrigerant 6G | R22 | Residential Heat Pump | Ground | water or brine |
| Refrigerant 6H | R22 | Residential Heat Pump | Ground | water or brine |
| Refrigerant 6I | R22 | Residential Heat Pump | Ground | water or brine |
| Refrigerant 7A | R22 | Residential Heat Pump | Ground | water or brine |
| Refrigerant 7B | R22 | Residential Heat Pump | Ground | water or brine |
| Refrigerant 7C | R22 | Residential Heat Pump | Ground | water or brine |
| Refrigerant 7D | R22 | Residential Heat Pump | Ground | water or brine |
| Refrigerant 7E | R22 | Residential Heat Pump | Ground | water or brine |
| Refrigerant 7F | R22 | Residential Heat Pump | Ground | water or brine |
| Refrigerant 7G | R22 | Residential Heat Pump | Ground | water or brine |
| Refrigerant 7H | R22 | Residential Heat Pump | Ground | water or brine |
| Refrigerant 7I | R22 | Residential Heat Pump | Ground | water or brine |
| Refrigerant 1 | R290 | Residential Heat Pump | Ground | water or brine |
| Refrigerant 2 | R290 | Residential Heat Pump | Ground | water or brine |
| Refrigerant 3 | R290 | Residential Heat Pump | Ground | water or brine |
| Refrigerant 4A1 | R290 | Residential Heat Pump | Ground | water or brine |
| Refrigerant 4A2 | R290 | Residential Heat Pump | Ground | water or brine |
| Refrigerant 4A3 | R290 | Residential Heat Pump | Ground | water or brine |
| Refrigerant 4A4 | R290 | Residential Heat Pump | Ground | water or brine |
| Refrigerant 5A | R290 | Residential Heat Pump | Ground | water or brine |
| Refrigerant 5B | R290 | Residential Heat Pump | Ground | water or brine |
| Refrigerant 5C | R290 | Residential Heat Pump | Ground | water or brine |
| Refrigerant 5D | R290 | Residential Heat Pump | Ground | water or brine |
| Refrigerant 5E | R290 | Residential Heat Pump | Ground | water or brine |
| Refrigerant 5F | R290 | Residential Heat Pump | Ground | water or brine |
| Refrigerant 5G | R290 | Residential Heat Pump | Ground | water or brine |
| Refrigerant 5H | R290 | Residential Heat Pump | Ground | water or brine |
| Refrigerant 5I | R290 | Residential Heat Pump | Ground | water or brine |
| Refrigerant 6A | R290 | Residential Heat Pump | Ground | water or brine |
| Refrigerant 6B | R290 | Residential Heat Pump | Ground | water or brine |
| Refrigerant 6C | R290 | Residential Heat Pump | Ground | water or brine |
| Refrigerant 6D | R290 | Residential Heat Pump | Ground | water or brine |
| Refrigerant 6E | R290 | Residential Heat Pump | Ground | water or brine |
| Refrigerant 6F | R290 | Residential Heat Pump | Ground | water or brine |
| Refrigerant 6G | R290 | Residential Heat Pump | Ground | water or brine |
| Refrigerant 6H | R290 | Residential Heat Pump | Ground | water or brine |
| Refrigerant 6I | R290 | Residential Heat Pump | Ground | water or brine |
| Refrigerant 7A | R290 | Residential Heat Pump | Ground | water or brine |
| Refrigerant 7B | R290 | Residential Heat Pump | Ground | water or brine |
| Refrigerant 7C | R290 | Residential Heat Pump | Ground | water or brine |
| Refrigerant 7D | R290 | Residential Heat Pump | Ground | water or brine |
| Refrigerant 7E | R290 | Residential Heat Pump | Ground | water or brine |
| Refrigerant 7F | R290 | Residential Heat Pump | Ground | water or brine |
| Refrigerant 7G | R290 | Residential Heat Pump | Ground | water or brine |
| Refrigerant 7H | R290 | Residential Heat Pump | Ground | water or brine |
| Refrigerant 7I | R290 | Residential Heat Pump | Ground | water or brine |
| Refrigerant 1 | R407C | Residential Heat Pump | Ground | water or brine |
| Refrigerant 2 | R407C | Residential Heat Pump | Ground | water or brine |
| Refrigerant 3 | R407C | Residential Heat Pump | Ground | water or brine |
| Refrigerant 4A1 | R407C | Residential Heat Pump | Ground | water or brine |
| Refrigerant 4A2 | R407C | Residential Heat Pump | Ground | water or brine |
| Refrigerant 4A3 | R407C | Residential Heat Pump | Ground | water or brine |
| Refrigerant 4A4 | R407C | Residential Heat Pump | Ground | water or brine |
| Refrigerant 5A | R407C | Residential Heat Pump | Ground | water or brine |
| Refrigerant 5B | R407C | Residential Heat Pump | Ground | water or brine |
| Refrigerant 5C | R407C | Residential Heat Pump | Ground | water or brine |
| Refrigerant 5D | R407C | Residential Heat Pump | Ground | water or brine |
| Refrigerant 5E | R407C | Residential Heat Pump | Ground | water or brine |
| Refrigerant 5F | R407C | Residential Heat Pump | Ground | water or brine |
| Refrigerant 5G | R407C | Residential Heat Pump | Ground | water or brine |
| Refrigerant 5H | R407C | Residential Heat Pump | Ground | water or brine |
| Refrigerant 5I | R407C | Residential Heat Pump | Ground | water or brine |
| Refrigerant 6A | R407C | Residential Heat Pump | Ground | water or brine |
| Refrigerant 6B | R407C | Residential Heat Pump | Ground | water or brine |
| Refrigerant 6C | R407C | Residential Heat Pump | Ground | water or brine |
| Refrigerant 6D | R407C | Residential Heat Pump | Ground | water or brine |
| Refrigerant 6E | R407C | Residential Heat Pump | Ground | water or brine |
| Refrigerant 6F | R407C | Residential Heat Pump | Ground | water or brine |
| Refrigerant 6G | R407C | Residential Heat Pump | Ground | water or brine |
| Refrigerant 6H | R407C | Residential Heat Pump | Ground | water or brine |
| Refrigerant 6I | R407C | Residential Heat Pump | Ground | water or brine |
| Refrigerant 7A | R407C | Residential Heat Pump | Ground | water or brine |
| Refrigerant 7B | R407C | Residential Heat Pump | Ground | water or brine |
| Refrigerant 7C | R407C | Residential Heat Pump | Ground | water or brine |
| Refrigerant 7D | R407C | Residential Heat Pump | Ground | water or brine |
| Refrigerant 7E | R407C | Residential Heat Pump | Ground | water or brine |
| Refrigerant 7F | R407C | Residential Heat Pump | Ground | water or brine |
| Refrigerant 7G | R407C | Residential Heat Pump | Ground | water or brine |
| Refrigerant 7H | R407C | Residential Heat Pump | Ground | water or brine |
| Refrigerant 7I | R407C | Residential Heat Pump | Ground | water or brine |
| Refrigerant 1 | R410A | Residential Heat Pump | Ground | water or brine |
| Refrigerant 2 | R410A | Residential Heat Pump | Ground | water or brine |
| Refrigerant 3 | R410A | Residential Heat Pump | Ground | water or brine |
| Refrigerant 4A1 | R410A | Residential Heat Pump | Ground | water or brine |
| Refrigerant 4A2 | R410A | Residential Heat Pump | Ground | water or brine |
| Refrigerant 4A3 | R410A | Residential Heat Pump | Ground | water or brine |
| Refrigerant 4A4 | R410A | Residential Heat Pump | Ground | water or brine |
| Refrigerant 5A | R410A | Residential Heat Pump | Ground | water or brine |
| Refrigerant 5B | R410A | Residential Heat Pump | Ground | water or brine |
| Refrigerant 5C | R410A | Residential Heat Pump | Ground | water or brine |
| Refrigerant 5D | R410A | Residential Heat Pump | Ground | water or brine |
| Refrigerant 5E | R410A | Residential Heat Pump | Ground | water or brine |
| Refrigerant 5F | R410A | Residential Heat Pump | Ground | water or brine |
| Refrigerant 5G | R410A | Residential Heat Pump | Ground | water or brine |
| Refrigerant 5H | R410A | Residential Heat Pump | Ground | water or brine |
| Refrigerant 5I | R410A | Residential Heat Pump | Ground | water or brine |
| Refrigerant 6A | R410A | Residential Heat Pump | Ground | water or brine |
| Refrigerant 6B | R410A | Residential Heat Pump | Ground | water or brine |
| Refrigerant 6C | R410A | Residential Heat Pump | Ground | water or brine |
| Refrigerant 6D | R410A | Residential Heat Pump | Ground | water or brine |
| Refrigerant 6E | R410A | Residential Heat Pump | Ground | water or brine |
| Refrigerant 6F | R410A | Residential Heat Pump | Ground | water or brine |
| Refrigerant 6G | R410A | Residential Heat Pump | Ground | water or brine |
| Refrigerant 6H | R410A | Residential Heat Pump | Ground | water or brine |
| Refrigerant 6I | R410A | Residential Heat Pump | Ground | water or brine |
| Refrigerant 7A | R410A | Residential Heat Pump | Ground | water or brine |
| Refrigerant 7B | R410A | Residential Heat Pump | Ground | water or brine |
| Refrigerant 7C | R410A | Residential Heat Pump | Ground | water or brine |
| Refrigerant 7D | R410A | Residential Heat Pump | Ground | water or brine |
| Refrigerant 7E | R410A | Residential Heat Pump | Ground | water or brine |
| Refrigerant 7F | R410A | Residential Heat Pump | Ground | water or brine |
| Refrigerant 7G | R410A | Residential Heat Pump | Ground | water or brine |
| Refrigerant 7H | R410A | Residential Heat Pump | Ground | water or brine |
| Refrigerant 7I | R410A | Residential Heat Pump | Ground | water or brine |
| Refrigerant 1 | R454B | Residential Heat Pump | Ground | water or brine |
| Refrigerant 2 | R454B | Residential Heat Pump | Ground | water or brine |
| Refrigerant 3 | R454B | Residential Heat Pump | Ground | water or brine |
| Refrigerant 4A1 | R454B | Residential Heat Pump | Ground | water or brine |
| Refrigerant 4A2 | R454B | Residential Heat Pump | Ground | water or brine |
| Refrigerant 4A3 | R454B | Residential Heat Pump | Ground | water or brine |
| Refrigerant 4A4 | R454B | Residential Heat Pump | Ground | water or brine |
| Refrigerant 5A | R454B | Residential Heat Pump | Ground | water or brine |
| Refrigerant 5B | R454B | Residential Heat Pump | Ground | water or brine |
| Refrigerant 5C | R454B | Residential Heat Pump | Ground | water or brine |
| Refrigerant 5D | R454B | Residential Heat Pump | Ground | water or brine |
| Refrigerant 5E | R454B | Residential Heat Pump | Ground | water or brine |
| Refrigerant 5F | R454B | Residential Heat Pump | Ground | water or brine |
| Refrigerant 5G | R454B | Residential Heat Pump | Ground | water or brine |
| Refrigerant 5H | R454B | Residential Heat Pump | Ground | water or brine |
| Refrigerant 5I | R454B | Residential Heat Pump | Ground | water or brine |
| Refrigerant 6A | R454B | Residential Heat Pump | Ground | water or brine |
| Refrigerant 6B | R454B | Residential Heat Pump | Ground | water or brine |
| Refrigerant 6C | R454B | Residential Heat Pump | Ground | water or brine |
| Refrigerant 6D | R454B | Residential Heat Pump | Ground | water or brine |
| Refrigerant 6E | R454B | Residential Heat Pump | Ground | water or brine |
| Refrigerant 6F | R454B | Residential Heat Pump | Ground | water or brine |
| Refrigerant 6G | R454B | Residential Heat Pump | Ground | water or brine |
| Refrigerant 6H | R454B | Residential Heat Pump | Ground | water or brine |
| Refrigerant 6I | R454B | Residential Heat Pump | Ground | water or brine |
| Refrigerant 7A | R454B | Residential Heat Pump | Ground | water or brine |
| Refrigerant 7B | R454B | Residential Heat Pump | Ground | water or brine |
| Refrigerant 7C | R454B | Residential Heat Pump | Ground | water or brine |
| Refrigerant 7D | R454B | Residential Heat Pump | Ground | water or brine |
| Refrigerant 7E | R454B | Residential Heat Pump | Ground | water or brine |
| Refrigerant 7F | R454B | Residential Heat Pump | Ground | water or brine |
| Refrigerant 7G | R454B | Residential Heat Pump | Ground | water or brine |
| Refrigerant 7H | R454B | Residential Heat Pump | Ground | water or brine |
| Refrigerant 7I | R454B | Residential Heat Pump | Ground | water or brine |
| Refrigerant 1 | R454C | Residential Heat Pump | Ground | water or brine |
| Refrigerant 2 | R454C | Residential Heat Pump | Ground | water or brine |
| Refrigerant 3 | R454C | Residential Heat Pump | Ground | water or brine |
| Refrigerant 4A1 | R454C | Residential Heat Pump | Ground | water or brine |
| Refrigerant 4A2 | R454C | Residential Heat Pump | Ground | water or brine |
| Refrigerant 4A3 | R454C | Residential Heat Pump | Ground | water or brine |
| Refrigerant 4A4 | R454C | Residential Heat Pump | Ground | water or brine |
| Refrigerant 5A | R454C | Residential Heat Pump | Ground | water or brine |
| Refrigerant 5B | R454C | Residential Heat Pump | Ground | water or brine |
| Refrigerant 5C | R454C | Residential Heat Pump | Ground | water or brine |
| Refrigerant 5D | R454C | Residential Heat Pump | Ground | water or brine |
| Refrigerant 5E | R454C | Residential Heat Pump | Ground | water or brine |
| Refrigerant 5F | R454C | Residential Heat Pump | Ground | water or brine |
| Refrigerant 5G | R454C | Residential Heat Pump | Ground | water or brine |
| Refrigerant 5H | R454C | Residential Heat Pump | Ground | water or brine |
| Refrigerant 5I | R454C | Residential Heat Pump | Ground | water or brine |
| Refrigerant 6A | R454C | Residential Heat Pump | Ground | water or brine |
| Refrigerant 6B | R454C | Residential Heat Pump | Ground | water or brine |
| Refrigerant 6C | R454C | Residential Heat Pump | Ground | water or brine |
| Refrigerant 6D | R454C | Residential Heat Pump | Ground | water or brine |
| Refrigerant 6E | R454C | Residential Heat Pump | Ground | water or brine |
| Refrigerant 6F | R454C | Residential Heat Pump | Ground | water or brine |
| Refrigerant 6G | R454C | Residential Heat Pump | Ground | water or brine |
| Refrigerant 6H | R454C | Residential Heat Pump | Ground | water or brine |
| Refrigerant 6I | R454C | Residential Heat Pump | Ground | water or brine |
| Refrigerant 7A | R454C | Residential Heat Pump | Ground | water or brine |
| Refrigerant 7B | R454C | Residential Heat Pump | Ground | water or brine |
| Refrigerant 7C | R454C | Residential Heat Pump | Ground | water or brine |
| Refrigerant 7D | R454C | Residential Heat Pump | Ground | water or brine |
| Refrigerant 7E | R454C | Residential Heat Pump | Ground | water or brine |
| Refrigerant 7F | R454C | Residential Heat Pump | Ground | water or brine |
| Refrigerant 7G | R454C | Residential Heat Pump | Ground | water or brine |
| Refrigerant 7H | R454C | Residential Heat Pump | Ground | water or brine |
| Refrigerant 7I | R454C | Residential Heat Pump | Ground | water or brine |
| Refrigerant 1 | R455A | Residential Heat Pump | Ground | water or brine |
| Refrigerant 2 | R455A | Residential Heat Pump | Ground | water or brine |
| Refrigerant 3 | R455A | Residential Heat Pump | Ground | water or brine |
| Refrigerant 4A1 | R455A | Residential Heat Pump | Ground | water or brine |
| Refrigerant 4A2 | R455A | Residential Heat Pump | Ground | water or brine |
| Refrigerant 4A3 | R455A | Residential Heat Pump | Ground | water or brine |
| Refrigerant 4A4 | R455A | Residential Heat Pump | Ground | water or brine |
| Refrigerant 5A | R455A | Residential Heat Pump | Ground | water or brine |
| Refrigerant 5B | R455A | Residential Heat Pump | Ground | water or brine |
| Refrigerant 5C | R455A | Residential Heat Pump | Ground | water or brine |
| Refrigerant 5D | R455A | Residential Heat Pump | Ground | water or brine |
| Refrigerant 5E | R455A | Residential Heat Pump | Ground | water or brine |
| Refrigerant 5F | R455A | Residential Heat Pump | Ground | water or brine |
| Refrigerant 5G | R455A | Residential Heat Pump | Ground | water or brine |
| Refrigerant 5H | R455A | Residential Heat Pump | Ground | water or brine |
| Refrigerant 5I | R455A | Residential Heat Pump | Ground | water or brine |
| Refrigerant 6A | R455A | Residential Heat Pump | Ground | water or brine |
| Refrigerant 6B | R455A | Residential Heat Pump | Ground | water or brine |
| Refrigerant 6C | R455A | Residential Heat Pump | Ground | water or brine |
| Refrigerant 6D | R455A | Residential Heat Pump | Ground | water or brine |
| Refrigerant 6E | R455A | Residential Heat Pump | Ground | water or brine |
| Refrigerant 6F | R455A | Residential Heat Pump | Ground | water or brine |
| Refrigerant 6G | R455A | Residential Heat Pump | Ground | water or brine |
| Refrigerant 6H | R455A | Residential Heat Pump | Ground | water or brine |
| Refrigerant 6I | R455A | Residential Heat Pump | Ground | water or brine |
| Refrigerant 7A | R455A | Residential Heat Pump | Ground | water or brine |
| Refrigerant 7B | R455A | Residential Heat Pump | Ground | water or brine |
| Refrigerant 7C | R455A | Residential Heat Pump | Ground | water or brine |
| Refrigerant 7D | R455A | Residential Heat Pump | Ground | water or brine |
| Refrigerant 7E | R455A | Residential Heat Pump | Ground | water or brine |
| Refrigerant 7F | R455A | Residential Heat Pump | Ground | water or brine |
| Refrigerant 7G | R455A | Residential Heat Pump | Ground | water or brine |
| Refrigerant 7H | R455A | Residential Heat Pump | Ground | water or brine |
| Refrigerant 7I | R455A | Residential Heat Pump | Ground | water or brine |
| Refrigerant 1 | R32 | Residential Heat Pump | Ground | water or brine |
| Refrigerant 2 | R32 | Residential Heat Pump | Ground | water or brine |
| Refrigerant 3 | R32 | Residential Heat Pump | Ground | water or brine |
| Refrigerant 4A1 | R32 | Residential Heat Pump | Ground | water or brine |
| Refrigerant 4A2 | R32 | Residential Heat Pump | Ground | water or brine |
| Refrigerant 4A3 | R32 | Residential Heat Pump | Ground | water or brine |
| Refrigerant 4A4 | R32 | Residential Heat Pump | Ground | water or brine |
| Refrigerant 5A | R32 | Residential Heat Pump | Ground | water or brine |
| Refrigerant 5B | R32 | Residential Heat Pump | Ground | water or brine |
| Refrigerant 5C | R32 | Residential Heat Pump | Ground | water or brine |
| Refrigerant 5D | R32 | Residential Heat Pump | Ground | water or brine |
| Refrigerant 5E | R32 | Residential Heat Pump | Ground | water or brine |
| Refrigerant 5F | R32 | Residential Heat Pump | Ground | water or brine |
| Refrigerant 5G | R32 | Residential Heat Pump | Ground | water or brine |
| Refrigerant 5H | R32 | Residential Heat Pump | Ground | water or brine |
| Refrigerant 5I | R32 | Residential Heat Pump | Ground | water or brine |
| Refrigerant 6A | R32 | Residential Heat Pump | Ground | water or brine |
| Refrigerant 6B | R32 | Residential Heat Pump | Ground | water or brine |
| Refrigerant 6C | R32 | Residential Heat Pump | Ground | water or brine |
| Refrigerant 6D | R32 | Residential Heat Pump | Ground | water or brine |
| Refrigerant 6E | R32 | Residential Heat Pump | Ground | water or brine |
| Refrigerant 6F | R32 | Residential Heat Pump | Ground | water or brine |
| Refrigerant 6G | R32 | Residential Heat Pump | Ground | water or brine |
| Refrigerant 6H | R32 | Residential Heat Pump | Ground | water or brine |
| Refrigerant 6I | R32 | Residential Heat Pump | Ground | water or brine |
| Refrigerant 7A | R32 | Residential Heat Pump | Ground | water or brine |
| Refrigerant 7B | R32 | Residential Heat Pump | Ground | water or brine |
| Refrigerant 7C | R32 | Residential Heat Pump | Ground | water or brine |
| Refrigerant 7D | R32 | Residential Heat Pump | Ground | water or brine |
| Refrigerant 7E | R32 | Residential Heat Pump | Ground | water or brine |
| Refrigerant 7F | R32 | Residential Heat Pump | Ground | water or brine |
| Refrigerant 7G | R32 | Residential Heat Pump | Ground | water or brine |
| Refrigerant 7H | R32 | Residential Heat Pump | Ground | water or brine |
| Refrigerant 7I | R32 | Residential Heat Pump | Ground | water or brine |
| Refrigerant 1 | NR | Residential Heat Pump | Ground | water or brine |
| Refrigerant 2 | NR | Residential Heat Pump | Ground | water or brine |
| Refrigerant 3 | NR | Residential Heat Pump | Ground | water or brine |
| Refrigerant 4A1 | NR | Residential Heat Pump | Ground | water or brine |
| Refrigerant 4A2 | NR | Residential Heat Pump | Ground | water or brine |
| Refrigerant 4A3 | NR | Residential Heat Pump | Ground | water or brine |
| Refrigerant 4A4 | NR | Residential Heat Pump | Ground | water or brine |
| Refrigerant 5A | NR | Residential Heat Pump | Ground | water or brine |
| Refrigerant 5B | NR | Residential Heat Pump | Ground | water or brine |
| Refrigerant 5C | NR | Residential Heat Pump | Ground | water or brine |
| Refrigerant 5D | NR | Residential Heat Pump | Ground | water or brine |
| Refrigerant 5E | NR | Residential Heat Pump | Ground | water or brine |
| Refrigerant 5F | NR | Residential Heat Pump | Ground | water or brine |
| Refrigerant 5G | NR | Residential Heat Pump | Ground | water or brine |
| Refrigerant 5H | NR | Residential Heat Pump | Ground | water or brine |
| Refrigerant 5I | NR | Residential Heat Pump | Ground | water or brine |
| Refrigerant 6A | NR | Residential Heat Pump | Ground | water or brine |
| Refrigerant 6B | NR | Residential Heat Pump | Ground | water or brine |
| Refrigerant 6C | NR | Residential Heat Pump | Ground | water or brine |
| Refrigerant 6D | NR | Residential Heat Pump | Ground | water or brine |
| Refrigerant 6E | NR | Residential Heat Pump | Ground | water or brine |
| Refrigerant 6F | NR | Residential Heat Pump | Ground | water or brine |
| Refrigerant 6G | NR | Residential Heat Pump | Ground | water or brine |
| Refrigerant 6H | NR | Residential Heat Pump | Ground | water or brine |
| Refrigerant 6I | NR | Residential Heat Pump | Ground | water or brine |
| Refrigerant 7A | NR | Residential Heat Pump | Ground | water or brine |
| Refrigerant 7B | NR | Residential Heat Pump | Ground | water or brine |
| Refrigerant 7C | NR | Residential Heat Pump | Ground | water or brine |
| Refrigerant 7D | NR | Residential Heat Pump | Ground | water or brine |
| Refrigerant 7E | NR | Residential Heat Pump | Ground | water or brine |
| Refrigerant 7F | NR | Residential Heat Pump | Ground | water or brine |
| Refrigerant 7G | NR | Residential Heat Pump | Ground | water or brine |
| Refrigerant 7H | NR | Residential Heat Pump | Ground | water or brine |
| Refrigerant 7I | NR | Residential Heat Pump | Ground | water or brine |
| Refrigerant 1 | R22 | Residential Heat Pump | water | NR |
| Refrigerant 2 | R22 | Residential Heat Pump | water | NR |
| Refrigerant 3 | R22 | Residential Heat Pump | water | NR |
| Refrigerant 4A1 | R22 | Residential Heat Pump | water | NR |
| Refrigerant 4A2 | R22 | Residential Heat Pump | water | NR |
| Refrigerant 4A3 | R22 | Residential Heat Pump | water | NR |
| Refrigerant 4A4 | R22 | Residential Heat Pump | water | NR |
| Refrigerant 5A | R22 | Residential Heat Pump | water | NR |
| Refrigerant 5B | R22 | Residential Heat Pump | water | NR |
| Refrigerant 5C | R22 | Residential Heat Pump | water | NR |
| Refrigerant 5D | R22 | Residential Heat Pump | water | NR |
| Refrigerant 5E | R22 | Residential Heat Pump | water | NR |
| Refrigerant 5F | R22 | Residential Heat Pump | water | NR |
| Refrigerant 5G | R22 | Residential Heat Pump | water | NR |
| Refrigerant 5H | R22 | Residential Heat Pump | water | NR |
| Refrigerant 5I | R22 | Residential Heat Pump | water | NR |
| Refrigerant 6A | R22 | Residential Heat Pump | water | NR |
| Refrigerant 6B | R22 | Residential Heat Pump | water | NR |
| Refrigerant 6C | R22 | Residential Heat Pump | water | NR |
| Refrigerant 6D | R22 | Residential Heat Pump | water | NR |
| Refrigerant 6E | R22 | Residential Heat Pump | water | NR |
| Refrigerant 6F | R22 | Residential Heat Pump | water | NR |
| Refrigerant 6G | R22 | Residential Heat Pump | water | NR |
| Refrigerant 6H | R22 | Residential Heat Pump | water | NR |
| Refrigerant 6I | R22 | Residential Heat Pump | water | NR |
| Refrigerant 7A | R22 | Residential Heat Pump | water | NR |
| Refrigerant 7B | R22 | Residential Heat Pump | water | NR |
| Refrigerant 7C | R22 | Residential Heat Pump | water | NR |
| Refrigerant 7D | R22 | Residential Heat Pump | water | NR |
| Refrigerant 7E | R22 | Residential Heat Pump | water | NR |
| Refrigerant 7F | R22 | Residential Heat Pump | water | NR |
| Refrigerant 7G | R22 | Residential Heat Pump | water | NR |
| Refrigerant 7H | R22 | Residential Heat Pump | water | NR |
| Refrigerant 7I | R22 | Residential Heat Pump | water | NR |
| Refrigerant 1 | R290 | Residential Heat Pump | water | NR |
| Refrigerant 2 | R290 | Residential Heat Pump | water | NR |
| Refrigerant 3 | R290 | Residential Heat Pump | water | NR |
| Refrigerant 4A1 | R290 | Residential Heat Pump | water | NR |
| Refrigerant 4A2 | R290 | Residential Heat Pump | water | NR |
| Refrigerant 4A3 | R290 | Residential Heat Pump | water | NR |
| Refrigerant 4A4 | R290 | Residential Heat Pump | water | NR |
| Refrigerant 5A | R290 | Residential Heat Pump | water | NR |
| Refrigerant 5B | R290 | Residential Heat Pump | water | NR |
| Refrigerant 5C | R290 | Residential Heat Pump | water | NR |
| Refrigerant 5D | R290 | Residential Heat Pump | water | NR |
| Refrigerant 5E | R290 | Residential Heat Pump | water | NR |
| Refrigerant 5F | R290 | Residential Heat Pump | water | NR |
| Refrigerant 5G | R290 | Residential Heat Pump | water | NR |
| Refrigerant 5H | R290 | Residential Heat Pump | water | NR |
| Refrigerant 5I | R290 | Residential Heat Pump | water | NR |
| Refrigerant 6A | R290 | Residential Heat Pump | water | NR |
| Refrigerant 6B | R290 | Residential Heat Pump | water | NR |
| Refrigerant 6C | R290 | Residential Heat Pump | water | NR |
| Refrigerant 6D | R290 | Residential Heat Pump | water | NR |
| Refrigerant 6E | R290 | Residential Heat Pump | water | NR |
| Refrigerant 6F | R290 | Residential Heat Pump | water | NR |
| Refrigerant 6G | R290 | Residential Heat Pump | water | NR |
| Refrigerant 6H | R290 | Residential Heat Pump | water | NR |
| Refrigerant 6I | R290 | Residential Heat Pump | water | NR |
| Refrigerant 7A | R290 | Residential Heat Pump | water | NR |
| Refrigerant 7B | R290 | Residential Heat Pump | water | NR |
| Refrigerant 7C | R290 | Residential Heat Pump | water | NR |
| Refrigerant 7D | R290 | Residential Heat Pump | water | NR |
| Refrigerant 7E | R290 | Residential Heat Pump | water | NR |
| Refrigerant 7F | R290 | Residential Heat Pump | water | NR |
| Refrigerant 7G | R290 | Residential Heat Pump | water | NR |
| Refrigerant 7H | R290 | Residential Heat Pump | water | NR |
| Refrigerant 7I | R290 | Residential Heat Pump | water | NR |
| Refrigerant 1 | R407C | Residential Heat Pump | water | NR |
| Refrigerant 2 | R407C | Residential Heat Pump | water | NR |
| Refrigerant 3 | R407C | Residential Heat Pump | water | NR |
| Refrigerant 4A1 | R407C | Residential Heat Pump | water | NR |
| Refrigerant 4A2 | R407C | Residential Heat Pump | water | NR |
| Refrigerant 4A3 | R407C | Residential Heat Pump | water | NR |
| Refrigerant 4A4 | R407C | Residential Heat Pump | water | NR |
| Refrigerant 5A | R407C | Residential Heat Pump | water | NR |
| Refrigerant 5B | R407C | Residential Heat Pump | water | NR |
| Refrigerant 5C | R407C | Residential Heat Pump | water | NR |
| Refrigerant 5D | R407C | Residential Heat Pump | water | NR |
| Refrigerant 5E | R407C | Residential Heat Pump | water | NR |
| Refrigerant 5F | R407C | Residential Heat Pump | water | NR |
| Refrigerant 5G | R407C | Residential Heat Pump | water | NR |
| Refrigerant 5H | R407C | Residential Heat Pump | water | NR |
| Refrigerant 5I | R407C | Residential Heat Pump | water | NR |
| Refrigerant 6A | R407C | Residential Heat Pump | water | NR |
| Refrigerant 6B | R407C | Residential Heat Pump | water | NR |
| Refrigerant 6C | R407C | Residential Heat Pump | water | NR |
| Refrigerant 6D | R407C | Residential Heat Pump | water | NR |
| Refrigerant 6E | R407C | Residential Heat Pump | water | NR |
| Refrigerant 6F | R407C | Residential Heat Pump | water | NR |
| Refrigerant 6G | R407C | Residential Heat Pump | water | NR |
| Refrigerant 6H | R407C | Residential Heat Pump | water | NR |
| Refrigerant 6I | R407C | Residential Heat Pump | water | NR |
| Refrigerant 7A | R407C | Residential Heat Pump | water | NR |
| Refrigerant 7B | R407C | Residential Heat Pump | water | NR |
| Refrigerant 7C | R407C | Residential Heat Pump | water | NR |
| Refrigerant 7D | R407C | Residential Heat Pump | water | NR |
| Refrigerant 7E | R407C | Residential Heat Pump | water | NR |
| Refrigerant 7F | R407C | Residential Heat Pump | water | NR |
| Refrigerant 7G | R407C | Residential Heat Pump | water | NR |
| Refrigerant 7H | R407C | Residential Heat Pump | water | NR |
| Refrigerant 7I | R407C | Residential Heat Pump | water | NR |
| Refrigerant 1 | R410A | Residential Heat Pump | water | NR |
| Refrigerant 2 | R410A | Residential Heat Pump | water | NR |
| Refrigerant 3 | R410A | Residential Heat Pump | water | NR |
| Refrigerant 4A1 | R410A | Residential Heat Pump | water | NR |
| Refrigerant 4A2 | R410A | Residential Heat Pump | water | NR |
| Refrigerant 4A3 | R410A | Residential Heat Pump | water | NR |
| Refrigerant 4A4 | R410A | Residential Heat Pump | water | NR |
| Refrigerant 5A | R410A | Residential Heat Pump | water | NR |
| Refrigerant 5B | R410A | Residential Heat Pump | water | NR |
| Refrigerant 5C | R410A | Residential Heat Pump | water | NR |
| Refrigerant 5D | R410A | Residential Heat Pump | water | NR |
| Refrigerant 5E | R410A | Residential Heat Pump | water | NR |
| Refrigerant 5F | R410A | Residential Heat Pump | water | NR |
| Refrigerant 5G | R410A | Residential Heat Pump | water | NR |
| Refrigerant 5H | R410A | Residential Heat Pump | water | NR |
| Refrigerant 5I | R410A | Residential Heat Pump | water | NR |
| Refrigerant 6A | R410A | Residential Heat Pump | water | NR |
| Refrigerant 6B | R410A | Residential Heat Pump | water | NR |
| Refrigerant 6C | R410A | Residential Heat Pump | water | NR |
| Refrigerant 6D | R410A | Residential Heat Pump | water | NR |
| Refrigerant 6E | R410A | Residential Heat Pump | water | NR |
| Refrigerant 6F | R410A | Residential Heat Pump | water | NR |
| Refrigerant 6G | R410A | Residential Heat Pump | water | NR |
| Refrigerant 6H | R410A | Residential Heat Pump | water | NR |
| Refrigerant 6I | R410A | Residential Heat Pump | water | NR |
| Refrigerant 7A | R410A | Residential Heat Pump | water | NR |
| Refrigerant 7B | R410A | Residential Heat Pump | water | NR |
| Refrigerant 7C | R410A | Residential Heat Pump | water | NR |
| Refrigerant 7D | R410A | Residential Heat Pump | water | NR |
| Refrigerant 7E | R410A | Residential Heat Pump | water | NR |
| Refrigerant 7F | R410A | Residential Heat Pump | water | NR |
| Refrigerant 7G | R410A | Residential Heat Pump | water | NR |
| Refrigerant 7H | R410A | Residential Heat Pump | water | NR |
| Refrigerant 7I | R410A | Residential Heat Pump | water | NR |
| Refrigerant 1 | R454B | Residential Heat Pump | water | NR |
| Refrigerant 2 | R454B | Residential Heat Pump | water | NR |
| Refrigerant 3 | R454B | Residential Heat Pump | water | NR |
| Refrigerant 4A1 | R454B | Residential Heat Pump | water | NR |
| Refrigerant 4A2 | R454B | Residential Heat Pump | water | NR |
| Refrigerant 4A3 | R454B | Residential Heat Pump | water | NR |
| Refrigerant 4A4 | R454B | Residential Heat Pump | water | NR |
| Refrigerant 5A | R454B | Residential Heat Pump | water | NR |
| Refrigerant 5B | R454B | Residential Heat Pump | water | NR |
| Refrigerant 5C | R454B | Residential Heat Pump | water | NR |
| Refrigerant 5D | R454B | Residential Heat Pump | water | NR |
| Refrigerant 5E | R454B | Residential Heat Pump | water | NR |
| Refrigerant 5F | R454B | Residential Heat Pump | water | NR |
| Refrigerant 5G | R454B | Residential Heat Pump | water | NR |
| Refrigerant 5H | R454B | Residential Heat Pump | water | NR |
| Refrigerant 5I | R454B | Residential Heat Pump | water | NR |
| Refrigerant 6A | R454B | Residential Heat Pump | water | NR |
| Refrigerant 6B | R454B | Residential Heat Pump | water | NR |
| Refrigerant 6C | R454B | Residential Heat Pump | water | NR |
| Refrigerant 6D | R454B | Residential Heat Pump | water | NR |
| Refrigerant 6E | R454B | Residential Heat Pump | water | NR |
| Refrigerant 6F | R454B | Residential Heat Pump | water | NR |
| Refrigerant 6G | R454B | Residential Heat Pump | water | NR |
| Refrigerant 6H | R454B | Residential Heat Pump | water | NR |
| Refrigerant 6I | R454B | Residential Heat Pump | water | NR |
| Refrigerant 7A | R454B | Residential Heat Pump | water | NR |
| Refrigerant 7B | R454B | Residential Heat Pump | water | NR |
| Refrigerant 7C | R454B | Residential Heat Pump | water | NR |
| Refrigerant 7D | R454B | Residential Heat Pump | water | NR |
| Refrigerant 7E | R454B | Residential Heat Pump | water | NR |
| Refrigerant 7F | R454B | Residential Heat Pump | water | NR |
| Refrigerant 7G | R454B | Residential Heat Pump | water | NR |
| Refrigerant 7H | R454B | Residential Heat Pump | water | NR |
| Refrigerant 7I | R454B | Residential Heat Pump | water | NR |
| Refrigerant 1 | R454C | Residential Heat Pump | water | NR |
| Refrigerant 2 | R454C | Residential Heat Pump | water | NR |
| Refrigerant 3 | R454C | Residential Heat Pump | water | NR |
| Refrigerant 4A1 | R454C | Residential Heat Pump | water | NR |
| Refrigerant 4A2 | R454C | Residential Heat Pump | water | NR |
| Refrigerant 4A3 | R454C | Residential Heat Pump | water | NR |
| Refrigerant 4A4 | R454C | Residential Heat Pump | water | NR |
| Refrigerant 5A | R454C | Residential Heat Pump | water | NR |
| Refrigerant 5B | R454C | Residential Heat Pump | water | NR |
| Refrigerant 5C | R454C | Residential Heat Pump | water | NR |
| Refrigerant 5D | R454C | Residential Heat Pump | water | NR |
| Refrigerant 5E | R454C | Residential Heat Pump | water | NR |
| Refrigerant 5F | R454C | Residential Heat Pump | water | NR |
| Refrigerant 5G | R454C | Residential Heat Pump | water | NR |
| Refrigerant 5H | R454C | Residential Heat Pump | water | NR |
| Refrigerant 5I | R454C | Residential Heat Pump | water | NR |
| Refrigerant 6A | R454C | Residential Heat Pump | water | NR |
| Refrigerant 6B | R454C | Residential Heat Pump | water | NR |
| Refrigerant 6C | R454C | Residential Heat Pump | water | NR |
| Refrigerant 6D | R454C | Residential Heat Pump | water | NR |
| Refrigerant 6E | R454C | Residential Heat Pump | water | NR |
| Refrigerant 6F | R454C | Residential Heat Pump | water | NR |
| Refrigerant 6G | R454C | Residential Heat Pump | water | NR |
| Refrigerant 6H | R454C | Residential Heat Pump | water | NR |
| Refrigerant 6I | R454C | Residential Heat Pump | water | NR |
| Refrigerant 7A | R454C | Residential Heat Pump | water | NR |
| Refrigerant 7B | R454C | Residential Heat Pump | water | NR |
| Refrigerant 7C | R454C | Residential Heat Pump | water | NR |
| Refrigerant 7D | R454C | Residential Heat Pump | water | NR |
| Refrigerant 7E | R454C | Residential Heat Pump | water | NR |
| Refrigerant 7F | R454C | Residential Heat Pump | water | NR |
| Refrigerant 7G | R454C | Residential Heat Pump | water | NR |
| Refrigerant 7H | R454C | Residential Heat Pump | water | NR |
| Refrigerant 7I | R454C | Residential Heat Pump | water | NR |
| Refrigerant 1 | R455A | Residential Heat Pump | water | NR |
| Refrigerant 2 | R455A | Residential Heat Pump | water | NR |
| Refrigerant 3 | R455A | Residential Heat Pump | water | NR |
| Refrigerant 4A1 | R455A | Residential Heat Pump | water | NR |
| Refrigerant 4A2 | R455A | Residential Heat Pump | water | NR |
| Refrigerant 4A3 | R455A | Residential Heat Pump | water | NR |
| Refrigerant 4A4 | R455A | Residential Heat Pump | water | NR |
| Refrigerant 5A | R455A | Residential Heat Pump | water | NR |
| Refrigerant 5B | R455A | Residential Heat Pump | water | NR |
| Refrigerant 5C | R455A | Residential Heat Pump | water | NR |
| Refrigerant 5D | R455A | Residential Heat Pump | water | NR |
| Refrigerant 5E | R455A | Residential Heat Pump | water | NR |
| Refrigerant 5F | R455A | Residential Heat Pump | water | NR |
| Refrigerant 5G | R455A | Residential Heat Pump | water | NR |
| Refrigerant 5H | R455A | Residential Heat Pump | water | NR |
| Refrigerant 5I | R455A | Residential Heat Pump | water | NR |
| Refrigerant 6A | R455A | Residential Heat Pump | water | NR |
| Refrigerant 6B | R455A | Residential Heat Pump | water | NR |
| Refrigerant 6C | R455A | Residential Heat Pump | water | NR |
| Refrigerant 6D | R455A | Residential Heat Pump | water | NR |
| Refrigerant 6E | R455A | Residential Heat Pump | water | NR |
| Refrigerant 6F | R455A | Residential Heat Pump | water | NR |
| Refrigerant 6G | R455A | Residential Heat Pump | water | NR |
| Refrigerant 6H | R455A | Residential Heat Pump | water | NR |
| Refrigerant 6I | R455A | Residential Heat Pump | water | NR |
| Refrigerant 7A | R455A | Residential Heat Pump | water | NR |
| Refrigerant 7B | R455A | Residential Heat Pump | water | NR |
| Refrigerant 7C | R455A | Residential Heat Pump | water | NR |
| Refrigerant 7D | R455A | Residential Heat Pump | water | NR |
| Refrigerant 7E | R455A | Residential Heat Pump | water | NR |
| Refrigerant 7F | R455A | Residential Heat Pump | water | NR |
| Refrigerant 7G | R455A | Residential Heat Pump | water | NR |
| Refrigerant 7H | R455A | Residential Heat Pump | water | NR |
| Refrigerant 7I | R455A | Residential Heat Pump | water | NR |
| Refrigerant 1 | R32 | Residential Heat Pump | water | NR |
| Refrigerant 2 | R32 | Residential Heat Pump | water | NR |
| Refrigerant 3 | R32 | Residential Heat Pump | water | NR |
| Refrigerant 4A1 | R32 | Residential Heat Pump | water | NR |
| Refrigerant 4A2 | R32 | Residential Heat Pump | water | NR |
| Refrigerant 4A3 | R32 | Residential Heat Pump | water | NR |
| Refrigerant 4A4 | R32 | Residential Heat Pump | water | NR |
| Refrigerant 5A | R32 | Residential Heat Pump | water | NR |
| Refrigerant 5B | R32 | Residential Heat Pump | water | NR |
| Refrigerant 5C | R32 | Residential Heat Pump | water | NR |
| Refrigerant 5D | R32 | Residential Heat Pump | water | NR |
| Refrigerant 5E | R32 | Residential Heat Pump | water | NR |
| Refrigerant 5F | R32 | Residential Heat Pump | water | NR |
| Refrigerant 5G | R32 | Residential Heat Pump | water | NR |
| Refrigerant 5H | R32 | Residential Heat Pump | water | NR |
| Refrigerant 5I | R32 | Residential Heat Pump | water | NR |
| Refrigerant 6A | R32 | Residential Heat Pump | water | NR |
| Refrigerant 6B | R32 | Residential Heat Pump | water | NR |
| Refrigerant 6C | R32 | Residential Heat Pump | water | NR |
| Refrigerant 6D | R32 | Residential Heat Pump | water | NR |
| Refrigerant 6E | R32 | Residential Heat Pump | water | NR |
| Refrigerant 6F | R32 | Residential Heat Pump | water | NR |
| Refrigerant 6G | R32 | Residential Heat Pump | water | NR |
| Refrigerant 6H | R32 | Residential Heat Pump | water | NR |
| Refrigerant 6I | R32 | Residential Heat Pump | water | NR |
| Refrigerant 7A | R32 | Residential Heat Pump | water | NR |
| Refrigerant 7B | R32 | Residential Heat Pump | water | NR |
| Refrigerant 7C | R32 | Residential Heat Pump | water | NR |
| Refrigerant 7D | R32 | Residential Heat Pump | water | NR |
| Refrigerant 7E | R32 | Residential Heat Pump | water | NR |
| Refrigerant 7F | R32 | Residential Heat Pump | water | NR |
| Refrigerant 7G | R32 | Residential Heat Pump | water | NR |
| Refrigerant 7H | R32 | Residential Heat Pump | water | NR |
| Refrigerant 7I | R32 | Residential Heat Pump | water | NR |
| Refrigerant 1 | NR | Residential Heat Pump | water | NR |
| Refrigerant 2 | NR | Residential Heat Pump | water | NR |
| Refrigerant 3 | NR | Residential Heat Pump | water | NR |
| Refrigerant 4A1 | NR | Residential Heat Pump | water | NR |
| Refrigerant 4A2 | NR | Residential Heat Pump | water | NR |
| Refrigerant 4A3 | NR | Residential Heat Pump | water | NR |
| Refrigerant 4A4 | NR | Residential Heat Pump | water | NR |
| Refrigerant 5A | NR | Residential Heat Pump | water | NR |
| Refrigerant 5B | NR | Residential Heat Pump | water | NR |
| Refrigerant 5C | NR | Residential Heat Pump | water | NR |
| Refrigerant 5D | NR | Residential Heat Pump | water | NR |
| Refrigerant 5E | NR | Residential Heat Pump | water | NR |
| Refrigerant 5F | NR | Residential Heat Pump | water | NR |
| Refrigerant 5G | NR | Residential Heat Pump | water | NR |
| Refrigerant 5H | NR | Residential Heat Pump | water | NR |
| Refrigerant 5I | NR | Residential Heat Pump | water | NR |
| Refrigerant 6A | NR | Residential Heat Pump | water | NR |
| Refrigerant 6B | NR | Residential Heat Pump | water | NR |
| Refrigerant 6C | NR | Residential Heat Pump | water | NR |
| Refrigerant 6D | NR | Residential Heat Pump | water | NR |
| Refrigerant 6E | NR | Residential Heat Pump | water | NR |
| Refrigerant 6F | NR | Residential Heat Pump | water | NR |
| Refrigerant 6G | NR | Residential Heat Pump | water | NR |
| Refrigerant 6H | NR | Residential Heat Pump | water | NR |
| Refrigerant 6I | NR | Residential Heat Pump | water | NR |
| Refrigerant 7A | NR | Residential Heat Pump | water | NR |
| Refrigerant 7B | NR | Residential Heat Pump | water | NR |
| Refrigerant 7C | NR | Residential Heat Pump | water | NR |
| Refrigerant 7D | NR | Residential Heat Pump | water | NR |
| Refrigerant 7E | NR | Residential Heat Pump | water | NR |
| Refrigerant 7F | NR | Residential Heat Pump | water | NR |
| Refrigerant 7G | NR | Residential Heat Pump | water | NR |
| Refrigerant 7H | NR | Residential Heat Pump | water | NR |
| Refrigerant 7I | NR | Residential Heat Pump | water | NR |
| Refrigerant 1 | R22 | Residential Heat Pump | water | water or brine |
| Refrigerant 2 | R22 | Residential Heat Pump | water | water or brine |
| Refrigerant 3 | R22 | Residential Heat Pump | water | water or brine |
| Refrigerant 4A1 | R22 | Residential Heat Pump | water | water or brine |
| Refrigerant 4A2 | R22 | Residential Heat Pump | water | water or brine |
| Refrigerant 4A3 | R22 | Residential Heat Pump | water | water or brine |
| Refrigerant 4A4 | R22 | Residential Heat Pump | water | water or brine |
| Refrigerant 5A | R22 | Residential Heat Pump | water | water or brine |
| Refrigerant 5B | R22 | Residential Heat Pump | water | water or brine |
| Refrigerant 5C | R22 | Residential Heat Pump | water | water or brine |
| Refrigerant 5D | R22 | Residential Heat Pump | water | water or brine |
| Refrigerant 5E | R22 | Residential Heat Pump | water | water or brine |
| Refrigerant 5F | R22 | Residential Heat Pump | water | water or brine |
| Refrigerant 5G | R22 | Residential Heat Pump | water | water or brine |
| Refrigerant 5H | R22 | Residential Heat Pump | water | water or brine |
| Refrigerant 5I | R22 | Residential Heat Pump | water | water or brine |
| Refrigerant 6A | R22 | Residential Heat Pump | water | water or brine |
| Refrigerant 6B | R22 | Residential Heat Pump | water | water or brine |
| Refrigerant 6C | R22 | Residential Heat Pump | water | water or brine |
| Refrigerant 6D | R22 | Residential Heat Pump | water | water or brine |
| Refrigerant 6E | R22 | Residential Heat Pump | water | water or brine |
| Refrigerant 6F | R22 | Residential Heat Pump | water | water or brine |
| Refrigerant 6G | R22 | Residential Heat Pump | water | water or brine |
| Refrigerant 6H | R22 | Residential Heat Pump | water | water or brine |
| Refrigerant 6I | R22 | Residential Heat Pump | water | water or brine |
| Refrigerant 7A | R22 | Residential Heat Pump | water | water or brine |
| Refrigerant 7B | R22 | Residential Heat Pump | water | water or brine |
| Refrigerant 7C | R22 | Residential Heat Pump | water | water or brine |
| Refrigerant 7D | R22 | Residential Heat Pump | water | water or brine |
| Refrigerant 7E | R22 | Residential Heat Pump | water | water or brine |
| Refrigerant 7F | R22 | Residential Heat Pump | water | water or brine |
| Refrigerant 7G | R22 | Residential Heat Pump | water | water or brine |
| Refrigerant 7H | R22 | Residential Heat Pump | water | water or brine |
| Refrigerant 7I | R22 | Residential Heat Pump | water | water or brine |
| Refrigerant 1 | R290 | Residential Heat Pump | water | water or brine |
| Refrigerant 2 | R290 | Residential Heat Pump | water | water or brine |
| Refrigerant 3 | R290 | Residential Heat Pump | water | water or brine |
| Refrigerant 4A1 | R290 | Residential Heat Pump | water | water or brine |
| Refrigerant 4A2 | R290 | Residential Heat Pump | water | water or brine |
| Refrigerant 4A3 | R290 | Residential Heat Pump | water | water or brine |
| Refrigerant 4A4 | R290 | Residential Heat Pump | water | water or brine |
| Refrigerant 5A | R290 | Residential Heat Pump | water | water or brine |
| Refrigerant 5B | R290 | Residential Heat Pump | water | water or brine |
| Refrigerant 5C | R290 | Residential Heat Pump | water | water or brine |
| Refrigerant 5D | R290 | Residential Heat Pump | water | water or brine |
| Refrigerant 5E | R290 | Residential Heat Pump | water | water or brine |
| Refrigerant 5F | R290 | Residential Heat Pump | water | water or brine |
| Refrigerant 5G | R290 | Residential Heat Pump | water | water or brine |
| Refrigerant 5H | R290 | Residential Heat Pump | water | water or brine |
| Refrigerant 5I | R290 | Residential Heat Pump | water | water or brine |
| Refrigerant 6A | R290 | Residential Heat Pump | water | water or brine |
| Refrigerant 6B | R290 | Residential Heat Pump | water | water or brine |
| Refrigerant 6C | R290 | Residential Heat Pump | water | water or brine |
| Refrigerant 6D | R290 | Residential Heat Pump | water | water or brine |
| Refrigerant 6E | R290 | Residential Heat Pump | water | water or brine |
| Refrigerant 6F | R290 | Residential Heat Pump | water | water or brine |
| Refrigerant 6G | R290 | Residential Heat Pump | water | water or brine |
| Refrigerant 6H | R290 | Residential Heat Pump | water | water or brine |
| Refrigerant 6I | R290 | Residential Heat Pump | water | water or brine |
| Refrigerant 7A | R290 | Residential Heat Pump | water | water or brine |
| Refrigerant 7B | R290 | Residential Heat Pump | water | water or brine |
| Refrigerant 7C | R290 | Residential Heat Pump | water | water or brine |
| Refrigerant 7D | R290 | Residential Heat Pump | water | water or brine |
| Refrigerant 7E | R290 | Residential Heat Pump | water | water or brine |
| Refrigerant 7F | R290 | Residential Heat Pump | water | water or brine |
| Refrigerant 7G | R290 | Residential Heat Pump | water | water or brine |
| Refrigerant 7H | R290 | Residential Heat Pump | water | water or brine |
| Refrigerant 7I | R290 | Residential Heat Pump | water | water or brine |
| Refrigerant 1 | R407C | Residential Heat Pump | water | water or brine |
| Refrigerant 2 | R407C | Residential Heat Pump | water | water or brine |
| Refrigerant 3 | R407C | Residential Heat Pump | water | water or brine |
| Refrigerant 4A1 | R407C | Residential Heat Pump | water | water or brine |
| Refrigerant 4A2 | R407C | Residential Heat Pump | water | water or brine |
| Refrigerant 4A3 | R407C | Residential Heat Pump | water | water or brine |
| Refrigerant 4A4 | R407C | Residential Heat Pump | water | water or brine |
| Refrigerant 5A | R407C | Residential Heat Pump | water | water or brine |
| Refrigerant 5B | R407C | Residential Heat Pump | water | water or brine |
| Refrigerant 5C | R407C | Residential Heat Pump | water | water or brine |
| Refrigerant 5D | R407C | Residential Heat Pump | water | water or brine |
| Refrigerant 5E | R407C | Residential Heat Pump | water | water or brine |
| Refrigerant 5F | R407C | Residential Heat Pump | water | water or brine |
| Refrigerant 5G | R407C | Residential Heat Pump | water | water or brine |
| Refrigerant 5H | R407C | Residential Heat Pump | water | water or brine |
| Refrigerant 5I | R407C | Residential Heat Pump | water | water or brine |
| Refrigerant 6A | R407C | Residential Heat Pump | water | water or brine |
| Refrigerant 6B | R407C | Residential Heat Pump | water | water or brine |
| Refrigerant 6C | R407C | Residential Heat Pump | water | water or brine |
| Refrigerant 6D | R407C | Residential Heat Pump | water | water or brine |
| Refrigerant 6E | R407C | Residential Heat Pump | water | water or brine |
| Refrigerant 6F | R407C | Residential Heat Pump | water | water or brine |
| Refrigerant 6G | R407C | Residential Heat Pump | water | water or brine |
| Refrigerant 6H | R407C | Residential Heat Pump | water | water or brine |
| Refrigerant 6I | R407C | Residential Heat Pump | water | water or brine |
| Refrigerant 7A | R407C | Residential Heat Pump | water | water or brine |
| Refrigerant 7B | R407C | Residential Heat Pump | water | water or brine |
| Refrigerant 7C | R407C | Residential Heat Pump | water | water or brine |
| Refrigerant 7D | R407C | Residential Heat Pump | water | water or brine |
| Refrigerant 7E | R407C | Residential Heat Pump | water | water or brine |
| Refrigerant 7F | R407C | Residential Heat Pump | water | water or brine |
| Refrigerant 7G | R407C | Residential Heat Pump | water | water or brine |
| Refrigerant 7H | R407C | Residential Heat Pump | water | water or brine |
| Refrigerant 7I | R407C | Residential Heat Pump | water | water or brine |
| Refrigerant 1 | R410A | Residential Heat Pump | water | water or brine |
| Refrigerant 2 | R410A | Residential Heat Pump | water | water or brine |
| Refrigerant 3 | R410A | Residential Heat Pump | water | water or brine |
| Refrigerant 4A1 | R410A | Residential Heat Pump | water | water or brine |
| Refrigerant 4A2 | R410A | Residential Heat Pump | water | water or brine |
| Refrigerant 4A3 | R410A | Residential Heat Pump | water | water or brine |
| Refrigerant 4A4 | R410A | Residential Heat Pump | water | water or brine |
| Refrigerant 5A | R410A | Residential Heat Pump | water | water or brine |
| Refrigerant 5B | R410A | Residential Heat Pump | water | water or brine |
| Refrigerant 5C | R410A | Residential Heat Pump | water | water or brine |
| Refrigerant 5D | R410A | Residential Heat Pump | water | water or brine |
| Refrigerant 5E | R410A | Residential Heat Pump | water | water or brine |
| Refrigerant 5F | R410A | Residential Heat Pump | water | water or brine |
| Refrigerant 5G | R410A | Residential Heat Pump | water | water or brine |
| Refrigerant 5H | R410A | Residential Heat Pump | water | water or brine |
| Refrigerant 5I | R410A | Residential Heat Pump | water | water or brine |
| Refrigerant 6A | R410A | Residential Heat Pump | water | water or brine |
| Refrigerant 6B | R410A | Residential Heat Pump | water | water or brine |
| Refrigerant 6C | R410A | Residential Heat Pump | water | water or brine |
| Refrigerant 6D | R410A | Residential Heat Pump | water | water or brine |
| Refrigerant 6E | R410A | Residential Heat Pump | water | water or brine |
| Refrigerant 6F | R410A | Residential Heat Pump | water | water or brine |
| Refrigerant 6G | R410A | Residential Heat Pump | water | water or brine |
| Refrigerant 6H | R410A | Residential Heat Pump | water | water or brine |
| Refrigerant 6I | R410A | Residential Heat Pump | water | water or brine |
| Refrigerant 7A | R410A | Residential Heat Pump | water | water or brine |
| Refrigerant 7B | R410A | Residential Heat Pump | water | water or brine |
| Refrigerant 7C | R410A | Residential Heat Pump | water | water or brine |
| Refrigerant 7D | R410A | Residential Heat Pump | water | water or brine |
| Refrigerant 7E | R410A | Residential Heat Pump | water | water or brine |
| Refrigerant 7F | R410A | Residential Heat Pump | water | water or brine |
| Refrigerant 7G | R410A | Residential Heat Pump | water | water or brine |
| Refrigerant 7H | R410A | Residential Heat Pump | water | water or brine |
| Refrigerant 7I | R410A | Residential Heat Pump | water | water or brine |
| Refrigerant 1 | R454B | Residential Heat Pump | water | water or brine |
| Refrigerant 2 | R454B | Residential Heat Pump | water | water or brine |
| Refrigerant 3 | R454B | Residential Heat Pump | water | water or brine |
| Refrigerant 4A1 | R454B | Residential Heat Pump | water | water or brine |
| Refrigerant 4A2 | R454B | Residential Heat Pump | water | water or brine |
| Refrigerant 4A3 | R454B | Residential Heat Pump | water | water or brine |
| Refrigerant 4A4 | R454B | Residential Heat Pump | water | water or brine |
| Refrigerant 5A | R454B | Residential Heat Pump | water | water or brine |
| Refrigerant 5B | R454B | Residential Heat Pump | water | water or brine |
| Refrigerant 5C | R454B | Residential Heat Pump | water | water or brine |
| Refrigerant 5D | R454B | Residential Heat Pump | water | water or brine |
| Refrigerant 5E | R454B | Residential Heat Pump | water | water or brine |
| Refrigerant 5F | R454B | Residential Heat Pump | water | water or brine |
| Refrigerant 5G | R454B | Residential Heat Pump | water | water or brine |
| Refrigerant 5H | R454B | Residential Heat Pump | water | water or brine |
| Refrigerant 5I | R454B | Residential Heat Pump | water | water or brine |
| Refrigerant 6A | R454B | Residential Heat Pump | water | water or brine |
| Refrigerant 6B | R454B | Residential Heat Pump | water | water or brine |
| Refrigerant 6C | R454B | Residential Heat Pump | water | water or brine |
| Refrigerant 6D | R454B | Residential Heat Pump | water | water or brine |
| Refrigerant 6E | R454B | Residential Heat Pump | water | water or brine |
| Refrigerant 6F | R454B | Residential Heat Pump | water | water or brine |
| Refrigerant 6G | R454B | Residential Heat Pump | water | water or brine |
| Refrigerant 6H | R454B | Residential Heat Pump | water | water or brine |
| Refrigerant 6I | R454B | Residential Heat Pump | water | water or brine |
| Refrigerant 7A | R454B | Residential Heat Pump | water | water or brine |
| Refrigerant 7B | R454B | Residential Heat Pump | water | water or brine |
| Refrigerant 7C | R454B | Residential Heat Pump | water | water or brine |
| Refrigerant 7D | R454B | Residential Heat Pump | water | water or brine |
| Refrigerant 7E | R454B | Residential Heat Pump | water | water or brine |
| Refrigerant 7F | R454B | Residential Heat Pump | water | water or brine |
| Refrigerant 7G | R454B | Residential Heat Pump | water | water or brine |
| Refrigerant 7H | R454B | Residential Heat Pump | water | water or brine |
| Refrigerant 7I | R454B | Residential Heat Pump | water | water or brine |
| Refrigerant 1 | R454C | Residential Heat Pump | water | water or brine |
| Refrigerant 2 | R454C | Residential Heat Pump | water | water or brine |
| Refrigerant 3 | R454C | Residential Heat Pump | water | water or brine |
| Refrigerant 4A1 | R454C | Residential Heat Pump | water | water or brine |
| Refrigerant 4A2 | R454C | Residential Heat Pump | water | water or brine |
| Refrigerant 4A3 | R454C | Residential Heat Pump | water | water or brine |
| Refrigerant 4A4 | R454C | Residential Heat Pump | water | water or brine |
| Refrigerant 5A | R454C | Residential Heat Pump | water | water or brine |
| Refrigerant 5B | R454C | Residential Heat Pump | water | water or brine |
| Refrigerant 5C | R454C | Residential Heat Pump | water | water or brine |
| Refrigerant 5D | R454C | Residential Heat Pump | water | water or brine |
| Refrigerant 5E | R454C | Residential Heat Pump | water | water or brine |
| Refrigerant 5F | R454C | Residential Heat Pump | water | water or brine |
| Refrigerant 5G | R454C | Residential Heat Pump | water | water or brine |
| Refrigerant 5H | R454C | Residential Heat Pump | water | water or brine |
| Refrigerant 5I | R454C | Residential Heat Pump | water | water or brine |
| Refrigerant 6A | R454C | Residential Heat Pump | water | water or brine |
| Refrigerant 6B | R454C | Residential Heat Pump | water | water or brine |
| Refrigerant 6C | R454C | Residential Heat Pump | water | water or brine |
| Refrigerant 6D | R454C | Residential Heat Pump | water | water or brine |
| Refrigerant 6E | R454C | Residential Heat Pump | water | water or brine |
| Refrigerant 6F | R454C | Residential Heat Pump | water | water or brine |
| Refrigerant 6G | R454C | Residential Heat Pump | water | water or brine |
| Refrigerant 6H | R454C | Residential Heat Pump | water | water or brine |
| Refrigerant 6I | R454C | Residential Heat Pump | water | water or brine |
| Refrigerant 7A | R454C | Residential Heat Pump | water | water or brine |
| Refrigerant 7B | R454C | Residential Heat Pump | water | water or brine |
| Refrigerant 7C | R454C | Residential Heat Pump | water | water or brine |
| Refrigerant 7D | R454C | Residential Heat Pump | water | water or brine |
| Refrigerant 7E | R454C | Residential Heat Pump | water | water or brine |
| Refrigerant 7F | R454C | Residential Heat Pump | water | water or brine |
| Refrigerant 7G | R454C | Residential Heat Pump | water | water or brine |
| Refrigerant 7H | R454C | Residential Heat Pump | water | water or brine |
| Refrigerant 7I | R454C | Residential Heat Pump | water | water or brine |
| Refrigerant 1 | R455A | Residential Heat Pump | water | water or brine |
| Refrigerant 2 | R455A | Residential Heat Pump | water | water or brine |
| Refrigerant 3 | R455A | Residential Heat Pump | water | water or brine |
| Refrigerant 4A1 | R455A | Residential Heat Pump | water | water or brine |
| Refrigerant 4A2 | R455A | Residential Heat Pump | water | water or brine |
| Refrigerant 4A3 | R455A | Residential Heat Pump | water | water or brine |
| Refrigerant 4A4 | R455A | Residential Heat Pump | water | water or brine |
| Refrigerant 5A | R455A | Residential Heat Pump | water | water or brine |
| Refrigerant 5B | R455A | Residential Heat Pump | water | water or brine |
| Refrigerant 5C | R455A | Residential Heat Pump | water | water or brine |
| Refrigerant 5D | R455A | Residential Heat Pump | water | water or brine |
| Refrigerant 5E | R455A | Residential Heat Pump | water | water or brine |
| Refrigerant 5F | R455A | Residential Heat Pump | water | water or brine |
| Refrigerant 5G | R455A | Residential Heat Pump | water | water or brine |
| Refrigerant 5H | R455A | Residential Heat Pump | water | water or brine |
| Refrigerant 5I | R455A | Residential Heat Pump | water | water or brine |
| Refrigerant 6A | R455A | Residential Heat Pump | water | water or brine |
| Refrigerant 6B | R455A | Residential Heat Pump | water | water or brine |
| Refrigerant 6C | R455A | Residential Heat Pump | water | water or brine |
| Refrigerant 6D | R455A | Residential Heat Pump | water | water or brine |
| Refrigerant 6E | R455A | Residential Heat Pump | water | water or brine |
| Refrigerant 6F | R455A | Residential Heat Pump | water | water or brine |
| Refrigerant 6G | R455A | Residential Heat Pump | water | water or brine |
| Refrigerant 6H | R455A | Residential Heat Pump | water | water or brine |
| Refrigerant 6I | R455A | Residential Heat Pump | water | water or brine |
| Refrigerant 7A | R455A | Residential Heat Pump | water | water or brine |
| Refrigerant 7B | R455A | Residential Heat Pump | water | water or brine |
| Refrigerant 7C | R455A | Residential Heat Pump | water | water or brine |
| Refrigerant 7D | R455A | Residential Heat Pump | water | water or brine |
| Refrigerant 7E | R455A | Residential Heat Pump | water | water or brine |
| Refrigerant 7F | R455A | Residential Heat Pump | water | water or brine |
| Refrigerant 7G | R455A | Residential Heat Pump | water | water or brine |
| Refrigerant 7H | R455A | Residential Heat Pump | water | water or brine |
| Refrigerant 7I | R455A | Residential Heat Pump | water | water or brine |
| Refrigerant 1 | R32 | Residential Heat Pump | water | water or brine |
| Refrigerant 2 | R32 | Residential Heat Pump | water | water or brine |
| Refrigerant 3 | R32 | Residential Heat Pump | water | water or brine |
| Refrigerant 4A1 | R32 | Residential Heat Pump | water | water or brine |
| Refrigerant 4A2 | R32 | Residential Heat Pump | water | water or brine |
| Refrigerant 4A3 | R32 | Residential Heat Pump | water | water or brine |
| Refrigerant 4A4 | R32 | Residential Heat Pump | water | water or brine |
| Refrigerant 5A | R32 | Residential Heat Pump | water | water or brine |
| Refrigerant 5B | R32 | Residential Heat Pump | water | water or brine |
| Refrigerant 5C | R32 | Residential Heat Pump | water | water or brine |
| Refrigerant 5D | R32 | Residential Heat Pump | water | water or brine |
| Refrigerant 5E | R32 | Residential Heat Pump | water | water or brine |
| Refrigerant 5F | R32 | Residential Heat Pump | water | water or brine |
| Refrigerant 5G | R32 | Residential Heat Pump | water | water or brine |
| Refrigerant 5H | R32 | Residential Heat Pump | water | water or brine |
| Refrigerant 5I | R32 | Residential Heat Pump | water | water or brine |
| Refrigerant 6A | R32 | Residential Heat Pump | water | water or brine |
| Refrigerant 6B | R32 | Residential Heat Pump | water | water or brine |
| Refrigerant 6C | R32 | Residential Heat Pump | water | water or brine |
| Refrigerant 6D | R32 | Residential Heat Pump | water | water or brine |
| Refrigerant 6E | R32 | Residential Heat Pump | water | water or brine |
| Refrigerant 6F | R32 | Residential Heat Pump | water | water or brine |
| Refrigerant 6G | R32 | Residential Heat Pump | water | water or brine |
| Refrigerant 6H | R32 | Residential Heat Pump | water | water or brine |
| Refrigerant 6I | R32 | Residential Heat Pump | water | water or brine |
| Refrigerant 7A | R32 | Residential Heat Pump | water | water or brine |
| Refrigerant 7B | R32 | Residential Heat Pump | water | water or brine |
| Refrigerant 7C | R32 | Residential Heat Pump | water | water or brine |
| Refrigerant 7D | R32 | Residential Heat Pump | water | water or brine |
| Refrigerant 7E | R32 | Residential Heat Pump | water | water or brine |
| Refrigerant 7F | R32 | Residential Heat Pump | water | water or brine |
| Refrigerant 7G | R32 | Residential Heat Pump | water | water or brine |
| Refrigerant 7H | R32 | Residential Heat Pump | water | water or brine |
| Refrigerant 7I | R32 | Residential Heat Pump | water | water or brine |
| Refrigerant 1 | NR | Residential Heat Pump | water | water or brine |
| Refrigerant 2 | NR | Residential Heat Pump | water | water or brine |
| Refrigerant 3 | NR | Residential Heat Pump | water | water or brine |
| Refrigerant 4A1 | NR | Residential Heat Pump | water | water or brine |
| Refrigerant 4A2 | NR | Residential Heat Pump | water | water or brine |
| Refrigerant 4A3 | NR | Residential Heat Pump | water | water or brine |
| Refrigerant 4A4 | NR | Residential Heat Pump | water | water or brine |
| Refrigerant 5A | NR | Residential Heat Pump | water | water or brine |
| Refrigerant 5B | NR | Residential Heat Pump | water | water or brine |
| Refrigerant 5C | NR | Residential Heat Pump | water | water or brine |
| Refrigerant 5D | NR | Residential Heat Pump | water | water or brine |
| Refrigerant 5E | NR | Residential Heat Pump | water | water or brine |
| Refrigerant 5F | NR | Residential Heat Pump | water | water or brine |
| Refrigerant 5G | NR | Residential Heat Pump | water | water or brine |
| Refrigerant 5H | NR | Residential Heat Pump | water | water or brine |
| Refrigerant 5I | NR | Residential Heat Pump | water | water or brine |
| Refrigerant 6A | NR | Residential Heat Pump | water | water or brine |
| Refrigerant 6B | NR | Residential Heat Pump | water | water or brine |
| Refrigerant 6C | NR | Residential Heat Pump | water | water or brine |
| Refrigerant 6D | NR | Residential Heat Pump | water | water or brine |
| Refrigerant 6E | NR | Residential Heat Pump | water | water or brine |
| Refrigerant 6F | NR | Residential Heat Pump | water | water or brine |
| Refrigerant 6G | NR | Residential Heat Pump | water | water or brine |
| Refrigerant 6H | NR | Residential Heat Pump | water | water or brine |
| Refrigerant 6I | NR | Residential Heat Pump | water | water or brine |
| Refrigerant 7A | NR | Residential Heat Pump | water | water or brine |
| Refrigerant 7B | NR | Residential Heat Pump | water | water or brine |
| Refrigerant 7C | NR | Residential Heat Pump | water | water or brine |
| Refrigerant 7D | NR | Residential Heat Pump | water | water or brine |
| Refrigerant 7E | NR | Residential Heat Pump | water | water or brine |
| Refrigerant 7F | NR | Residential Heat Pump | water | water or brine |
| Refrigerant 7G | NR | Residential Heat Pump | water | water or brine |
| Refrigerant 7H | NR | Residential Heat Pump | water | water or brine |
| Refrigerant 7I | NR | Residential Heat Pump | water | water or brine |

The present disclosure includes methods for providing heating comprising:
(a) evaporating a refrigerant according to the present disclosure, including each of Refrigerants 1-7, in the vicinity of the heat source (external air, ground or water) to be cooled at a temperature of from about −40° C. to about +15° C. to produce a refrigerant vapor;
(b) compressing said refrigerant vapor to produce a refrigerant at discharge temperature of less than about 135° C.; and
(c) condensing the refrigerant from said compressor at a temperature of from about 20° C. to about 70° C. in the vicinity of the heat sink (water or another secondary fluid) to produce a refrigerant liquid. The heated water or secondary fluid is then pumped throughout the building to provide heating. Heating methods in accordance with this paragraph are referred to herein as Heating Method 1.

The present disclosure includes methods for providing heating comprising:
(a) evaporating a refrigerant according to the present disclosure, including each of Refrigerants 1-7, in the vicinity of the heat source (external air, ground or water) to be cooled at a temperature of from about −40° C. to about +15° C. to produce a refrigerant vapor;
(b) compressing said refrigerant vapor to produce a refrigerant at discharge temperature of less than about 135° C.; and
(c) condensing the refrigerant from said compressor at a temperature of from about 20° C. to about 70° C. in the vicinity of the heat sink (indoor air) to produce a refrigerant liquid and provide heating. Heating methods in accordance with this paragraph are referred to herein as Heating Method 2.

The present disclosure includes conducting heating according to Heating Method 1 in any one of the following systems: air-to-water heat pump systems, ground-source heat pump systems, water-source heat pump systems.

The present disclosure includes conducting heating according to Heating Method 2 in any one of the following systems: air-to-air heat pump systems, ground-source heat pump systems and water-source heat pump systems.

The present disclosure includes methods for replacing the refrigerant in an R-32 heat pump system comprising:
(a) using instead of the R-32 in said heat pump system a refrigerant according to the present disclosure, including each of Refrigerants 1-7; and
(b) using in said system a vapor injector economizer and/or a suction-line liquid line heat exchanger, wherein said refrigerant operating in said system has a COP of at least about 104% of the use of R32 in said system. Methods in accordance with this paragraph are referred to herein as Replacement Method 1A.

The present disclosure includes methods for replacing the refrigerant in an R-32 heat pump system comprising:
(a) using instead of the R-32 in said heat pump system a refrigerant according to the present disclosure, including each of Refrigerants 1-7; and
(b) using in said system a vapor injector economizer, wherein said refrigerant operating in said system has a COP of at least about 104% of the use of R32 in said system and wherein the capacity of said refrigerant in said system is at least about 80% of the capacity of R32 in said system without a vapor injector economizer. Methods in accordance with this paragraph are referred to herein as Replacement Method 1B.

The present disclosure includes methods for replacing the refrigerant in an R-32 heat pump system comprising:
(a) using instead of the R-32 in said heat pump system a refrigerant according to the present disclosure, including each of Refrigerants 1-7, provided that said refrigerant comprises at least about 20% by weight of R-1132(E); and
(b) using in said system a vapor injector economizer. Methods in accordance with this paragraph are referred to herein as Replacement Method 1C.

The present disclosure includes methods for replacing the refrigerant in an R-290 heat pump system comprising:
(a) using instead of the R-290 in said heat pump system a refrigerant according to the present disclosure, including each of Refrigerants 1-7; and
(b) using in said system a vapor injector economizer and/or a suction-line liquid line heat exchanger, wherein said refrigerant operating in said system has a COP of at least about 98% of the use of R-290 in said system. Methods in accordance with this paragraph are referred to herein as Replacement Method 2A.

The present disclosure includes methods for replacing the refrigerant in an R-290 heat pump system comprising:
(a) using instead of the R-290 in said heat pump system a refrigerant according to the present disclosure, including each of Refrigerants 1-7; and
(b) using in said system a suction-line liquid line heat exchanger, wherein said refrigerant operating in said system has a capacity of COP of at least about 101% of the use of R290 in said system and wherein the capacity of said refrigerant in said system is at least about 120% of the capacity of R290 in said system. Methods in accordance with this paragraph are referred to herein as Replacement Method 2B.

The present disclosure includes methods for replacing the refrigerant in an R-290 heat pump system comprising:
(a) using instead of the R-290 in said heat pump system a refrigerant according to the present disclosure, including each of Refrigerants 1-7; and
(b) using in said system a vapor injector economizer, wherein said refrigerant operating in said system has a capacity of COP of at least about 101% of the use of R290 in said system and wherein the capacity of said refrigerant in said system is at least about 128% of the capacity of R290 in said system. Methods in accordance with this paragraph are referred to herein as Replacement Method 2C.

The present disclosure includes methods for replacing the refrigerant in an R-410A heat pump system comprising:
(a) using instead of the R-410A in said heat pump system a refrigerant according to the present disclosure, including each of Refrigerants 1-7; and
(b) using in said system a vapor injector economizer and/or a suction-line liquid line heat exchanger, wherein said refrigerant operating in said system has a COP of at least about 100% of the use of R410A in said system. Methods in accordance with this paragraph are referred to herein as Replacement Method 3A.

The present disclosure includes methods for replacing the refrigerant in an R-410A heat pump system comprising:
(a) using instead of the R-410A in said heat pump system a refrigerant according to the present disclosure, including each of Refrigerants 1-7; and
(b) using in said system a vapor injector economizer, wherein said refrigerant operating in said system has a COP of at least about 100% of the use of R410A in said system and wherein the capacity of said refrigerant in said system is at least about 90% of the capacity of Rr410A in said system without a vapor injector economizer. Methods in accordance with this paragraph are referred to herein as Replacement Method 3B.

The present disclosure includes methods for replacing the refrigerant in an R-410A heat pump system comprising:
(a) using instead of the R-410A in said heat pump system a refrigerant according to the present disclosure, including each of Refrigerants 1-7, provided that said refrigerant comprises at least about 17.5% by weight of R-1132(E); and
(b) using in said system a vapor injector economizer. Methods in accordance with this paragraph are referred to herein as Replacement Method 3C.

The present disclosure includes methods for replacing the refrigerant in an R-410A heat pump system, including each of Replacement Method 3, which uses a vapor injector economizer and a suction-line liquid line heat exchanger.

The present disclosure includes methods for replacing the refrigerant in an R-290 heat pump system, including each of Replacement Method 2, which uses a vapor injector economizer and a suction-line liquid line heat exchanger.

The present disclosure includes methods for replacing the refrigerant in an R-32 heat pump system, including each of Replacement Method 1, which uses a vapor injector economizer and a suction-line liquid line heat exchanger.

Applicants have found that substantial advantage can be achieved in connection with heat transfer methods, including Heat Transfer Methods 1-2 and Heating Methods 1 and 2, in which a refrigerant of the present disclosure including each of Refrigerants 1-7, is used to absorb or transfer heat from/to a fluid. In such cases, the fluid may be a secondary coolant (for example: water, glycol, water/glycol mixtures, brine, etc.), such as would occur in the case of the refrigerant being used in systems and methods which make use of indoor radiators or under floor piping for heating or cooling.

Thus, in general, the present methods, including Heat Transfer Methods 1-2 and Heating Methods 1 and 2, utilize apparatus and/or processes which permit the refrigerant including each of Refrigerants 1-7, or heat transfer composition of the present disclosure, including each of the above disclosed heat transfer compositions which include any or Refrigerants 1-7, to absorb heat and also apparatus and/or processes which then remove the absorbed heat from the refrigerant.

It will be appreciated that the condenser which is used to transfer heat to and from the building may include conduits and the like, such as for example brazed plate heat exchanger or coiled tubes on the external walls of a secondary fluid tank, through which the refrigerant flows, while such conduits are being exposed to the fluid (directly or indirectly) to be heated or cooled. In this way, heat flows to/from the fluid (e.g. air) being heated/cooled through the metal or other heat conductive material of the conduit and from/into the refrigerants of the present disclosure.

The heat pump methods encompassed by the present disclosure and their preferred operation are discussed below.

### Heat Pump Methods

The present disclosure relates to a heat pump methods, including Heat Transfer Methods 1-2 and Heating Methods 1 and 2, comprising a refrigerant of the disclosure including each of Refrigerants 1-7, or a heat transfer composition comprising a refrigerant of the present disclosure, including each of Refrigerants 1-7.

The present disclosure also provides a method of heating a fluid or body using a heat pump, the method comprising the steps of (a) condensing a refrigerant composition of the disclosure, including each Refrigerants 1-7, in the vicinity of the fluid or body to be heated, and (b) evaporating the refrigerant. Examples of heat pumps of the present invention, including Heat Transfer Systems 1-2, include heat pump tumble driers, reversible heat pumps, high temperature heat pumps, air-to-air heat pumps, and air-to-water heat pumps.

Air-to-water heat pumps, including Heat Transfer Systems 1-2, can be defined as a heat pump system with air as a heat source and water as its heat sink. The evaporator exchanges heat with the external air generating refrigerant vapor. The vapor is compressed by the compressor to generate higher pressure vapor with temperatures above the heat sink. The condenser condenses the refrigerant fluids rejecting heat to the water and generating refrigerant liquid. The liquid is expanded to a lower pressure with a lower temperature than the external air to be evaporated. The air-to-water heat pumps, including Heat Transfer Systems 1-2, can be split or monoblock. Split systems have a part of the system outside the building, usually the evaporator, expansion device and compressor, while the condenser is inside the building. Monoblock systems are self contained system outside the building that heat the water which is then pumped inside the building.

Air-to-water heat pumps, including Heat Transfer Systems 1-2, can be used to provide heat for floor heating which requires water or glycol temperatures of 30° C. to 35° C., or provide heat to radiator which require water or glycol temperatures of 45° C. to 65° C.

Air-to-water heat pumps, Heat Transfer Systems 1-2, can be reversible to provide also cooling for the building. This is achieved by using a reversible 4-way valve that allows the flow to be reversed changing the roles of the heat exchangers.

### Air Conditioning Methods

The present disclosure relates to an air conditioning system, Heat Transfer Systems 1-2, comprising a refrigerant of the present invention, including each of Refrigerants 1-7, or a heat transfer composition comprising a refrigerant of the present disclosure, including each of Refrigerants 1-7. The present disclosure also provides a method of air conditioning, Heat Transfer Systems 1-2, using an air conditioning system, said method comprising the steps of (a) evaporating a refrigerant composition of the disclosure, including each of Refrigerants 1-7, in the vicinity of a fluid of body to be cooled, and (b) condensing said refrigerant. Air may be conditioned either directly or indirectly by the refrigerants, including each of Refrigerants 1-7, of the disclosure. In preferred embodiments, air conditioning in the present disclosure can be achieved by reversal of the heat pump systems. Examples of air conditioning systems include chillers, residential, industrial, commercial.

It will be appreciated that any of the above refrigeration, air conditioning or heat pump systems, including each of Heat Transfer Systems 1-2, using the refrigerant of the disclosure or heat transfer compositions comprising a refrigerant of the present disclosure, including each of Refrigerants 1-7, may comprise a suction line/liquid line heat exchanger (SL-LL HX).

### EXAMPLES

### Comparative Example 1: Use of R-410A for Residential Air-to-Water Heat Pump Hydronic System with Radiators—Heating Mode

A residential air-to-water heat pump hydronic system having a basic structure as illustrated in FIG. 1 is provided and is used to supply hot water at a temperature of about 50° C. to about 55° C. to radiators located in an indoor living space in the winter. The hydronic system usually has a round tube plate fin or microchannel evaporator to exchange heat with ambient air, a reciprocating or rotary compressor, a brazed plate condenser to heat the water, and a thermostatic or electronic expansion valve. The refrigerant evaporating temperature is in the range of −30 to 10° C., while the condensing temperature is in the range of 55 to 90° C. The system is operated under the following conditions using R-410A, which has a GWP of 2088, as the refrigerant:
1. Refrigerant condensing (dew point) temperature=60° C.
2. Indoor water inlet temperature=47° C.
3. Condenser sub-cooling=5.5° C.
4. Refrigerant evaporating temperature=−2° C.
5. Outdoor ambient temperature=7° C.
6. Evaporator Superheat=5.5° C.
7. Isentropic Efficiency=70%
8. Volumetric Efficiency=100%
   The system performance under these conditions is used as the baseline for Comparative Example 2, Comparative Example 3, and for Examples 1-3, each with respect to values of heating capacity, compressor pressure ratio and discharge pressure, that is, the values achieved in this example are set as a baseline of 100% for comparison purposes, and discharge temperature difference is reported relative the discharge temperature of this example. However, this system is highly disadvantageous due to the very high GWP value of the R-410A refrigerant.

### Comparative Example 2: Use of Propane for Residential Air-to-Water Heat Pump Hydronic System with Radiators—Heating Mode

Comparative Example 1 is repeated except that the refrigerant used is propane, which has a GWP of near zero. The system performance using propane is used as the base-line for Examples 1-3 with respect to the value of heating efficiency, that is, the efficiency value achieved in this example is set as a baseline of 100% for comparison purposes. The results are reported, together with the results for Comparative Example C1, in Table ExC2 below:

TABLE ExC2

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R-410A | 100% | 94% | 100% | 100% | 0 | 0.06 |
| R-290 | 58% | 100% | 93% | 55% | 22.24 | 0 |

As can be seen from the table above, while propane has an advantageously low GWP, its use to replace R-410A is highly disadvantageous from a performance perspective, including having a heating capacity that is only 58% of that produced with R410A as the refrigerant, as well as an unacceptably high discharge temperature difference of over 22° C.

### Comparative Examples 3A and 3B: Use of Refrigerant Comprising R-32, R-1132(E) and R-1234yf for Residential Air-to-Water Heat Pump Hydronic System with Radiators and Using Vapor Injection and Economizer—Heating Mode

Comparative Example 1 is repeated except that the refrigerants identified in Table ExC3-1 below is used and the system is modified with a vapor injection/economizer with 60% effectiveness and outlet superheat of 5.5° C. as illustrated in FIG. 12 is used in the system, which produces the results reported in Table ExC3-2, together with the results from Comparative Examples 1 and 2 for comparison:

TABLE ExC3-1

| Refrigerant | R32 | R1132(E) | R1234yf | |
|---|---|---|---|---|
| Designation | (wt. %) | (wt. %) | (wt. %) | GWP |
| ExC3A | 22.5 | 22.5 | 55 | 156 |
| ExC3B | 22.5 | 20 | 57.5 | 156 |

TABLE ExC3-2

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R-410A | 100% | 94% | 100% | 100% | 0 | 0.06 |
| R-290 | 58% | 100% | 93% | 55% | 22.24 | 0 |
| ExC3A | 93% | 103% | 102% | 78% | 9.41 | 5.21 |
| ExC3B | 91% | 103% | 103% | 77% | 10.24 | 5.31 |

As can be seen from the tables above, the use of the refrigerants ExC3A and ExC3B each have disadvantages and do not satisfy the preferred aspects of the present invention at least in terms of having: (1) GWP values that are not 150 or less; and (2) heating capacities that are not at least 95% of R410A. These deficiencies make use of these compositions in this heat pump application less than is fully desirable.

### Examples 1A, 1B and 1C: Use of Refrigerant Comprising R-32, R-1132(E) and R-1234yf for Residential Air-to-Water Heat Pump Hydronic System with Radiators and Using Vapor Injection and Economizer as Replacement for R410A—Heating Mode

Comparative Example 1 is repeated except that the refrigerants identified in Table Ex1A are used and the system is modified with a vapor injection/economizer with 60% effectiveness and outlet superheat of 5.5° C. as illustrated in FIG. 12, which produces the results reported in Table Ex1B, together with the results from Comparative Examples 1 and 2 for comparison:

TABLE Ex1A

| Refrigerant | R32 | R1132(E) | R1234yf | |
|---|---|---|---|---|
| Designation | (wt. %) | (wt. %) | (wt. %) | GWP |
| Ex1A | 21.1% | 70.0% | 8.96% | 149.8 |
| Ex1B | 21.2% | 60.0% | 18.8% | 149.9 |
| Ex1C | 21.4% | 40.0% | 38.6% | 150.0 |

TABLE Ex1B

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R-410A | 100% | 94% | 100% | 100% | 0 | 0.06 |
| R-290 | 58% | 100% | 93% | 55% | 22.24 | 0 |
| Ex1A | 103% | 102% | 100% | 85% | 5.03 | 4.48 |
| Ex1B | 101% | 102% | 101% | 83% | 5.94 | 4.67 |
| Ex1C | 97% | 102% | 101% | 81% | 7.5 | 4.95 |

It will be noted that refrigerants Ex1A through Ex1 C are Refrigerants 4A1, 4A2 and 4A3 in Table 2 above and will be referred to hereinafter in these examples as such for the purposes of convenience. The use of Refrigerants 4A1-4A3 in this example illustrates the ability of the refrigerants and heat transfer compositions of the present invention to achieve at once the following combination of desirable results:
(1) GWP of 150 or less;
(2) Heating capacity of 95% or greater relative to R-410A
(3) Heating efficiency of greater than 100% relative to R-290 Evaporator glide of less than 5° C.
(4) Discharge Temperature difference of less than 8° C.
   The ability to achieve this combination of highly desirable results is unexpected and very difficult to achieve. It will be noted that refrigerant Ex1A (4A1) produces the most desirable results from the standpoint of having the highest capacity while at the same time having the lowest glide and lowest temperature difference among these three refrigerants of the present invention.

### Example 2A: Use of Refrigerant Comprising R-32, R-1132(E) and R-1234yf for Residential Air-to-Water Heat Pump Hydronic System with Radiators and Using Vapor Injection and Economize as Replacement for R410A—Heating Mode

Comparative Example 1 is repeated except that the refrigerant identified in Table Ex2A is used and the system is modified with a vapor injection/economizer with 60% effectiveness and outlet superheat of 5.5° C. as illustrated in FIG. 12 is used in the system, which produces the results reported in Table Ex2B, together with the results from Comparative Examples 1 and 2 for comparison:

TABLE 2B

| Refrigerant | R32 | R1132(E) | R1234yf | |
|---|---|---|---|---|
| Designation | (wt. %) | (wt. %) | (wt. %) | GWP |
| Ex2A | 22.5% | 25.0% | 52.5% | 156 |

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R-410A | 100% | 94% | 100% | 100% | 0 | 0.06 |
| R-290 | 58% | 100% | 93% | 55% | 22.24 | 0 |
| Ex2A | 95% | 102% | 102% | 79% | 8.6 | 5.11 |

The refrigerant Ex2A illustrates the ability of certain refrigerants and heat transfer compositions of the present invention to achieve at once the following combination of desirable results:
(1) Heating capacity of 95% or greater relative to R-410A
(2) Heating efficiency of greater than 100% relative to R-410A
(3) Evaporator glide of less than 5.5° C.
(4) Discharge Temperature difference of less than 9° C.
   Thus, while this refrigerant is able to achieve a capacity 95%, this value is nevertheless than the capacity results for Ex1A-Ex1C. Moreover, the GWP values, the evaporator glide and the discharge temperature difference for refrigerants Ex1A-Ex1C are all superior to the results for Ex2A.

### Comparative Example 4A and 4B: Replacement for R-22 and R407C for Residential Air-to-Water Heat Pump Hydronic System with Radiators and Using Vapor Injection and Economizer—Heating Mode

Comparative Example 1, is repeated, except the refrigerants R-22 and R-407C are used for the residential air-to-water heat pump hydronic system having a basic structure as illustrated in FIG. 1 is used to supply hot water (50-55° C.) to buildings for radiators or similar applications in the winter.

Table C4A shows the thermodynamic performance of this residential air-to-water heat pump hydronic system using the R-22 system as the baseline for all parameters.

TABLE C4

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R-22 | 100% | 100% | 100% | 100% | 0 | 0 |
| R-407C | 96% | 96% | 111% | 109% | 12.31 | 3.78 |

The system performance under these conditions is used as the base-line for Example 4. However, these systems are highly disadvantageous due to the very high GWP value of R-22 and R407C refrigerants being 1810 and 1774, respectively.

### Examples 4A, 4B, 4C and 4D: Use of Refrigerant Comprising R-32, R-1132(E) and R-1234yf for Residential Air-to-Water Heat Pump Hydronic System with Radiators and Using Vapor Injection and Economizer as Replacement for R-22 and R407C—Heating Mode

Comparative Example 4 is repeated except that the refrigerants identified in Table Ex4A (i.e., Refrigerants 4A1, 4A2, 4A3 and 4A4 in Table 2 above) and the system is modified with a vapor injection/economizer with 60% effectiveness and outlet superheat of 5.5° C. as illustrated in FIG. 12, which produces the results reported in Table Ex4B, together with the results from Comparative Examples 4A and 4B for comparison:

TABLE Ex4A

| Refrigerant | R32 | R1132(E) | R1234yf | |
|---|---|---|---|---|
| Designation | (wt. %) | (wt. %) | (wt. %) | GWP |
| Ex4A (4A1) | 21.1% | 70.0% | 8.96% | 149.8 |
| Ex4B (4A2) | 21.2% | 60.0% | 18.8% | 149.9 |
| Ex4C (4A3) | 21.4% | 40.0% | 38.6% | 150.0 |
| Ex4D (4A4) | 21.5 | 38.0% | 40.5% | 149.5 |

TABLE 4B

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R-22 | 100% | 100% | 100% | 100% | 0 | 0 |
| R-407C | 96% | 96% | 111% | 109% | 12.31 | 3.78 |
| Ex4A (4A1) | 147% | 99% | 99% | 134% | 10.26 | 4.48 |
| Ex4B (4A2) | 143% | 99% | 99% | 132% | 11.17 | 4.67 |
| Ex4C (4A3) | 138% | 100% | 100% | 128% | 12.73 | 4.95 |
| Ex4D (4A4) | 135% | 100% | 100% | 125% | 13.75 | 5.11 |

The refrigerants Ex4A through Ex4C illustrate the ability of the refrigerants and heat transfer compositions of the present invention to achieve at once the following combination of desirable results as a replacement for R-22 and R-407C:
(1) GWP of 150 or less;
(2) Heating capacity of 135% or greater relative to R-22
(3) Heating efficiency of greater than 99% relative to R-22
(4) Evaporator glide of less than 5° C.
(5) Discharge Temperature difference of less than 13° C.
   Refrigerant Ex4D is also able to achieve all of the results indicated above, but with an evaporator glide just slightly above 5° C. The ability to achieve this combination of highly desirable results is unexpected and very difficult to achieve. It will be noted that refrigerant Ex4A produces the most desirable results from the standpoint of having the highest capacity while at the same time having the lowest glide and lowest temperature difference among these three refrigerants of the present invention. It is noted, however, that for each of Ex4A-4D, while a 99-100% pressure ratio is achieved compared to R-22, the values of 125%-134% discharge pressures mean that while these refrigerants in general can be used to replace R-22 and R-407C, they generally will not be used as a drop-in replacement for these refrigerants.

### Comparative Examples 5A and 5B: Use of R-410A and R-290 for Residential Air-to-Water Heat Pump Hydronic System with Radiators and Using Suction Line-Liquid Line Heat Exchanger and Receiver—Heating Mode

A residential air-to-water heat pump hydronic system having a basic structure as illustrated in FIGS. 1 and 13 is provided and is used to supply hot water at a temperature of about 50° C. to about 55° C. to radiators located in an indoor living space in the winter. The hydronic system usually has a round tube plate fin or microchannel evaporator to exchange heat with ambient air, a reciprocating or rotary compressor, a brazed plate condenser to heat the water, a liquid receiver, and a thermostatic or electronic expansion valve and a suction line-liquid line heat exchanger. The refrigerant evaporating temperature is in the range of −30 to 10° C., while the condensing temperature is in the range of 55 to 90° C. The following operating conditions were used for the heat pump hydronic system:
1. Refrigerant condensing (dew point) temperature=60° C.
2. Indoor water inlet temperature=47° C.
3. Condenser sub-cooling=5.5° C.
4. Refrigerant evaporating temperature=−2° C.
5. Outdoor ambient temperature=7° C.
6. Compressor suction superheat=5.5° C.
7. Isentropic Efficiency=70%
8. Volumetric Efficiency=100%
9. Suction line liquid line heat exchanger effectiveness=35%
   Table C5 shows the thermodynamic performance of the residential air-to-water heat pump hydronic system with radiators using as a baseline R-290 for system efficiency, and R-410A as the base line for all other parameters.

TABLE C5

| | | | | | Discharge | |
|---|---|---|---|---|---|---|
| | Heating | Heating | | Discharge | Temperature | Evaporator |
| | Capacity | Efficiency | Pressure | Pressure | Difference | Glide |
| Refrigerant | (vs R410A) | (vs R290) | ratio | [kPa] | [° C.] | [° C.] |
| R410A | 100% | 94% | 100% | 100% | 00.00 | 0.06 |
| R290 | 58% | 100% | 93% | 55% | −22.24 | 0.00 |

### Examples 5A, 5B, 5C and 5D: Use of Refrigerant Comprising R-32, R-1132(E) and R-1234yf for Residential Air-to-Water Heat Pump Hydronic System with Radiators and Using Suction Line/Liquid Line Heat Exchanger—Heating Mode

Comparative Example 5 is repeated except that the refrigerants identified in Table Ex5A are used and the system is modified with a suction-line/liquid-line heat exchanger 30 with 35% effectiveness and receiver 60, as illustrated in FIG. 13, which produces the results reported in Table Ex5B, together with the results from Comparative Example 5 for comparison:

TABLE 5A

| Refrigerant | R32 | R1132(E) | R1234yf | |
|---|---|---|---|---|
| Designation | (wt. %) | (wt. %) | (wt. %) | GWP |
| Ex5A (4A1) | 21.1% | 70.0% | 8.96% | 149.8 |
| Ex5B (4A2) | 21.2% | 60.0% | 18.8% | 149.9 |
| Ex5C (4A3) | 21.4% | 40.0% | 38.6% | 150.0 |
| Ex5D (4A4) | 21.5 | 38.0% | 40.5% | 149.5 |

TABLE 5B

| | | | | | Discharge | |
|---|---|---|---|---|---|---|
| | Heating | Heating | | Discharge | Temperature | Evaporator |
| | Capacity | Efficiency | Pressure | Pressure | Difference | Glide |
| Refrigerant | (vs. R410A) | (vs. R290) | ratio | [kPa] | [° C.] | [° C.] |
| R410A | 100% | 94% | 100% | 100% | 00.00 | 0.06 |
| R290 | 58% | 100% | 93% | 55% | −22.24 | 0.00 |
| Ex5A | 92% | 114% | 76% | 70% | −16.34 | 2.76 |
| (R4A1) | | | | | | |
| Ex5B | 89% | 110% | 79% | 72% | −14.95 | 2.89 |
| (R4A2) | | | | | | |
| Ex5C | 85% | 106% | 82% | 72% | −14.05 | 3.11 |
| (R4A3) | | | | | | |
| Ex5D | 82 | 102 | 86 | 74 | −12.58 | 3.2 |
| (R4A4) | | | | | | |

The refrigerants Ex5A through Ex5D illustrate the ability of the refrigerants and heat transfer compositions of the present invention to achieve at once the following combination of desirable results:
(1) GWP of 150 or less;
(2) Heating capacity of 82% or greater relative to R-410A
(3) Heating efficiency of greater than 102% relative to R-290
(4) Evaporator glide of less than 3.5° C.
(5) Discharge Temperature difference of less than 15° C.
   The ability to achieve this combination of highly desirable results is unexpected and difficult to achieve. It will be noted that refrigerant Ex5A (R4A1) produces the most desirable results from the standpoint of having the highest capacity while at the same time having the lowest glide among these four refrigerants of the present invention. It is noted, however, that for each of Ex5A-5D, the values of 70%-74% discharge pressures mean that while these refrigerants in general can be used to replace R-22 and R-407C, they generally will not be used as a drop-in replacement for these refrigerants. In addition, it is noted that for each of Ex5A-5D the discharge temperatures are lower than R410A, which indicates good compressor reliability and relatively low risk of oil breakdown or motor burn-out. These compositions in this operation show an average evaporator glide of 3.5° C. or less, which indicates that a redesigned evaporator may be needed, but performance in the condenser should benefit from the glide matching the water temperature rise. It also shows how the suction line-liquid line heat exchanger can lead to decreased glide and thus make these blends more viable even under frosting conditions.

### Comparative Example 6: Use of R-22 and R-407C for Residential Air-to-Water Heat Pump Hydronic System with Radiators—Heating Mode

A residential air-to-water heat pump hydronic system having a basic structure as illustrated in FIG. 1, except modified to include a liquid line/suction line heat exchanger (generally as illustrated in FIG. 13), is provided and is used to supply hot water at a temperature of about 50° C. to about 55° C. to radiators located in an indoor living space in the winter. The hydronic system usually has a round tube plate fin or microchannel evaporator to exchange heat with ambient air, a reciprocating or rotary compressor, a brazed plate condenser to heat the water, and a thermostatic or electronic expansion valve and a suction line-liquid line heat exchanger. The refrigerant evaporating temperature is in the range of −30 to 10° C., while the condensing temperature is in the range of 55 to 90° C. This system also utilizes a flooded evaporator. The following operating conditions were used for the heat pump hydronic system:
1. Refrigerant condensing (dew point) temperature=60° C.
2. Indoor water inlet temperature=47° C.
3. Condenser sub-cooling=5.5° C.
4. Refrigerant evaporating temperature=−2° C.
5. Outdoor ambient temperature=7° C.
6. Compressor suction superheat=5.5° C.
7. Isentropic Efficiency=70%
8. Volumetric Efficiency=100%
9. Suction line liquid line heat exchanger effectiveness=35%
   Table C6 shows the thermodynamic performance of the residential air-to-water heat pump hydronic system with radiators using suction line liquid line heat exchanger and receiver as described above, using as a baseline R-22 for all system parameters.

TABLE C6

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R22 | 100% | 100% | 100% | 100% | 0.00 | 0.00 |
| R407C | 96% | 96% | 111% | 109% | −12.31 | 3.78 |

### Examples 6A, 6B, 6C and 6D: Use of Refrigerant Comprising R-32, R-1132(E) and R-1234yf for Residential Air-to-Water Heat Pump Hydronic System with Radiators and Using Suction Line/Liquid Line Heat Exchanger—Heating Mode

Comparative Example 6 is repeated except that the refrigerants identified in Table Ex6A are used and the system is modified with a suction-line/liquid-line heat exchanger 30 with 35% effectiveness and receiver 60, as illustrated in FIG. 13 which produces the results reported in Table Ex6B, together with the results from Comparative Example 6 for comparison:

TABLE Ex6A

| Refrigerant | R32 | R1132(E) | R1234yf | |
|---|---|---|---|---|
| Designation | (wt. %) | (wt. %) | (wt. %) | GWP |
| Ex6A (4A1) | 21.1% | 70.0% | 8.96% | 149.8 |
| Ex6B (4A2) | 21.2% | 60.0% | 18.8% | 149.9 |
| Ex6C (4A3) | 21.4% | 40.0% | 38.6% | 150.0 |
| Ex6D (4A4) | 21.5 | 38.0% | 40.5% | 149.5 |

TABLE Ex6B

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R22 | 100% | 100% | 100% | 100% | 0.00 | 0.00 |
| R407C | 96% | 96% | 111% | 109% | −12.31 | 3.78 |
| Ex6A | 131% | 111% | 74% | 111% | −21.57 | 2.76 |
| Ex6B | 127% | 107% | 77% | 113% | −20.18 | 2.89 |
| Ex6C | 121% | 103% | 81% | 114% | −19.28 | 3.11 |
| Ex6D | 117 | 100 | 85 | 117 | −17.81 | 3.20 |

The refrigerants Ex6A through Ex6D illustrate the ability of the refrigerants and heat transfer compositions of the present invention to achieve at once the following combination of desirable results:
(1) GWP of 150 or less;
(2) Heating capacity of 121% or greater relative to R-22
(3) Heating efficiency of 103% or greater relative to R-22
(4) Evaporator glide of less than 3.5° C.
(5) Discharge Temperature difference of less than 22° C.

The ability to achieve this combination of highly desirable results is unexpected and difficult to achieve. It will be noted that refrigerant Ex6A (R4A1) produces the most desirable results from the standpoint of having the highest capacity while at the same time having the lowest glide among these three refrigerants of the present invention. It is noted, however, that for each of Ex6A-6D, the values of 111%-117% discharge pressures mean that while these refrigerants in general can be used to replace R-22 and R-407C, they generally will not be used as a drop-in replacement for these refrigerants. In addition, it is noted that for each of Ex6A-6D the discharge temperatures are lower than R22, which indicates good compressor reliability and relatively low risk of oil breakdown or motor burn-out. These compositions in this operation show an average evaporator glide of 3.5° C. or less, which indicates that a redesigned evaporator may be needed, but performance in the condenser should benefit from the glide matching the water temperature rise. It also shows how the suction line-liquid line heat exchanger can lead to decreased glide and thus make these blends more viable even under frosting conditions. The glide values are also lower than R-407C which is considered by the industry as acceptable for heating and air conditioning use.

### Comparative Example 7: Use of R-410A and R-290 for Residential Air-to-Water Heat Pump Hydronic System with Under Floor Heating—Heating Mode

A residential air-to-water heat pump hydronic system having a basic structure as illustrated in FIG. 1 is provided and is used to supply hot water at a temperature of about 35° C. to buildings for floor heating in the winter. The hydronic system usually has a round tube plate fin or microchannel evaporator to exchange heat with ambient air, a reciprocating or rotary compressor, a brazed plate condenser to heat the water, and a thermal or electronic expansion valve. The refrigerant evaporating temperature is in the range of −30 to 10° C., while the condensing temperature is in the range of 35 to 90° C. The following operating conditions were used for the heat pump hydronic system:
1. Refrigerant condensing temperature=42° C.
2. Indoor inlet water temperature=30° C.
3. Condenser sub-cooling=5.5° C.
4. Evaporating temperature=−2° C., Corresponding outdoor ambient temperature=7° C.
5. Evaporator Superheat=5.5° C.
6. Isentropic Efficiency=70%
7. Volumetric Efficiency=100%
   Table C7 shows the thermodynamic performance of the residential air-to-water heat pump hydronic system using R290 refrigerant operation as the baseline for system efficiency and R410A refrigerant operation as the baseline for all other parameters.

TABLE C7

| | | | | | Discharge | |
|---|---|---|---|---|---|---|
| | Heating | Heating | | Discharge | Temperature | Evaporator |
| | Capacity | Efficiency | Pressure | Pressure | Difference | Glide |
| Refrigerant | (vs. R410A) | (vs. R290) | ratio | [kPa] | [° C.] | [° C.] |
| R410A | 100% | 96% | 100% | 100% | 0 | 0.08 |
| R290 | 58% | 100% | 95% | 56% | 15.64 | 0 |

While the system operating with R-410A has good performance, use of this system is highly undesirable because R-410A has a very high GWP value of 2088. Furthermore, while propane has an advantageously low GWP, its use to replace R-410A is highly disadvantageous from a performance perspective, including having a heating capacity that is only 58% of that produced with R410A as the refrigerant, as well as an unacceptably high positive discharge temperature difference of over 15° C.

### Examples 7A, 7B, 7C and 7D: Use of Refrigerant Comprising R-32, R-1132(E) and R-1234yf for Residential Air-to-Water Heat Pump Hydronic System with Under Floor Heating Using Vapor Injection and Economizer—Heating Mode

Comparative Example 7 is repeated except that the refrigerants identified in Table Ex7A and the system is modified with a vapor injection/economizer with 60% effectiveness and outlet superheat of 5.5° C. as illustrated in FIG. 12 is used in the system, which produces the results reported in Table Ex7B, together with the results from Comparative Example 7 for comparison:

TABLE Ex7A

| Refrigerant | R32 | R1132(E) | R1234yf | |
|---|---|---|---|---|
| Designation | (wt. %) | (wt. %) | (wt. %) | GWP |
| Ex7A (4A1) | 21.1% | 70.0% | 8.96% | 149.8 |
| Ex7B (4A2) | 21.2% | 60.0% | 18.8% | 149.9 |
| Ex7C (4A3) | 21.4% | 40.0% | 38.6% | 150.0 |
| Ex7D (4A4) | 21.5 | 38.0% | 40.5% | 149.5 |

TABLE Ex7B

| | | | | | Discharge | |
|---|---|---|---|---|---|---|
| | Heating | Heating | | Discharge | Temperature | Evaporator |
| | Capacity | Efficiency | Pressure | Pressure | Difference | Glide |
| Refrigerant | (vs R410A) | (vs R290) | ratio | [kPa] | [° C.] | [° C.] |
| R410A | 100% | 96% | 100% | 100% | 0 | 0.08 |
| R290 | 58% | 100% | 95% | 56% | 15.64 | 0 |
| Ex7A (4A1) | 95% | 100% | 100% | 85% | −1.77 | 4.88 |
| Ex7B (4A2) | 93% | 100% | 100% | 84% | −2.46 | 5.1 |
| Ex7C (4A3) | 90% | 101% | 101% | 81% | −3.63 | 5.43 |
| Ex7D (4A4) | 88 | 101 | 101 | 80 | −4.4 | 5.62 |

The refrigerants Ex7A through Ex7C illustrate the ability of the refrigerants and heat transfer compositions of the present invention to achieve at once the following combination of desirable results:
(1) GWP of 150 or less;
(2) Heating capacity of 88% or greater relative to R-410A
(3) Heating efficiency of 100% or greater relative to R290
(4) Evaporator glide of less than 5.7° C.
(5) Discharge Temperature difference of less than 5° C.

The ability to achieve this combination of highly desirable results is unexpected and very difficult to achieve. It will be noted that refrigerant Ex7A (R4A1) produces the most desirable results from the standpoint of having the highest capacity while at the same time having the lowest glide and lowest temperature difference (indicates good compressor reliability and there is no risk of oil breakdown or motor burn-out). Moreover, the evaporator glides for the present refrigerants in this system indicates that a redesigned evaporator may be needed, but performance in the condenser should benefit from the glide matching the water temperature rise.

### Comparative Example 8: Use of R-407C and R-22 for Residential Air-to-Water Heat Pump Hydronic System with Under Floor Heating—Heating Mode

A residential air-to-water heat pump hydronic system having a basic structure as illustrated in FIG. 1 is provided and is used to supply hot water at a temperature of about 35° C. to buildings for floor heating in the winter. The hydronic system usually has a round tube plate fin or microchannel evaporator to exchange heat with ambient air, a reciprocating or rotary compressor, a brazed plate condenser to heat the water, and a thermal or electronic expansion valve. The refrigerant evaporating temperature is in the range of −30 to 10° C., while the condensing temperature is in the range of 35 to 90° C. The following operating conditions were used for the heat pump hydronic system:
1. Refrigerant condensing temperature=42° C.
2. Indoor inlet water temperature=30° C.
3. Condenser sub-cooling=5.5° C.
4. Evaporating temperature=−2° C., Corresponding outdoor ambient temperature=7° C.
5. Evaporator Superheat=5.5° C.
6. Isentropic Efficiency=70%
7. Volumetric Efficiency=100%
   Table C8 shows the thermodynamic performance of the residential air-to-water heat pump hydronic system using R407C refrigerant operation as the baseline for system efficiency and R22 refrigerant operation as the baseline for all other parameters.

TABLE C8

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R-22 | 100% | 100% | 100% | 100% | 0 | 0 |
| R407C | 101% | 98% | 107% | 107% | 8.48 | 4.67 |

While the system operating with R-22 has good performance, use of this system is highly undesirable because R-22 has a very high GWP value of 1810. Likewise, R-407C has a high GWP of 1774.

### Examples 8A, 8B, 8C and 8D: Use of Refrigerant Comprising R-32, R-1132(E) and R-1234yf for Residential Air-to-Water Heat Pump Hydronic System with Under Floor Heating Using Vapor Injection and Economizer—Heating Mode

Comparative Example 8 is repeated except that the refrigerants identified in Table Ex8A and the system is modified with a vapor injection/economizer with 60% effectiveness and outlet superheat of 5.5° C. as illustrated in FIG. 12 is used in the system, which produces the results reported in Table Ex8B, together with the results from Comparative Example 8 for comparison:

TABLE 8A

| Refrigerant | R32 | R1132(E) | R1234yf | |
|---|---|---|---|---|
| Designation | (wt. %) | (wt. %) | (wt. %) | GWP |
| Ex8A (4A1) | 21.1% | 70.0% | 8.96% | 149.8 |
| Ex8B (4A2) | 21.2% | 60.0% | 18.8% | 149.9 |
| Ex8C (4A3) | 21.4% | 40.0% | 38.6% | 150.0 |
| Ex8D (4A4) | 21.5 | 38.0% | 40.5% | 149.5 |

TABLE 8B

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R-22 | 100% | 100% | 100% | 100% | 0 | 0 |
| R-407C | 101% | 98% | 107% | 107% | 8.48 | 4.67 |
| Ex8A | 141% | 99% | 98% | 135% | 2.71 | 4.88 |
| Ex8B | 138% | 100% | 99% | 132% | 2.02 | 5.1 |
| Ex8C | 133% | 100% | 99% | 128% | 0.85 | 5.43 |
| Ex8D | 131 | 100 | 99 | 126 | 0.08 | 5.62 |

The refrigerants Ex8A through Ex8D illustrate the ability of the refrigerants and heat transfer compositions of the present invention to achieve at once the following combination of desirable results:
(1) GWP of 150 or less;
(2) Heating capacity of 130% or greater relative to R-22
(3) Heating efficiency of 99% or greater relative to R-407C
(4) Evaporator glide of less than 5.7° C.
(5) Discharge Temperature difference of less than 3° C.
   The ability to achieve this combination of highly desirable results is unexpected and very difficult to achieve. It will be noted that refrigerant Ex8A produces the most desirable results from the standpoint of having the highest capacity while at the same time having the lowest glide and lowest temperature difference, which indicates good compressor reliability and no risk of oil breakdown or motor burn-out. Moreover, the evaporator glides for the present refrigerants in this system indicates that a redesigned evaporator may be needed, but performance in the condenser should benefit from the glide matching the water temperature rise.

### Comparative Example 9: Use of R-410A and R-290 for Residential Air-to-Water Heat Pump Hydronic System with Under Floor Heating and Using a—Heating Mode

A residential air-to-water heat pump hydronic system having a basic structure as illustrated in FIG. 1 is provided and is used to supply hot water at a temperature of about 35° C. to buildings for floor heating in the winter. The hydronic system usually has a round tube plate fin or microchannel evaporator to exchange heat with ambient air, a reciprocating or rotary compressor, a brazed plate condenser to heat the water, and a thermostatic or electronic expansion. The refrigerant evaporating temperature is in the range of −30 to 10° C., while the condensing temperature is in the range of 35 to 90° C.

The following operating conditions were used for the heat pump hydronic system:
1. Refrigerant condensing (dew point) temperature=42° C.
2. Indoor water inlet temperature=30° C.
3. Condenser sub-cooling=5.5° C.
4. Refrigerant evaporating temperature=−2° C.
5. Outdoor ambient temperature=7° C.
6. Compressor suction superheat=5.5° C.
7. Isentropic Efficiency=70%
8. Volumetric Efficiency=100%
   Table C9 shows the thermodynamic performance of the residential air-to-water heat pump hydronic system with under floor heat as described above, using R-290 refrigerant as the baseline for system efficiency operation and using R-410A as the base line for all other system parameters.

TABLE C9

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R410A | 100% | 96% | 100% | 100% | 0 | 0.08 |
| R290 | 58% | 100% | 95% | 56% | −15.64 | 0 |

### Examples 9A, 9B, 9C and 9D: Use of Refrigerant Comprising R-32, R-1132(E) and R-1234yf for for Residential Air-to-Water Heat Pump Hydronic System with Under Floor Heating and Using a Receiver and Suction Line-Liquid Line Heat Exchanger—Heating Mode

Comparative Example 9 is repeated except that the refrigerants identified in Table Ex9A are used with a system modified with a suction-line/liquid-line heat exchanger 30 with effectiveness of 35% and receiver 60 are used, as illustrated in FIG. 13, which produces the results reported in Table Ex9B, together with the results from Comparative Example 9 for comparison. The proposed refrigerants benefit from the use of a suction line liquid line heat exchanger and a receiver by exploiting the glide to raise the evaporation temperature and reduce the condensation temperature. This is achieved by operating with a flooded evaporator and using the high-quality two-phase refrigerant at its outlet to cool the liquid line.

TABLE 9A

| Refrigerant | R32 | R1132(E) | R1234yf | |
|---|---|---|---|---|
| Designation | (wt. %) | (wt. %) | (wt. %) | GWP |
| Ex9A | 21.1% | 70.0% | 8.96% | 149.8 |
| Ex9B | 21.2% | 60.0% | 18.8% | 149.9 |
| Ex9C | 21.4% | 40.0% | 38.6% | 150.0 |
| Ex9D (4A4) | 21.5 | 38.0% | 40.5% | 149.5 |

TABLE 9B

| | | | | | Discharge | |
|---|---|---|---|---|---|---|
| | Heating | Heating | | Discharge | Temperature | Evaporator |
| | Capacity | Efficiency | Pressure | Pressure | Difference | Glide |
| Refrigerant | (vs R410A) | (vs R290) | ratio | [kPa] | [° C.] | [° C.] |
| R410A | 100% | 96% | 100% | 100% | 0 | 0.08 |
| R290 | 58% | 100% | 95% | 56% | −15.64 | 0 |
| Ex9A | 91% | 130% | 73% | 67% | −16.73 | 3.35 |
| Ex9B | 88% | 122% | 77% | 69% | −14.47 | 3.51 |
| Ex9C | 85% | 115% | 81% | 71% | −12.49 | 3.80 |
| Ex9D | 83 | 109 | 86 | 73 | −10.08 | 3.95 |

The refrigerants Ex9A through Ex9D illustrate the ability of the refrigerants and heat transfer compositions of the present invention to achieve at once the following combination of desirable results:
(1) GWP of 150 or less;
(2) Heating capacity of 83% or greater relative to R-410A
(3) Heating efficiency of 109% or greater relative to R290
(4) Evaporator glide of less than 4° C.
(5) Discharge Temperature difference of less than 17° C.

The ability to achieve this combination of highly desirable results is unexpected and very difficult to achieve. It will be noted that refrigerant Ex9A produces the most desirable results from the standpoint of having the highest capacity while at the same time having the lowest glide and the lowest discharge temperatures. Since the discharge temperatures for all the tested refrigerants of the present invention are lower than for R-410A, this indicates that the compressor would operate with good reliability and no risk of oil breakdown or motor burn-out. Moreover, the present refrigerants operate with an overall performance that is better than R-290, and the presence of the suction line-liquid line heat exchanger can lead to decreased glide of the present refrigerants, thus making the present refrigerant more viable even under frosting conditions.

### Comparative Example 10: Use of R-22 and R-407C for Residential Air-to-Water Heat Pump Hydronic System with Radiators—Heating Mode

A residential air-to-water heat pump hydronic system having a basic structure as illustrated in FIG. 1 is provided and is used to supply hot water at a temperature of about 50° C. radiators located in an indoor living space in the winter. The hydronic system usually has a round tube plate fin or microchannel evaporator to exchange heat with ambient air, a reciprocating or rotary compressor, a brazed plate condenser to heat the water and a thermal or electronic expansion. The refrigerant evaporating temperature is in the range of −30 to 10° C., while the condensing temperature is in the range of 35 to 90° C.

The following operating conditions were used for the heat pump hydronic system:

1. Refrigerant condensing (dew point) temperature=42° C.

2. Indoor water inlet temperature=30° C.

3. Condenser sub-cooling=5.5° C.

4. Refrigerant evaporating temperature=−2° C.

5. Outdoor ambient temperature=7° C.

6. Compressor suction superheat=5.5° C.

7. Isentropic Efficiency=70%

8. Volumetric Efficiency=100%

Table C10 shows the thermodynamic performance of the residential air-to-water heat pump hydronic system with radiators as described above, using as a baseline R-22 for all system parameters.

TABLE C10

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R22 | 100% | 100% | 100% | 100% | 0.00 | 0.00 |
| R407C | 101% | 98% | 107% | 107% | −8.48 | 4.67 |

### Examples 10A, 10B, 10C and 10D: Use of Refrigerant Comprising R-32, R-1132(E) and R-1234yf for Residential Air-to-Water Heat Pump Hydronic System with Radiators and Using a Suction Line/Liquid Line Heat Exchanger and Receiver—Heating Mode

Comparative Example 10 is repeated except that the refrigerants identified in Table Ex10A are used with a system modified with a suction-line/liquid-line heat exchanger 30 with effectiveness of 35% and receiver 60 are used, as illustrated in FIG. 13, which produces the results reported in Table Ex10B, together with the results from Comparative Example 10 for comparison. The proposed refrigerants benefit from the use of a suction line liquid line heat exchanger and a receiver by exploiting the glide to raise the evaporation temperature and reduce the condensation temperature. This is achieved by operating with a flooded evaporator and using the high-quality two-phase refrigerant at its outlet to cool the liquid line.

TABLE 10A

| Refrigerant | R32 | R1132(E) | R1234yf | |
|---|---|---|---|---|
| Designation | (wt. %) | (wt. %) | (wt. %) | GWP |
| Ex10A | 21.1% | 70.0% | 8.96% | 149.8 |
| (R4A1) | | | | |
| Ex10B | 21.2% | 60.0% | 18.8% | 149.9 |
| (R4A2) | | | | |
| Ex10C | 21.4% | 40.0% | 38.6% | 150.0 |
| (R4A3) | | | | |
| Ex108D | 21.5 | 38.0% | 40.5% | 149.5 |
| (R4A4) | | | | |

TABLE 10B

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R22 | 100% | 100% | 100% | 100% | 0.00 | 0.00 |
| R407C | 101% | 98% | 107% | 107% | −8.48 | 4.67 |
| Ex10A | 134% | 128% | 72% | 106% | −21.21 | 3.35 |
| Ex10B | 131% | 121% | 75% | 109% | −18.95 | 3.51 |
| Ex10C | 126% | 114% | 80% | 112% | −16.97 | 3.80 |
| Ex10D | 122 | 108 | 84 | 115 | −14.56 | 3.95 |

The refrigerants Ex10A through Ex10D illustrate the ability of the refrigerants and heat transfer compositions of the present invention to achieve at once the following combination of desirable results:
(1) GWP of 150 or less;
(2) Heating capacity of 122% or greater relative to R-22
(3) Heating efficiency of 108% or greater relative to R-22
(4) Evaporator glide of less than 4° C.
(5) Discharge Temperature difference of less than 22° C.

The ability to achieve this combination of highly desirable results is unexpected and difficult to achieve. It will be noted that refrigerant Ex10A produces the most desirable results from the standpoint of having the highest capacity while at the same time having the lowest glide among these three refrigerants of the present invention. It is noted, however, that for each of Ex10A-10D, the values of 106%-115% discharge pressures mean that while these refrigerants in general can be used to replace R-22 and R-407C, they generally will not be used as a drop-in replacement for these refrigerants. In addition, it is noted that for each of Ex10A-Ex10D the discharge temperatures are lower than R22, which indicates good compressor reliability and relatively low risk of oil breakdown or motor burn-out. These compositions in this operation show an average evaporator glide of 4° C. or less, which indicates that a redesigned evaporator may be needed, but performance in the condenser should benefit from the glide matching the water temperature rise. It also shows how the suction line-liquid line heat exchanger can lead to decreased glide and thus make these blends more viable even under frosting conditions. The glide values are also lower than R-407C which is considered by the industry as acceptable for heating and air conditioning use.

### Comparative Example 11: Use of R-410A, R-290, R-22 and R-407C for Residential Air-to-Water Air Conditioning Hydronic System with Radiators and Using Vapor Injection and Economizer—Cooling Mode

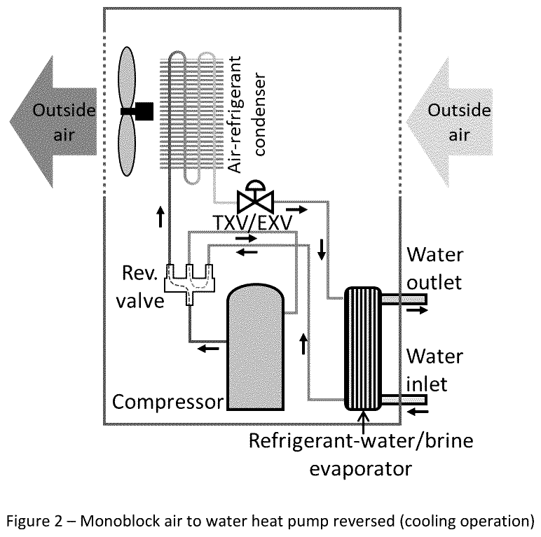

A residential air-conditioning system having a basic structure as illustrated in FIG. 2, except modified to include a vapor injection system and economizer (generally as illustrated in FIG. 12), is provided and is used to to supply cool air (about 27° C.) to an occupied building in the summer. Typical system types are split and monoblock with direct radiators or with a cooling coil and air handler. The system usually has an air-to-water or air-to-glycol evaporator, a compressor, an air-to-refrigerant condenser (outdoor coil), and an expansion valve. The evaporator is usually a brazed plate heat exchanger. The condenser is usually round tube plate fin or microchannel heat exchanger. The compressor is usually reciprocating or rotary (rolling-piston or scroll) compressor. The expansion valve is usually thermal or electronic expansion valve. The refrigerant evaporating temperature is in the range of 0 to 10° C., while the refrigerant condensing temperature is in the range of 30 to 70° C. The following operating conditions were used for the air-conditioning system:
1. Refrigerant condensing temperature=45° C.
2. Outdoor ambient temperature=35° C.
3. Condenser sub-cooling=5.5° C.
4. Refrigerant evaporating temperature=1° C.
5. Indoor water temperature=7° C.
6. Evaporator Superheat=5.5° C.
7. Isentropic Efficiency=70%
8. Volumetric Efficiency=100%
9. Economizer Outlet Superheat=5.5° C.
10. Economizer effectiveness=60%
   Table C11 shows the thermodynamic performance of this residential air-conditioning system operating in the cooling mode and using the basic system (illustrated in FIG. 2) operating with R290 as the baseline for the system efficiency and operating with R410A refrigerant as the baseline system in terms of all other parameters.

TABLE C11

| | | | | | Discharge | |
|---|---|---|---|---|---|---|
| | | | | Discharge | Temperature | Evaporator |
| | Capacity | Efficiency | Pressure | Pressure | Difference | Glide |
| Refrigerant | (vs R410A) | (vs R290) | ratio | [kPa] | [° C.] | [° C.] |
| R410A | 100% | 94% | 100% | 100% | 0.00 | 0.08 |
| R290 | 59% | 100% | 95% | 56% | −15.47 | 0.00 |
| R22 | 69% | 101% | 102% | 63% | 4.25 | 0.00 |
| R470C | 69% | 98% | 109% | 68% | −3.97 | 4.57 |

### Examples 11A, 11B, 11C and 11D: Use of Refrigerant Comprising R-32, R-1132(E) and R-1234yf for Residential Air-to-Water Air Conditioning Hydronic System with Radiators and Using Vapor Injection and Economizer—Cooling Mode

Comparative Example 11 is repeated except that the refrigerants identified in Table Ex11A are used to produce the results reported in Table Ex11B, together with the results from Comparative Example 11 for comparison:

TABLE 11A

| Refrigerant | R32 | R1132(E) | R1234yf | |
|---|---|---|---|---|
| Designation | (wt. %) | (wt. %) | (wt. %) | GWP |
| Ex11A | 21.1% | 70.0% | 8.96% | 149.8 |
| (R4A1) | | | | |
| Ex11B | 21.2% | 60.0% | 18.8% | 149.9 |
| (R4A2) | | | | |
| Ex11C | 21.4% | 40.0% | 38.6% | 150.0 |
| (R4A3) | | | | |
| Ex11D | 21.5 | 38.0% | 40.5% | 150.5 |
| (R4A4) | | | | |

TABLE 11B

| | | | | | Discharge | |
|---|---|---|---|---|---|---|
| | Heating | Heating | | Discharge | Temperature | Evaporator |
| | Capacity | Efficiency | Pressure | Pressure | Difference | Glide |
| Refrigerant | (vs R410A) | (vs R290) | ratio | [kPa] | [° C.] | [° C.] |
| R410A | 100% | 94% | 100% | 100% | 0.00 | 0.08 |
| R290 | 59% | 100% | 95% | 56% | −15.47 | 0.00 |
| R22 | 69% | 101% | 102% | 63% | 4.25 | 0.00 |
| R470C | 69% | 98% | 109% | 68% | −3.97 | 4.57 |
| Ex11A | 95% | 99% | 100% | 85% | −1.52 | 4.76 |
| Ex11B | 93% | 99% | 100% | 84% | −2.18 | 4.97 |
| Ex11C | 90% | 100% | 101% | 81% | −3.33 | 5.29 |
| Ex11D | 88 | 100 | 101 | 80 | −4.08 | 5.47 |

The refrigerants Ex11A through Ex11D illustrate the ability of the refrigerants and heat transfer compositions of the present invention to achieve at once the following combination of desirable results:
(1) GWP of 150 or less;
(2) Heating capacity of 88% or greater relative to R-410A
(3) Heating efficiency of 99% or greater relative to R-290
(4) Evaporator glide of less than 5.5° C.
(5) Discharge Temperature difference of less than 4.5° C.

The ability to achieve this combination of highly desirable results is unexpected and difficult to achieve. It will be noted that refrigerant Ex11A produces the most desirable results from the standpoint of having the highest capacity while at the same time having the lowest glide among these three refrigerants of the present invention. It is noted, however, that for each of Ex11A-11D, the values of greater than about 130% of capacity relative to 407C and over 99% for R22 means that these blends can be used as replacements for R407C or R22.

### Comparative Example 12: Use of R-410A, R-290, R-22 and R-407C for Residential Air-to-Water Air Conditioning Hydronic System with Radiators and Using a Suction Line-Liquid Line Heat Exchanger and Receiver—Cooling Mode

A residential air-to-water heat pump hydronic system having a basic structure as illustrated in FIG. 1, except modified to include a liquid line/suction line heat exchanger 30 (generally as illustrated in FIG. 13) and receiver 60 for the condenser 20, is provided and is used to supply cool air (about 27° C.) to buildings in the summer. Typical system types are split and monoblock with direct radiators or with a cooling coil and air handler. The system usually has an air-to-water or air-to-glycol evaporator, a compressor, an air-to-refrigerant condenser (outdoor coil), and an expansion valve. The evaporator is usually a brazed plate heat exchanger. The condenser is usually round tube plate fin or microchannel heat exchanger. The compressor is usually reciprocating or rotary (rolling-piston or scroll) compressor. The expansion valve is usually thermal or electronic expansion valve. The refrigerant evaporating temperature is in the range of 0 to 10° C., while the condensing temperature is in the range of 30 to 70° C. The following operating conditions were used for the heat pump hydronic system in the cooling mode:
1. Refrigerant condensing (dew point) temperature=45° C.
2. Condenser sub-cooling=5.5° C.
3. Refrigerant evaporating temperature=1° C.
4. Indoor water temperature—7° C.
5. Outdoor ambient temperature=35° C.
6. Evaporator outlet temperature=6.5° C.
7. Isentropic Efficiency=70%
8. Volumetric Efficiency=100%
9. Suction line liquid line heat exchanger effectiveness=35%
   Table C12 shows the thermodynamic performance of the residential air-to-water heat pump hydronic system with radiators using suction line liquid line heat exchanger and receiver as described above, using as a baseline the basic system (illustrated in FIG. 2) operating with R-290 refrigerant for efficiency and operating with R410A as a baseline for all other system parameters.

TABLE C12

| | | | | | Discharge | |
|---|---|---|---|---|---|---|
| | | | | Discharge | Temperature | Evaporator |
| | Capacity | Efficiency | Pressure | Pressure | Difference | Glide |
| Refrigerant | (vs R410A) | (vs R290) | ratio | [kPa] | [° C.] | [° C.] |
| R410A | 100% | 94% | 100% | 100% | 0 | 0.08 |
| R290 | 59% | 100% | 95% | 56% | −15.47 | 0 |
| R22 | 69% | 101% | 102% | 63% | 4.25 | 0 |
| R470C | 69% | 98% | 109% | 68% | −3.97 | 4.57 |

### Examples 12A, 12B, 12C and 12D: Use of Refrigerant Comprising R-32, R-1132(E) and R-1234yf for Residential Air-to-Water Heat Pump Hydronic System with Radiators and Using Suction Line/Liquid Line Heat Exchanger and Receiver—Cooling Mode

Comparative Example 12 is repeated except that the refrigerants identified in Table Ex12A are used to produce the results reported in Table Ex12B, together with the results from Comparative Example 12 for comparison using as a baseline the basic system (illustrated in FIG. 2) operating with R-290 refrigerant for efficiency and operating with R410A as a baseline for all other system parameters.

TABLE Ex12A

| Refrigerant | R32 | R1132(E) | R1234yf | |
|---|---|---|---|---|
| Designation | (wt. %) | (wt. %) | (wt. %) | GWP |
| Ex12A | 21.1% | 70.0% | 8.9% | 149.8 |
| (R4A1) | | | | |
| Ex12B | 21.2% | 60.0% | 18.8% | 149.9 |
| (R4A2) | | | | |
| Ex12C | 21.4% | 40.0% | 38.6% | 150.0 |
| (R4A3) | | | | |
| Ex12D | 21.5 | 38.0% | 40.5% | 149.5 |
| (R4A4) | | | | |

TABLE Ex12B

| | | | | | Discharge | |
|---|---|---|---|---|---|---|
| | | | | Discharge | Temperature | Evaporator |
| | Heating | Heating | Pressure | Pressure | Difference | Glide |
| Refrigerant | Capacity | Efficiency | ratio | [kPa] | [° C.] | [° C.] |
| R410A | 100% | 94% | 100% | 100% | 0 | 0.08 |
| R290 | 59% | 100% | 95% | 56% | −15.47 | 0 |
| R22 | 69% | 101% | 102% | 63% | 4.25 | 0 |
| R470C | 69% | 98% | 109% | 68% | −3.97 | 4.57 |
| Ex12A | 98% | 137% | 74% | 68% | −16.26 | 3.31 |
| Ex12B | 94% | 128% | 77% | 70% | −14.07 | 3.47 |
| Ex12C | 89% | 119% | 81% | 71% | −12.14 | 3.75 |
| Ex12D | 85 | 111 | 86 | 73 | −9.79 | 3.89 |

The refrigerants Ex12A through Ex12D illustrate the ability of the refrigerants and heat transfer compositions of the present invention to achieve at once the following combination of desirable results:
(1) GWP of 150 or less;
(2) Heating capacity of 89% or greater relative to R-410A
(3) Heating efficiency of 119% or greater relative to R-290
(4) Evaporator glide of less than 4° C.
(5) Discharge Temperature difference of less than 17° C.
   The ability to achieve this combination of highly desirable results is unexpected and difficult to achieve. It will be noted that refrigerant Ex12A produces the most desirable results from the standpoint of having the highest capacity while at the same time having the lowest glide among these three refrigerants of the present invention. It is noted, however, that for each of Ex12A-12D, the negative discharge temperature differences means that the system will operate with these refrigerants with good compressor reliability and no risk of oil breakdown or motor burn-out values. Further, the ability to achieve pressure ratios of 86%-74% and discharge pressures of 68%-73% means that while these refrigerants in general can be used to replace R-22 and R-407C, they generally will not be used as a drop-in replacement for these refrigerants since a redesigned compressor may be required. The negative discharge temperature differences means that compressor reliability will be good.

What is claimed is:

1. A heat pump or air conditioning system for heating and/or cooling air and/or water in an occupied indoor space comprising:
(a) a refrigerant comprising at least 97% by weight of the following three components, wherein the following percentages are based on the total of components (i) through (iii): (i) from about 20 wt. % to about 30 wt % of R-32; (ii) from about 25 wt. % to about 45 wt. % R-1132(E); and from about 35 wt. % to about 55 wt. % R-1234yf;
(b) a compressor for the refrigerant, said compressor being located outdoors;
(c) a first heat exchanger for exchanging heat, directly or indirectly, between said refrigerant and an outdoor heat sink, said first heat exchanger being located outdoors;
(d) a second heat exchanger for exchanging heat, directly or indirectly, between said refrigerant and air and/or water in said occupied indoor space;
(e) a reversing valve located between said compressor and said first heat exchanger and between said compressor and said second heat exchanger; and
(f) at least one expansion device for said refrigerant located between said first heat exchanger and said second heat exchanger.

2. The heat pump system of claim 1 wherein said refrigerant has a GWP of 150 or less and wherein said refrigerant is Class 1 or Class 2L.

3. The heat pump system of claim 1 wherein said outdoor heat sink comprises outdoor air and/or an outdoor water loop.

4. The heat pump system of claim 1 wherein said outdoor heat sink comprises and outdoor water loop which transfers heat with a ground-source.

5. A method for heating and/or cooling air and/or water in an occupied indoor space comprising:
(a) providing a heat transfer system comprising: (1) a refrigerant comprising at least 97% by weight of the following three components, wherein the following percentages are based on the total of components (i) through (iii): (i) from about 20 wt. % to about 30 wt % of R-32; (ii) from about 25 wt. % to about 45 wt. % R-1132(E); and from about 35 wt. % to about 55 wt. % R-1234yf; (2) a compressor for said refrigerant located outdoors; (3) a first heat exchanger for exchanging heat, directly or indirectly, between said refrigerant and an outdoor heat sink and being located outdoors; (4) a second heat exchanger for exchanging heat, directly or indirectly, between said refrigerant and air and/or water in said occupied indoor space; (5) a reversing valve located between said compressor and said first heat exchanger and between said compressor and said second heat exchanger; and (6) at least one expansion device for said refrigerant located between said first heat exchanger and said second heat exchanger; and
(b) transferring heat between air or water located in said indoor space and said outdoor heat sink using said heat transfer system.

6. The method of heating and/or cooling air and/or water in an occupied indoor space of claim 5 wherein said refrigerant has a GWP of 150 or less and wherein said refrigerant is Class 1 or Class 2L.

7. A heat pump system for heating and/or cooling air and/or water in an occupied indoor space comprising:
(a) a refrigerant comprising at least 99% by weight of the following three components, wherein the following percentages are based on the total of components (i) through (iii): (i) 21.5 wt. %+/−0.5 wt % of R-32; (ii) from 25 wt. % to 42.5 wt. % R-1132(E); and from 36 wt. % to 52 wt. % R-1234yf;
(b) a compressor for the refrigerant, said compressor being located outdoors;
(c) a first heat exchanger for exchanging heat, directly or indirectly, between said refrigerant and an outdoor heat sink, said first heat exchanger being located outdoors;
(d) a second heat exchanger for exchanging heat, directly or indirectly, between said refrigerant and air and/or water in said occupied indoor space;
(e) a reversing valve located between said compressor and said first heat exchanger and between said compressor and said second heat exchanger; and
(f) at least one expansion device for said refrigerant located between said first heat exchanger and said second heat exchanger.

8. The heat pump system of claim 7 wherein said outdoor heat sink comprises outdoor air and/or an outdoor water loop.

9. The heat pump system of claim 7 wherein said outdoor heat sink comprises an outdoor water loop that transfers heat with the earth.

10. The heat pump system of claim 7 wherein said water exchanges heat with indoor air.

11. The heat pump system of claim 7 wherein said system is was an R-32 system, or an R290 system or an R410A system and wherein said refrigerant is used in said R-32, R290 or said R410A system.

12. The heat pump system of claim 11 wherein said system is was an R-32 system and wherein said refrigerant is used in said R-32 system.

13. The heat pump system of claim 12 wherein said system operating with said refrigerant includes a vapor injection economizer and/or a suction line liquid line heat exchanger.

14. The heat pump system of claim 12 wherein said system operating with said refrigerant includes a vapor injection economizer.

15. The heat pump system of claim 11 wherein said system is was an R-290 system and wherein said refrigerant is used in said R-290 system.

16. The heat pump system of claim 15 wherein said system operating with said refrigerant includes a vapor injection economizer and/or a suction line liquid line heat exchanger.

17. The heat pump system of claim 15 wherein said system operating with said refrigerant includes a vapor injection economizer.

18. The heat pump system of claim 11 wherein said system is was an R-410A system and wherein said refrigerant is used in said R-410 system.

19. The heat pump system of claim 18 wherein said system operating with said refrigerant includes a vapor injection economizer and/or a suction line liquid line heat exchanger.

20. The heat pump system of claim 18 wherein said system operating with said refrigerant includes a vapor injection economizer.
